(19) United States
(12) Patent Application Publication
(10) Pub. No.: US 2024/0025085 A1
(43) Pub. Date: Jan. 25, 2024

(54) CONVERSION OF CO-MINGLED WASTE PLASTICS TO MONOMERS AND FUELS IN SEQUENTIAL CATALYTIC PROCESS

(71) Applicant: Washington State University, Pullman, WA (US)

(72) Inventor: Hongfei Lin, Pullman, WA (US)

(73) Assignee: Washington State University, Pullman, WA (US)

(21) Appl. No.: 18/251,958

(22) PCT Filed: Nov. 9, 2021
(86) PCT No.: PCT/US2021/072298

§ 371 Date: May 5, 2023

Related U.S. Application Data
(60) Provisional application No. 63/111,489, filed on Nov. 9, 2020.

(51) Int. Cl. B29B 17/02

(52) U.S. Cl. CPC B29B 17/02; B29B 2017/001

(57) ABSTRACT

The present disclosure describes a sequential continuous catalytic solvolysis process and system for deconstructing co-mingled plastics containing polyesters, polyamides, and polyolefins into polyester monomers, polyamide monomers, and low molecular weight hydrocarbons, respectively. The catalysts and solvents used in the process can be recycled, and the monomers can undergo polymerization to fresh polyesters and polyamides for everyday use. The low molecular weight hydrocarbons can be used as liquefied gas.

### CROSS REFERENCE TO RELATED APPLICATIONS

This application claims the benefit of U.S. Provisional Patent Application 63/111,489, filed on Nov. 9, 2020, which is hereby incorporated by reference in its entirety.

### TECHNICAL FIELD

The present disclosure relates to methods of and systems for recycling plastic wastes.

### BACKGROUND

The annual production of plastics is 335 million tons and is expected to double over the next two decades. The vast majority, 79 percent, of plastic waste are is accumulating in landfills or sloughing off in the natural environment as litter, while at some point, much of it ends up in the oceans, the final sink. If present trends continue, by 2050, there will be 12 billion metric tons of plastic in landfills. The degradation of plastic polymers in a landfill may take hundreds of years. Therefore, the vast amount of accumulated plastic waste has resulted in an ecological crisis. For instance, microplastic debris has been found even in the deep ocean, and on the shorelines of remote islands. Microplastics are highly persistent in the environment and may pose a serious threat to marine and freshwater organisms, as well as to humans because humans are at the end of the food chain. Hence, it is imperative to develop alternative methods for plastic waste disposal. Especially, the plastic recycling and upcycling approaches can benefit society both economically and environmentally. However, the United States recycles just 9 percent of its plastic trash, ranking behind Europe (30 percent) and China (25 percent).

Currently, mechanical recycling is the most common recycling method. However, it causes deterioration in material properties fu contrast, chemical recycling is more sustainable because plastics are converted to monomers, which are used to reproduce fresh plastic materials. Most waste plastics are collected as co-mingled mixtures and the selective recycling of such waste plastic mixtures is very challenging. Thus it is important to develop efficient routes to convert co-mingled waste plastics (polyesters, polyamides, polyolefins, etc.) to monomers and/or fuels through the selective C—O, C—N, and C—C cleavage. For plastics made from relatively expensive monomers, such as polyesters and polyamides, breaking down such waste plastic into their monomers could be cost-effective, while waste polyolefin plastics are suitable feedstock for making hydrocarbon fuels.

### SUMMARY

This Summary is provided to introduce a selection of concepts in a simplified form that is further described below in the Detailed Description. This Summary is not intended to identify all key features or essential features of the claimed subject matter, nor is it intended to be used alone as an aid in determining the scope of the claimed subject matter.

The present disclosure describes methods and systems for recycling and upcycling plastic wastes. In embodiments, the present disclosure describes methods and systems for recovering polyester monomers and derivatives thereof, polyamide monomers, and low molecular weight hydrocarbons (LMWH) from co-mingled plastics. The methods and systems include three different ways of recycling three different plastics: (1) depolymerization of polyesters by solvolysis with a catalyst in a solvent, such as methanolysis with a tertiary amine in methanol; (2) depolymerization of polyamides by solvolysis with a catalyst in a solvent, such as hydrolysis with a tertiary amine in an aqueous solvent; and (3) hydrocracking of polyolefins over a supported catalyst in a solvent, such as a ruthenium/carbon (RU/C) catalyst in cycloalkane solvent. The polyesters are converted to polyester monomers, dimethyl terephthalate (DMT) and ethylene glycol (EG), while the polyamides are converted to polyamide monomers. The polyolefins are converted to fuel-range hydrocarbons.

The present disclosure also describes a sequential catalytic method and system that includes the three methods and systems described herein, which selectively converts co-mingled plastics to monomers and fuels for promoting the circular economy in the plastic industry and mitigating the negative environmental impact caused by accumulated plastic wastes.

### BRIEF DESCRIPTION OF THE DRAWINGS

FIG. 1. Catalyst screening for methanolytic depolymerization of post-consumer polyethylene terephthalate (PET) bottle. Reaction conditions: 0.1 g post-consumer PET transparent bottle, 20 mL of 0.20 M tertiary amine methanol solution, 160° C., 1 h, 700 rpm. Tripropylamine (TPA), Triethylamine (TEA), 4,N,N-trimethylaniline (TMA), N,N-dimethylaniline (DMA), N-methylpiperidine (NMP), 1,8-Diazabicyclo[5.4.0]undec-7-ene (DBU), N,N,N′,N′-Tetramethyl-1,3-propanediamine (TMPDA), N,N,N′,N′-Tetramethylethylenediamine (TMEDA), N,N,N′,N′-Tetraethylethylenediamine (TEEDA).

FIG. 2. Potential byproducts corresponding to the catalyst screening (FIG. 2).

FIG. 3. Recyclability of NMP for depolymerization of post-consumer PET transparent bottle in methanol solution. Reaction condition: 20 mL of 0.20 M NMP methanol solution, p(N₂)=0 bar, 150° C., 0.5 hour (h), 700 rpm. Adding 0.1 g fresh PET at each recycling time.

FIGS. 4A-4D. Deconstruction of individual polyester. Temperature profiles of NMP-catalyzed depolymerization of post-consumer PET transparent bottle (4A) or polylactic acid (PLA) 4043D, 6060D, 6202D, and 2500HP (4B) or post-consumer polycarbonate (PC) bottle (4C) or polybutylene terephthalate (PBT) (4D) in methanol. Reaction condition: 0.1 g PET bottle or PLA pellets or post-consumer PC bottle or PBT pellets, 20 mL of 0.2 M NMP methanol solution, 1 h, 700 rpm.

FIGS. 5A and 5B. Yields of the monomers from methanolytic depolymerization of post-consumer PET transparent bottle in the presence of NMP as functions of reaction time (5A), and PET loading (5B). Reaction conditions for FIG. 5A: 0.1 g PET bottle, 20 mL of 0.2 M NMP methanol solution, 160° C., 700 rpm. Reaction conditions for FIG. 5B: 20 mL of 0.2 M NMP methanol solution, 160° C., 1 h, 700 rpm.

FIGS. 6A and 6B. Yields of the monomers in NMP-catalyzed methanolytic depolymerization of polyethylene terephthalate (PET) textile as a function of reaction temperature (6A) and time (6B). Reaction conditions for FIG. 6A: 0.1 g PET textile, 20 mL of 0.2 M NMP methanol solution, 1 h, 700 rpm. Reaction conditions for FIG. 6B: 0.1 g PET textile, 20 mL of 0.2 M NMP methanol solution, 160° C., 700 rpm.

FIG. 7. Dispersed dyes in PET polyester products.¹⁷ Blue 60 with 98% sorption; Yellow 211 with 99% sorption; Blue 79 with 98.8% sorption.

FIGS. 8A and 8B. The effect of the dyes in PET textile (8A) and PET bottle (8B) and the effect of pretreatment on yields of DMT and EG. (8A) The effect of pretreatment on yields of DMT and EG during the NMP-catalyzed methanolytic depolymerization of post-consumer PET textile. Reaction conditions: 0.1 g PET textile, 20 mL of 0.2 M NMP methanol solution, 160° C., 1 h, 700 rpm. M: methanol treatment, A: acetone treatment, and M+A: a mixture of methanol and acetone (V:V=1:1). (8B) Effect of dyes in post-consumer PET bottle on yields of DMT and EG. Reaction conditions: 0.1 g PET bottle, 20 mL of 0.2 M NMP methanol solution, 160° C., 1 h, 700 rpm.

FIGS. 9A-9D. Temperature profiles of non-catalyzed and NMP-catalyzed methanolytic depolymerization of PLA (9A) 6060D, (9B) 6202D, and (9C) 2500HP, and (9D) 4043D. Reaction conditions: 1) NMP-catalyzed methanolysis, 0.1 g PLA pellets, 20 mL of 0.2 M NMP methanol solution, 1 h, 700 rpm; 2) non-catalyzed methanolysis, 0.1 g PLA pellets, 20 mL of methanol, 1 h, 700 rpm.

FIG. 10: Temperature profiles of non-catalyzed and NMP-catalyzed methanolytic depolymerization of PC bottle. Reaction conditions: 1) NMP-catalyzed methanolysis, 0.1 g PC, 20 mL of 0.2 M NMP methanol solution, 1 h, 700 rpm; 2) non-catalyzed methanolysis, 0.1 g PC, 20 mL of methanol, 1 h, 700 rpm.

FIGS. 11A-11C. Selective deconstruction of polyesters from plastic mixtures and multilayer plastic packaging materials. (11A) Deconstruction of PLA and PET mixture via the sequential process. Reaction condition: 0.5 g PLA and 0.5 g PET in 20 mL of 0.4 M NMP methanol solution, 700 rpm; Step 1)PLA 6202D: 90° C., 2 h; or PLA 4043D: 80° C., 2h; or PLA 6060D: 60° C., 2h; or PLA 2500HP: 90° C., 2h; step 2) PET: 160° C., 1 h, 700 rpm. (11B) Deconstruction of PET in PET/PE, or PET/PVC, or PET/PP, or PET/PS, or PET/Nylon 6 mixture. Reaction condition: 0.1 g PET bottle and 0.1 g other plastic, 20 mL of 0.2 M NMP methanol solution, 160° C., 1 h, 700 rpm. (11C) Deconstruction of PET from PET/PA/PE or PET/PE multilayer packaging materials. Reaction condition: 0.25 g multilayer film, 20 mL of 0.2 M NMP methanol solution, 160° C., 1 h, 700 rpm.

FIG. 12. Fresh plastic samples before reaction and the solid residues after the N-methylpiperidine catalyzed methanolysis.

FIG. 13. ¹H NMR spectra of PET/PVC solid residues after the N-methylpiperidine catalyzed methanolysis. Deconstruction of PET in PET/PVC mixture. Reaction condition: 0.1 g PET bottle and 0.5 g PVC, 20 mL of 0.2 M NMP methanol solution, 160° C., 1 h, 700 rpm.

FIG. 14. Deconstruction of PET in PET/PE, or PET/PVC, or PET/PP, or PET/PS, or PET/Nylon 6 mixture. Reaction condition: 0.1 g PET bottle and 0.5 g other plastic, 20 mL of 0.2 M NMP methanol solution, 160° C., 1 h, 700 rpm.

FIG. 15. Deconstruction of PET in PET/PE/PP/PS/Nylon 6 mixture or PET/PE/PVC/PP/PS/Nylon 6 mixture. Reaction condition: 0.1 g PET bottle, 0.1 g PE, 0.1 g PVC, 0.1 g PP, 0.1 g PS, and 0.1 g Nylon 6 (with PVC); or 0.1 g PET bottle, 0.1 g PE, 0.1 g PP, 0.1 g PS, 0.1 g Nylon 6 (without PVC); 20 mL of 0.2 M NMP methanol solution, 160° C., 1 h, 700 rpm.

FIGS. 16A and 16B. ¹H NMR spectra of beer or milk bag (16A) and vacuum seal storage bag (16B) solid residues after the N-methylpiperidine catalyzed methanolysis. Deconstruction of PET from PET/PA/PE or PET/PE multilayer packaging materials. Reaction condition: 0.25 g multilayer film, 20 mL of 0.2 M NMP methanol solution, 160° C., 1 h, 700 rpm.

FIGS. 17A and 17B. XRD spectra of (17A) PET/PA/PE (beer or milk bag) or (17B) PET/PE (vacuum seal storage bag) multilayer packaging materials and the solid residues.

FIG. 18. ¹H NMR spectra of fresh and residual PET. Reaction condition: 0.3 g PET transparent bottle, 20 mL of 0.2 M NMP methanol solution, 160° C., 0.2 or 0.3 h, 700 rpm. Note that the peaks at 3.251 and 4.38 ppm are assigned to HFIP (hexafluoroisopropanol), a solvent used to dissolve solid PET. The peak at 7.26 ppm is an assignment from Chloroform-d. The peaks at 3.93, 4.68, and 8.08 are from the methylene and benzene groups in the PET polymer chain, respectively.

FIG. 19. ¹H NMR spectra of liquid-phase products after the NMP-catalyzed methanolysis of PET. Reaction condition: 0.3 g PET, 20 mL of 0.2 M NMP methanol solution, 160° C., 0.2 h, 700 rpm.

FIGS. 20A-20D. ¹H NMR spectra of standard samples, methanol, and NMP in chloroform-d (20A)¹H NMR spectra of methanol; (20B)¹H NMR spectra of NMP; (20C)¹H NMR spectra of standard dimethyl terephthalate; (20D)¹H NMR spectra of standard ethylene glycol.

FIG. 21. Proposed reaction pathway of chain-end scission depolymerization of post-consumer PET in the presence of NMP in methanol solvent

FIG. 22. Catalyst screening for hydrolytic depolymerization of Nylon 6. Reaction conditions: 0.1 g Nylon 6 pellets, 5 mL tertiary amine, 20 mL H₂O, 250° C., 6 h, 700 rpm. Triethylamine (TEA), Tripropylamine (TPA), N-methylpiperidine (NMP), 1,8-Diazabicyclo[5.4.0]undec-7-ene (DBU), N,N,N′,N′-Tetraethylethylenediamine (TEEDA), N,N-diethylaniline (DEA), N,N-dimethylaniline (DMA).

FIG. 23. GC chromatogram of the products from the hydrolytic depolymerization of Nylon 6 using DBU as a catalyst. Reaction conditions: 0.1 g Nylon 6 pellets, 5 mL DBU, 20 mL H2O, 250° C., 6 h, 700 rpm.

FIG. 24. Recyclability of triethylamine (TEA) in the hydrolysis of Nylon 6. Reaction condition: 0.1 g Nylon 6, 5 mL TEA, 20 mL DI water, 250° C., 1 h, 700 rpm.

FIG. 25. Yield of ε-caprolactam in triethylamine-catalyzed hydrolysis of Nylon 6 as a function of reaction temperature. Reaction conditions: 0.1 g Nylon 6, 20 mL water, 5 mL TEA, 6 h, 700 rpm.

FIG. 26. Yield of ε-caprolactam in TEA-catalyzed hydrolysis of Nylon 6 as a function of reaction time. Reaction conditions: 0.1 g Nylon 6, 20 mL water, 5 mL TEA, 700 rpm, 250° C.

FIG. 27. Yield of ε-caprolactam in NMP-catalyzed hydrolysis of Nylon 6 as a function of reaction temperature. Reaction conditions: 0.1 g Nylon 6, 20 mL water, 5 mL NMP, 1 h, 700 rpm.

FIG. 28. Yield of ε-caprolactam in triethylamine-catalyzed hydrolysis of Nylon 6 as a function of Nylon 6 loading based on the water volume. Reaction conditions: 20 mL water, 5 mL triethylamine, 6 h, 700 rpm, 250° C.

FIG. 29. Yield of ε-caprolactam in triethylamine-catalyzed hydrolysis of Nylon 6 as a function of triethylamine volume. Reaction conditions: 0.1 g Nylon 6, 20 mL water, 6 h, 700 rpm, 250° C.

FIG. 30. ¹H NMR of spectra of fresh Nylon 6 and Nylon 6 residue. Reaction condition: 0.3 g Nylon 6, 5 mL triethylamine (TEA), 20 mL DI water, 250° C., 1 h, 700 rpm.

FIG. 31. ¹H NMR of liquid solution after TEA-catalyzed hydrolysis of Nylon 6. Reaction condition: 0.3 g Nylon 6, 5 mL triethylamine (TEA), 20 mL DI water, 250° C., 1 h, 700 rpm.

FIG. 32. H-NMR of standard ε-caprolactam sample.

FIG. 33. H-NMR of triethylamine sample.

FIG. 34. Proposed reaction pathway of TEA-catalyzed hydrolytic depolymerization of polyamide 6.

FIGS. 35A-35C. TEM images and particle size distribution histogram figures of (35A) Ru/C-fresh; (35B) Ru/C-used cycle 1; (35C) Ru/C-used cycle 2. Reaction conditions: 0.1 g HDPE, 0.05 g Ru/C, 25 mL n-hexane, 220° C., p(H₂)=20 bar, 1 h, 700 rpm.

FIG. 36. XPS Spectra of fresh and spent Ru/C. Reaction condition: 0.1 g HDPE, 0.05 g Ru/C, 25 mL n-hexane, 220° C., p(H₂)=20 bar, 1 h, 700 rpm.

FIG. 37. Powder XRD patterns of the fresh and spent Ru/C catalysts. Reaction condition: 0.1 g HDPE, 0.05 g Ru/C, 25 mL n-hexane, 220° C., p(H₂)=20 bar, 1 h, 700 rpm.

FIGS. 38A and 38B. GC-MS spectra for the oil products from the HDPE depolymerization. (38A) Reaction Condition: 0.1 g HDPE, 0.05 g Rh/C, 25 mL n-hexane, 220° C., p(H2)=30 bar, 1 h, 700 rpm; (38B) Reaction Condition: 0.1 g HDPE, 0.05 g Ru/C, 25 mL n-hexane, 220° C., p(H2)=30 bar, 1 h, 700 rpm. From the GC-MS spectra, the long-chain hydrocarbons (C38+) can be observed when the hydrogenolysis rate was low with the Rh/C catalyst (FIG. 38A). In contrast, those C38+ peaks were not observed while the reaction rate was very fast with the Ru/C catalyst (FIG. 38). Therefore, it can be concluded that the excess is only made of short-chain products.

FIGS. 39A-39C. (39A) Temperature profile of the production distribution of the HDPE depolymerization. Reaction conditions: 0.1 g HDPE, 0.05 g Ru/C, 25 mL n-hexane, p(H₂)=30 bar, 1 h, 700 rpm; (39B) Reaction time profile of the production distribution of the HDPE depolymerization. Reaction conditions: 0.1 g HDPE, 0.05 g Ru/C, 25 mL n-hexane, 220° C., p(H₂)=30 bar, 700 rpm; (39C) Catalyst loading effect on the production distribution of the HDPE depolymerization. Reaction conditions: 0.1 g HDPE, 25 mL n-hexane, 220° C., p(H₂)=20 bar, 1h, 700 rpm. The effective catalyst loading M_{Ru}/M_{HDPE} wt % is calculated as follows: M_{Ru}/M_{HDPE}wt %=([mass of the Ru/C catalyst]×[5 wt %]×[Ru dispersion])/([mass of HDPE strips]. *The remaining products are short-chain hydrocarbons (C1-C7).

FIG. 40. Hydrogen pressure effect on depolymerization of HDPE. Reaction conditions: 0.1 g HDPE, 0.05 g Ru/C, 25 mL n-hexane, 220° C., 1h, 700 rpm. *The remaining products are short-chain hydrocarbons (C1-C7).

FIG. 41. The liquid alkane product (C₈-C₁₉) distribution from the eicosane hydrogenolysis over the Ru/C catalyst. Reaction condition: 0.1 g eicosane, 0.05 g Ru/C, 25 mL n-hexane, 200° C., 0.3 h. *The remaining products are short-chain hydrocarbons (C1-C7).

FIG. 42. Solvent effect on depolymerization of HDPE. Reaction conditions: 0.1 g HDPE, 25 mL solvent, 220° C., p(H₂)=20 bar, 1h, 700 rpm. *in decalin, 5.4% of HDPE was converted, but no detectable liquid hydrocarbon products were observed on GC-MS.

FIGS. 43A-43D. Solid Residue after depolymerization reaction and centrifugation. HDPE strips cannot be solvated in water (43A), and supercritical n-pentane (43B), and these strips are melted to form spherical solids due to surface tension. In n-hexane and decalin, HDPE strips can be solvated, and polymer molecules could be easier to be depolymerized, although a very low conversion (5.4%) was obtained in decalin. Reaction condition: 0.1 g HDPE, 0.05 g Ru/C, 220° C., p(H2)=20 bar, 25 ml solvent (43A) solvent water, 1 h; (43B) solvent n-pentane, 1 h; (43C) solvent n-hexane, 0.5 h. (43D) solvent decalin, 1 h.

FIG. 44. HDPE polymers degradation pathways in the solvent

FIG. 45. Lifetime of the catalyst. Reaction condition: 0.1 g HDPE, 0.05 g Ru/C, 25 mL n-hexane, 220° C., p(H₂)=20 bar, 1h, 700 rpm. *The excess is light hydrocarbons (C1-C7).

FIGS. 46A-46C. TGA profiles of fresh Ru/C catalyst (46A), spent Ru/C catalysts first cycle (46B) and second cycle (46C). Reaction condition: 0.1 g HDPE, 0.05 g Ru/C, 25 mL n-hexane, 220° C., p(H2)=20 bar, 1 h, 700 rpm.

FIG. 47. Sequential chemical recycling of co-mingled waste plastics or multilayer packaging materials.

FIGS. 48A, 48B. Selective methanolysis of PET from PET/Nylon 6/PE mixture in the first step using N-methylpiperidine (NMP) as a catalyst. (48A) Effect of temperature on the product yields. (48B) XRD patterns of the fresh PET, Nylon 6, PE, and the solid residues after methanolysis. Reaction conditions: 0.1 g PET, 0.05 g Nylon 6, 0.1 g PE, 20 mL of 0.2 M NMP methanol solution, 1 h, 700 rpm.

FIG. 49. Probe reaction for Nylon 6 using N-methylpiperidine (NMP) as a catalyst. Reaction conditions: 0.05 g Nylon 6, 20 mL of 0.2 M NMP methanol solution, 1 h, 160° C., 700 rpm.

FIG. 50. Probe reaction for PE using N-methylpiperidine (NMP) as a catalyst. Reaction conditions: 0.1 g PE, 20 mL of 0.2 M NMP methanol solution, 1 h, 160° C., 700 rpm.

FIG. 51. Effect of PET loading on the selective methanolysis of PET from PET/Nylon 6/PE mixture in the first step using N-methylpiperidine (NMP) as a catalyst. Reaction conditions: 0.1-0.5 g PET, 0.05 g Nylon 6, 0.1 g PE, 20 mL of 0.2 M NMP methanol solution, 160° C., 1 h, 700 rpm.

FIGS. 52A and 52B. (52A) Effect of Nylon 6 loading on the selective methanolysis of PET from PET/Nylon 6/PE mixture in the first step using N-methylpiperidine (NMP) as a catalyst. Reaction conditions: 0.1 g PET, 0.05-0.5 g Nylon 6, 0.1 g PE, 20 mL of 0.2 M NMP methanol solution, 160° C., 1 h, 700 rpm. (52B) Prolonging the reaction time to improve the selective methanolysis of PET from PET/Nylon 6/PE mixture in the first step using N-methylpiperidine (NMP) as a catalyst. Reaction conditions: 0.1 g PET, 0.5 or 0.3 g Nylon 6, 0.1 g PE, 20 mL of 0.2 M NMP methanol solution, 160° C., 700 rpm.

FIGS. 53A and 53B. (53A) Effect of PE loading on the selective methanolysis of PET from PET/Nylon 6/PE mixture in the first step using N-methylpiperidine (NMP) as a catalyst. Reaction conditions: 0.1 g PET, 0.05 g Nylon 6, 0.1-0.5 g PE, 20 mL of 0.2 M NMP methanol solution, 160° C., 1 h, 700 rpm. (53B) Prolonging the reaction time to improve the selective methanolysis of PET from PET/Nylon 6/PE mixture in the first step using N-methylpiperidine (NMP) as a catalyst. Reaction conditions: 0.1 g PET, 0.05 Nylon 6, 0.5 or 0.3 g PE, 20 mL of 0.2 M NMP methanol solution, 160° C., 700 rpm.

FIGS. 54A and 54B. (54A) Catalytic performance of TEA on the hydrolysis of Nylon 6 in step 2 at different temperatures, (54B) XRD patterns of the fresh Nylon 6, PE, the top solid residues, and all the solid residues after hydrolysis step. Reaction conditions: Residues from step 1 (PET:0.1 g, Nylon 6:0.05 g, PE:0.1 g), 20 mL H₂O, 5 mL TEA, 6 h, 700 rpm.

FIG. 55. Probe reaction for PE using Triethylamine (TEA) as a catalyst. Reaction conditions: 0.1 g PE, 20 mL H₂O, 5 mL TEA, 250° C., 1 h, 700 rpm.

FIG. 56. Solid residues from the top after the hydrolysis step. Reaction conditions: Residues from step 2 (PET:0.1 g, Nylon 6:0.05 g, PE:0.5 g), 20 mL H₂O, 5 mL TEA, 250° C., 6 h, 700 rpm.

FIG. 57. Effect of reaction time on the hydrolysis Nylon 6 in step 2. Reaction conditions: Residues from step 1, (PET:0.1 g, Nylon 6:0.05 g, PE:0.1 g), 20 mL H2O, 5 mL TEA, 700 rpm.

FIGS. 58A and 58B. (58A) Effect of Nylon 6 and (58B)PE loadings on the selective hydrolysis of Nylon 6 from Nylon 6/PE mixture in the second step using TEA as a catalyst. Reaction conditions: 20 mL H₂O, 5 mL TEA, 250° C., 6 h, 700 rpm.

FIG. 59. Temperature profile of the production distribution of the pure PE depolymerization. Reaction condition: 0.1 g pure PE, Ru/C 0.05 g, n-hexane 20 mL, p(H₂)=30 bar, 1 h, 700 rpm.

FIG. 60. Time course of the production distribution of the pure PE depolymerization. Reaction condition: 0.1 g pure PE, Ru/C 0.05 g, n-hexane 20 mL, p(H₂)=30 bar, 230° C., 700 rpm.

FIG. 61. Reaction temperature effect on the production distribution of the depolymerization of PE from the second step. Reaction condition: 0.1 g PE after methanolysis and hydrolysis steps, Ru/C 0.05 g, n-hexane 20 mL, p(H₂)=30 bar, 1 h, 700 rpm.

FIG. 62. Liquid alkane products distribution detected on GC-MS. Reaction condition: 0.1 g PE after methanolysis and hydrolysis steps, Ru/C 0.05 g, n-hexane 20 mL, p(H₂)=30 bar, 1 h, 700 rpm.

FIG. 63. Multilayer packaging materials used in this study and the content of each based on the NMR determination.

FIGS. 64A and 64B. (64A) Selective deconstruction of PET from beer or milk bag(PET/Nylon 6/PE film) and vacuum seal storage bag (PET/PE film) to produce DMT and EG. (64B) ¹H NMR spectra of 0.1 g beer or milk bag and vacuum seal storage bag solid residues after the N-methylpiperidine catalyzed methanolysis. Reaction conditions: 20 mL 0.2 M N-methylpiperidine methanol solution, 160° C., 1 h, 700 rpm.

FIG. 65. XRD spectra of fresh vacuum seal storage bag and its solid residues after the N-methylpiperidine catalyzed methanolysis.

FIGS. 66A-66D. (66A) Selective deconstruction of Nylon 6 from the solid residues from beer or milk bag (PET/Nylon 6/PE film) methanolysis, food bag, or vacuum seal storage bag to produce ε-caprolactam. (66B) ¹H NMR spectra of 0.1 g beer or milk bag solid residues from step 2, food bag solid residues, and vacuum seal storage bag 2 solid residues after the TEA catalyzed hydrolysis. (66C) XRD spectra of the food bag and its solid residues. (66D) XRD spectra of vacuum seal storage bag 2 and its solid residues. Reaction conditions: 20 mL H₂O, 5 mL TEA, 250° C., 8 h, 700 rpm.

FIG. 67. Deconstruction of PE into liquid hydrocarbon fuels and lubricants by hydrogenolysis. Reaction condition:solid residues after methanolysis (step 1) and/or hydrolysis (8h, step 2) of 0.1 g multilayer film, Ru/C 0.05 g, n-hexane 20 mL, 230° C., p(H2)=30 bar, 1 h, 700 rpm.

FIG. 68. Products distribution after the hydrogenolysis step. Reaction condition: 0.1 g multilayer film after methanolysis (step 1) and/or hydrolysis (8h, step 2), Ru/C 0.05 g, n-hexane 20 mL, 230° C., p(H2)=30 bar, 1 h, 700 rpm.

FIG. 69. Deconstruction of PE into liquid hydrocarbon fuels and lubricants by hydrogenolysis. Reaction condition: 0.1 g multilayer film after methanolysis (step 1) and/or hydrolysis (10h, step 2), Ru/C 0.05 g, n-hexane 20 mL, p(H2)=30 bar, 1 h, 700 rpm.

FIG. 70. Deconstruction of PE into liquid hydrocarbon fuels and lubricants by hydrogenolysis. Reaction condition: 0.3 g multilayer film after methanolysis (step 1) and/or hydrolysis (8h, step 2), Ru/C 0.05 g, n-hexane 20 mL, p(H2)=30 bar, 1 h, 700 rpm.

FIG. 71. Process flow diagram of the sequential catalytic process for the degradation of co-mingled waste plastics.

FIGS. 72A-72C. Assessment for the sequential catalytic process. (72A) project capital cost, (72B) operation cost, and (72C) project net present value (NPV).

FIG. 73. A flow diagram of the system and method for sequential catalytic solvolysis (SeCatSol) process that converts mixed plastics to valued products such as monomers and low molecular weight hydrocarbons.

### DETAILED DESCRIPTION

Plastic wastes represent an abundant and untapped source of energy and chemicals. If adequately managed, discarded plastics could be recycled or upcycled into high-value products and add drastic economic and environmental benefits. However, the challenge is that the heterogeneity of co-mingled plastic wastes containing incompatible polymers, additives, and contaminants makes it uneconomical to recycle waste plastics. For instance, mechanical plastic recycling requires recovering pure plastics from the mixed solid wastes by capital- and labor-intensive physical sorting. Traditional thermochemical upcycling processes still need sizable energy inputs and costly product upgrading. Therefore, novel energy-efficient catalytic polymer deconstruction and cost-competitive chemical upcycling processes are imperatively needed.

The present disclosure describes efficient methods for the selective deconstruction of polyesters and polyamides, either stand-alone or in a mixture without sorting, with catalysts in solvents. The terms “deconstruction” and “depolymerization” are used interchangeably throughout to refer to converting plastics to monomers and their derivatives or to low molecular weight hydrocarbons, such as alkanes and the like.

After extensive studies on catalytic solvolysis, it was discovered that with proper catalysts and solvents, the depolymerization of plastics proceeded at fast rates under mild reaction conditions. It was found that the tertiary amine organocatalysts can selectively catalyze the degradation of waste plastics stream containing polyesters and polyamides, such as polyethylene terephthalate (PET) or Nylon, from the co-mingled plastics while the other polymers, such as polyolefins, remain in their original chemical composition, though there is a change of their morphologies or physical shapes. Tertiary amines (R₃N:) harbor the lone pair electrons on nitrogen with the Lewis basicity but have no N—H bond. Tertiary amines attack the carbon of the carbonyl group in the ester bond, resulting in selective cleavage of the ester bond and producing monomers. In contrast, primary and secondary amines (RNH₂ and R₂NH) can react with the carboxylate segments of polyester via aminolysis, yielding low-molecular-weight amide products. The use of tertiary amine organocatalysts for selective polymer deconstruction has not been previously reported.

Tertiary amine organocatalysts are soluble in most organic solvents and water and thus provide the flexibility of finding the appropriate solvents for selectively transforming a specific class of polymers in mixed plastics. They are also highly selective for depolymerization of specific plastics synthesized via condensation polymerization and can only perform well in a narrow temperature range. Additionally, they have low boiling points (˜100° C.) and thus can be readily separated and recycled together with the solvent via energy-efficient membrane distillation/pervaporation methods. In embodiments, one or more tertiary amines are used as a liquid catalyst in the deconstruction processes described herein as they are dissolved in methanol, other organic solvents, or water.

Tertiary amines include linear amines, aromatic amines, cyclic amines, and diamines. Examples of linear amines include Tripropylamine (TPA) and Triethylamine (TEA). Examples of aromatic amines include N,N-dimethylaniline (DMA), and 4,N,N-trimethylaniline (TMA). Examples of cyclic amines include N-methylpiperidine (NMP) and 1,8-Diazabicyclo[5.4.0]undec-7-ene (DBU). Examples of diamines include N,N,N′,N′-Tetramethylethylenediamine (TMEDA) and N,N,N′,N′-Tetramethyl-1,3-propanediamine (TMPDA), and N,N,N′,N′-Tetraethylethylenediamine (TEEDA).

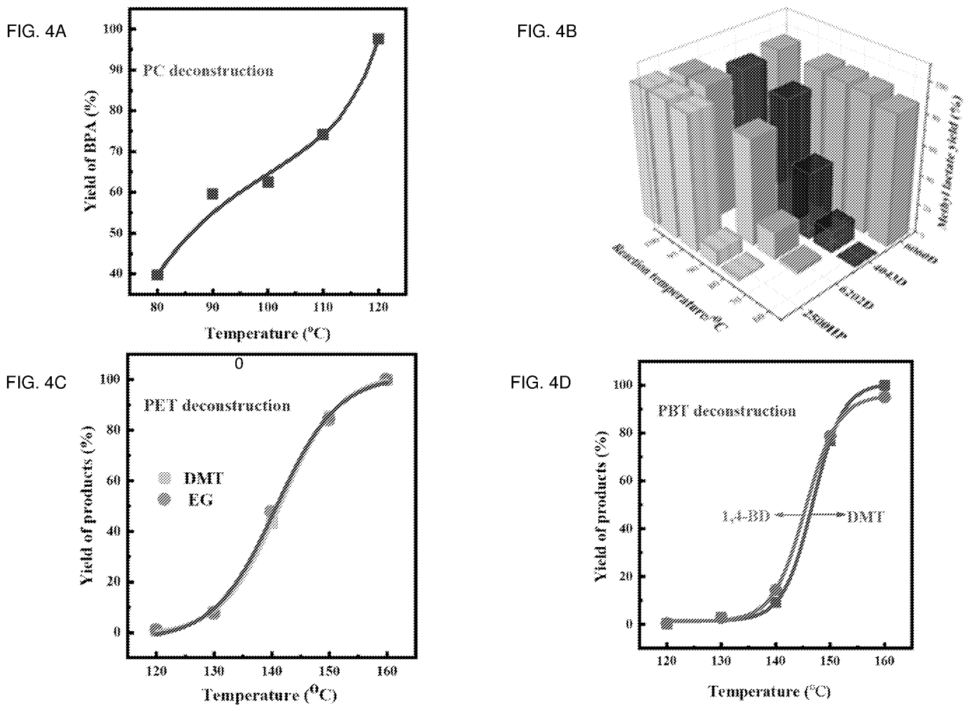

The present disclosure provides data demonstrating that the tertiary amines can readily depolymerize post-consumer PET bottles and textiles into their monomers, dimethyl terephthalate (DMT) and ethylene glycol (EG), in methanol solvent. By optimizing the reaction conditions, the yields of DMT and EG both reached ˜100% at 160° C. within 1 hour (FIG. 4A). Moreover, complete depolymerization of other polyester plastics, such as polylactic acid (PLA) (FIG. 4B), polycarbonate (PC) (FIG. 4C), polybutylene terephthalate (PBT) (FIG. 4D), was obtained from the tertiary amine-catalyzed methanolysis at 120° C., 160° C., and 100° C., respectively. Likewise, a tertiary amine catalyst also promoted the complete hydrolysis of Nylon 6 to ˜100% ε-caprolactam at relatively high temperatures (250° C.) (FIG. 25). The tertiary amines exhibited Brønsted basicity in the aqueous solution. Contrarily, without a catalyst, no conversion of Nylon 6 was observed at 250° C., implying that the amide bond is more resistant to cleavage than the ester bond. The use of a catalyst such as a tertiary amine allows the deconstruction reactions to proceed at a lower temperature under milder conditions. The low-molecular-weight monomers of polyesters or polyamides and DMT and EG are readily separated from the amine catalysts and the solvents by distillation, flash distillation, membrane pervaporation, and/or crystallization.

Although different tertiary amines can be used for deconstructing polyesters, NMP, TEA, and TEEDA are the top tertiary amine catalysts for deconstructing polyesters at a temperature of less than 200° C. Accordingly, a method and system are described herein for the selective deconstruction of polyesters into monomers and their derivatives, such as DMT and EG, via methanolysis using one or more tertiary amine catalysts under milder conditions. Milder conditions include a lower temperature than that conventionally used for deconstructing polyesters which is usually 200° C. or higher. Milder conditions also include performing the deconstruction of polyesters at a lower pressure. The operating pressure is a pressure that is higher than the vapor pressure of the solvent at the operating temperature. Milder conditions can include deconstructing for a reduced amount of time, such as for less than 2 hours. In embodiments, the method and system described herein for the selective deconstruction of polyesters include treating polyesters with NMP as the tertiary amine catalyst in methanol solvent under milder conditions such as 160° C. or lower for one hour (h). Other solvents for deconstructing polyesters by solvolysis including ethanol, propanol, butanol, or polyols, such as ethylene glycol can also be used with the tertiary amine catalyst for depolymerizing polyesters. The depoymerization mechanism would be similar to methanolysis.

Polyesters that can be depolymerized by solvolysis such as methanolysis with a catalyst, such as one or more tertiary amines include those containing ester bonds. Examples of such polyesters include PET, PLA, PC, PBT, polyurethanes (PU), polycaprolactone (PCL), polyhydroxybutyrate (PHB), polyglycolic acid (PGA), polyethylene adipate (PEA), polyethylene terephthalate (PET), polybutylene terephthalate (PBT), polyethylene naphthalate (PEN), polytrimethylene terephthalate (PTT), polyester of 4-hydroxybenzoic acid and 6-hydroxynaphthalene-2-carboxylic acid (LCP), and polyester of bisphenol A and phthalic acid (PAR).

The temperature for deconstructing polyesters includes from 80° C. to 180° C., 100° C. to 160° C., 120° C. to 160° C., 100° C., 120° C., or 160° C. The weakly bonded polyesters, for example, PLA, PC, and PU are deconstructed at the lower temperature range from about 100° C. to 120° C., while PET is deconstructed at a higher temperature of 160° C.

In embodiments, the polyesters can be pretreated with organic solvents such as methanol, acetone, or a mixture thereof prior to deconstruction. Polyesters such as those containing colors should be pretreated as the amine groups in the dyes can catalyze methanolysis of PET and produce byproducts.

Similarly, different tertiary amines can be used for deconstructing polyamides. TEA TPA, NMP, and TEEDA are the top tertiary amine catalysts for deconstructing polyamides at a temperature of less than 300° C. Therefore, a method and system are described herein for the selective deconstruction of polyamides into monomers, such as ε-caprolactam via hydrolysis using one or more tertiary amine catalysts with an aqueous solvent which is a milder reaction condition. Other solvents that can be used for depolymerizing polyamides by solvolysis include phenol, cresol, and DMF. Milder conditions also include deconstructing the polyamide at a lower temperature, lower pressure, and/or reduced time. In embodiments, the method and system described herein for deconstructing polyamides include treating the polyamide with TEA in an aqueous solvent under milder conditions such as 250° C. or lower and/or at a lower pressure. The operating pressure is a pressure that is higher than the vapor pressure of the solvent at the operating temperature. The length of time for deconstructing polyamides can be less than 6 hours.

Plastics that can be depolymerized by solvolysis using a tertiary amine and an aqueous solvent or another solvent include amide bonded plastics such as polyamides. Examples of polyamides include different Nylons such as poly(hexamethylene adipamide) (Nylon 6,6), polycaprolactam (Nylon 6), poly(hexamethylene dodecanediamide) (Nylon 6,12), poly(hexamethylene succinamide) (Nylon 4,6), poly(hexamethylene sebacamide) (Nylon 6,10), and Poly(ω-undecanamide) (Nylon 11). Other polyamides include semi-aromatic polyamides such as polyphthalamides (PPA), poly(hexamethylene teraphthalamide) (PA 6T), and poly(hexamethylene isophthalamide) (PA 6I).

The temperature for deconstructing polyamides is from 200° C. to 270° C., 200° C. to 250° C., 220° C. to 250° C., 230° C. to 250° C., 240° C. to 250° C., or 250° C.

The tertiary amines remain stable after each use and can be recycled for further use. The tertiary amines have long-term stability and can be recycled and reused for more than 10 time. The tertiary amines can be used for 2 to 10 more times, 2 to 9 more times, 2 to 8 more times, 2 to 7 more times, 2 to 6 more times, 2 to 5 more times, 2 more times, 3 more times, 4 more times, or 5 more times. In embodiments, the NMP and TEA can be recycled for further use for 2 to 10 more times or 2 to 5 more times in deconstruction reactions.

The present disclosure also describes a method of deconstructing polyolefins. In contrast to polyesters and polyamides, polyolefins are highly resistant to amine catalysts. However, it was found that polyolefins can be efficiently converted to liquid hydrocarbon molecules through hydrogenolysis with one or more solid catalysts, such as one or more supported metal catalysts with acid-base functionalities, which are more energy-efficient than pyrolysis or catalytic cracking. The present disclosure provides data demonstrating that lubricant-range hydrocarbons (yielding up to 60% C₁₇˜C₃₈) were obtained by hydrogenolysis of polyolefins, over the carbon-supported ruthenium (Ru) catalyst in an alkane solvent at 220° C. The hydrogen partial pressure is in the range of 1 to 100 bar, 5 to 90 bar, 10 to 80 bar, 10 to 70 bar, or 10 to 60 bar. The Ru catalyst exhibited a high catalytic activity on breaking the C—C bond with the aid of H₂, resulting in a formation of a variety of paraffinic hydrocarbon products (up to 90 wt % of valued liquid hydrocarbons) within 1 hour. The selection of solvents is crucial for PE depolymerization because the solvent effect can also influence the product distribution through the steric hindrance caused by the molecular structure. FIG. 42 shows that the yield of lubricant products (C23-C38) in methylcyclohexane is superior to that in either a water or an n-hexane solvent. The supported Ru solid catalyst can be readily recycled and reused after HDPE was fully depolymerized. The solid catalyst can be reused 2 to 5 more times, 2 more times, 3 more times, 4 more times, or 5 more times.

The present disclosure describes a method and system for deconstructing polyolefins into low molecular weight hydrocarbons via hydrogenolysis in liquid-phase solvents over a supported metal catalyst under mild conditions. The liquid-phase solvents include alkanes such as pentane, methylcyclohexane, hexane, heptane, octane, nonane, decane, undecane, dodecane, tridecane, tetradecane, pentadecane, and hexadecane. The low molecular weight hydrocarbons include alkanes and fuel-range and lubricant hydrocarbons. Examples of supported metal catalysts useful for the deconstruction of polyolefins include carbon-supported ruthenium catalyst (Ru/C), silica-supported ruthenium catalyst, and alumina-supported ruthenium catalyst. Other catalysts include supported platinum catalyst, supported rhodium catalyst, and supported nickel catalysts. The liquid-phase solvents include liquid-phase alkanes. Mild conditions include a temperature of lower than 260° C. and/or reduced time for depolymerization, for example, less than 2 hours. Examples of lower temperatures include 200° C. to 260° C., 200° C. to 240° C., 200 to 230° C., 200° C. to 220° C., 210° C. to 230° C., or 220° C. Examples of reduced time for depolymerization includes 0.5 hour to 2 hours, 0.5 hour to 1.5 hours, 0.5 hour to 1 hour, or 1 hour. Examples of H₂ pressure is in the range of 5 to 70 bar, 10 to 700 bar, 10 to 70 bar, or 10 to 60 bar.

Plastics that can be deconstructed by hydrogenolysis over a metal-supported catalyst include plastics with C—C bonds, such as polyolefins. Examples of polyolefins include HDPE, low density polyethylene (LDPE), linear LDPE (LLDPE), polypropylene (PP), poly(butylene), poly(butyl ethylene), poly(cyclohexylethylene), poly(ethylene), poly(isobutene), poly(isobutylethylene), poly(propylene), poly(propylethylene), and poly(tert-butylethylene).

In embodiments, the present disclosure describes a method and system for deconstructing HDPE by hydrogenolysis in liquid-phase alkanes over Ru/C catalyst under mild conditions into low molecular weight hydrocarbons such as jet-fuel-range and lubricant hydrocarbons. In embodiments, the mild conditions for the deconstruction include a temperature of 220° C. and 60 bar of Hydrogen for a time of one hour.

The solvents used in the deconstructions of the different plastics can also be recycled for further use. For example, the methanol can be recycled for deconstructing polyesters, and the water can be recycled for deconstructing polyamides. Similarly, the liquid-phase solvent for hydrogenolysis can be recycled for deconstructing polyethylenes.

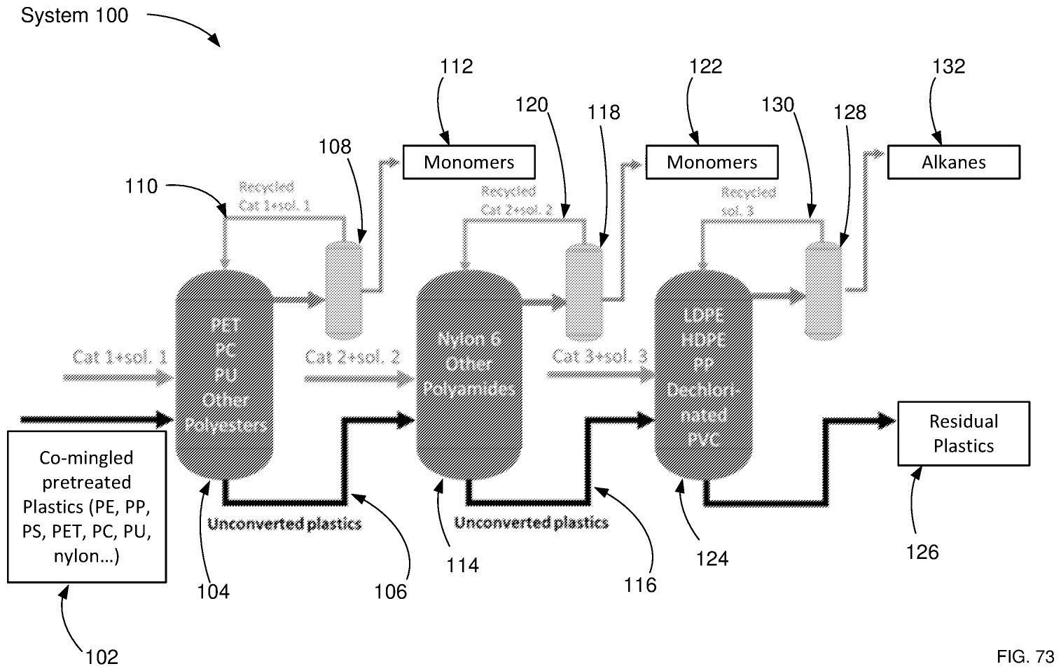

Additionally, the present disclosure describes a cost-effective process for the deconstruction of the co-mingled waste plastics streams through a novel sequential catalytic solvolysis (SeCatSol) process (or method) and system to produce monomers, chemicals, and hydrocarbon fuels. The SeCatSol process system combines the three separate methods of depolymerization including methanolysis, hydrolysis, and hydrogenolysis described herein for chemical upcycling of a mixture of plastics including polyesters, polyamides, and polyethylenes. The present disclosure describes a laboratory-scale SeCatSol process and system for chemical upcycling of a mixture of plastics including PET, Nylon 6, and PE. As shown in FIG. 73, the SeCatSol process includes three stages: (1) depolymerization of PET to DMT and EG by methanolysis or by using other solvents described herein, (2) depolymerization of Nylon 6 to ε-caprolactam by hydrolysis with an aqueous solvent or by using other solvents described herein, and (3) hydrogenolysis of PE to liquid hydrocarbons. As an example, in the first stage, PET in the mixed plastics is completely degraded with the N-methylpiperidine catalyst in methanol at 160° C. The solid residue containing unreacted Nylon 6 and PE from the first stage is used as the feedstock in the second stage of the process. In the second stage, using the trimethylamine catalyst in water, Nylon 6 in the feedstock of the first stage is depolymerized at 250° C., to yield ε-caprolactam. The solid residue containing unconverted PE is used as the feedstock in the third stage of the process. In the third stage using Ru/C catalyst, PE in the feedstock of the second stage is depolymerized and converted 220° C. to C7-C38 paraffin.

The SeCatSol process is designed to produce PET monomers first, then the monomers from Nylon 6, and lastly, liquid hydrocarbons from PE. FIG. 73 shows the materials balance of the SeCatSol process: in the 1^{st} stage, the methanolysis of PET was not influenced by the other plastics, Nylon 6 and HDPE, resulting in yields of ˜100% DMT and ˜100% EG, while PE or Nylon 6 did not degrade in methanol under the reaction conditions for PET depolymerization. Likewise, PE did not degrade in high-temperature water under the reaction conditions for depolymerization of Nylon 6 in the second hydrolysis stage. However, there was a decrease in the yield of ε-caprolactam, from ˜100% to ˜90% when the feedstock switched from pure Nylon-6 plastic to a plastic mixture of Nylon-6 and HDPE (the feedstock of stage 2). In the last hydrogenolysis stage, HDPE was completely converted and yielded ˜80% of C7-C38 paraffinic hydrocarbons.

In embodiments, the present disclosure describes a method and system for sequential deconstruction (SeCatSol) of mixed plastics, such as polyesters, polyamides, and polyolefins. The method includes the deconstruction of the polyesters into monomers by methanolysis with one or more tertiary amine catalysts, followed by the deconstruction of polyamides into monomers by hydrolysis with one or more tertiary amine catalysts, and followed by deconstructing polyethylenes into low molecular weight hydrocarbons such as alkanes by hydrogenolysis using a supported metal catalyst. Moreover, each step of the sequential deconstruction is performed under mild conditions and is a continuous process. Carrying out each step under mild conditions also reduces cost. Also, the monomers and low molecular hydrocarbons can be upcycled for synthesizing virgin polymers or fuel products. Further, the catalysts and solvents for each step can be recycled for use for further use as described herein.

The sequential deconstruction process and system described herein do not require sorting of plastics beforehand which reduces cost. The waste plastic feedstock that is fed continuously into the system is co-mingled plastics containing polyesters, polyamides, and polyethylenes. In embodiments, the waste plastic can be pretreated with organic solvents as described herein prior to entering the deconstruction process or system. Other pretreatments of the waste plastic includes shredding, cleaning, and removal of colorants, dyes, or other impurities.

FIG. 73 provides a schematic diagram of an exemplary embodiment of the SeCatSol plastic recycling system 100. System 100 includes three reactor tanks (104, 114, and 124), three separation apparatuses (108, 118, and 130), and four collection tanks (112, 122, 132, and 126) configured for the deconstruction of waste plastics. System 100 also includes lines configured for connecting the reactor tanks, separation apparatuses, and collection tanks. Polyesters are deconstructed in the first reactor tank 104. Polyamides are deconstructed in the second reactor tank 114, and polyolefins are deconstructed in reactor tank 124. Each reactor tank is connected to a heater so that each deconstruction reaction can proceed at the appropriate temperature.

Co-mingled plastic feedstock 102 is fed into reactor tank 104. Liquid catalyst, such as a tertiary amine dissolved in a solvent, for example, methanol, is added to reactor tank 104 and mixed with the plastic feedstock. In embodiments, the tertiary amine is NMP. The tank is heated to a low reaction temperature of 120° C. and then up to 160° C. for the deconstructions of the various polyesters into polyester monomers. In embodiments, the polyester is PET. Solid residue, which is unconverted plastics, remaining after the deconstruction in reactor tank 104 is separated by filtration and moved through line 106 to the second reactor tank 114, while the mixture of polyester monomers and their derivatives and the liquid catalyst is moved to the separation apparatus 108. In separation apparatus 108, the catalyst and solvent are separated from the mixture by distillation, for example, flash distillation, and recycled back to reactor tank 104 to be used again. Reactor tank 104 receives the recycled catalyst and solvent from separation apparatus 108 through line 110. Monomers are collected in tank 112. The monomers and their derivatives can be further purified in tank 112 via a purification process. In embodiments, the monomers and their derivatives are EG and DMT.

The unconverted plastic from reactor tank 104 is the feedstock for the second reactor tank 114. Liquid catalyst, such as tertiary amine dissolved in aqueous solvent or other solvents, is added to reactor tank 114 and mixed with the unconverted plastic. In embodiments, the tertiary amine is TEA and the solvent is water. The tank is heated to a high temperature of up to 250° C. for deconstructing the polyamides into polyamide monomers. In embodiments, the polyamides are Nylon 6. Solid residue, which is unconverted plastics, remaining after the deconstruction in reactor tank 114 is separated by filtration and moved through line 116 to the third reactor tank 124, while the mixture of polyamide monomers and the liquid catalyst is moved to separation apparatus 118. In separation apparatus 118, the catalyst and water are separated from the mixture by distillation, for example, flash distillation, and recycled back to reactor tank 114 to be used again. Reactor tank 114 receives the recycled catalyst and water from separation apparatus 118 through line 120. The aqueous solution of polyamide monomers is collected in tank 122.

The unconverted plastic from reactor tank 114 is the feedstock for the third reactor tank 124. Solid catalyst, such as supported metal catalyst, and solvent are added to reactor tank 114 and mixed with the unconverted plastic. In embodiments, the catalyst is RU/C and the solvent is an alkane solvent, such as methylcyclohexane. The tank is heated to a high temperature of up to 250° C. and hydrogen is added for hydrocracking the polyolefins into low molecular weight hydrocarbons. The H₂ pressure is 10 to 70 bar. In embodiments, the polyolefins are HDPE. Solid residue, which is residual plastics, remaining after the deconstruction in reactor tank 124 is separated by filtration and collected in tank 126, while the mixture of low molecular weight hydrocarbons, solid catalyst, and solvent are moved to separation apparatus 128. In separation apparatus 128, the solid catalyst and water are separated from the mixture by distillation and recycled back to reactor tank 124 to be used again. Reactor tank 124 receives the recycled catalyst and water from separation apparatus 128 through line 130. The liquid low molecular weight hydrocarbons are collected in tank 126.

After the removal of the oxygen-containing and nitrogen-containing waste plastics in reactor tanks 104 and 114, respectively, the catalytic cracking of the residues mainly containing the polyolefins are carried out to synthesize the fuel-range hydrocarbons. At the early stage, the external hydrocarbon solvent will be used to promote the cracking reaction. After the gasoline, jet, and diesel range hydrocarbons are obtained from the waste plastics, they can be used as solvents for further cracking of the waste polyolefins. The catalytic reaction condition and the selectivity are optimized according to the yields of the fuels. Almost all the PE should be cracked to the low molecular weight hydrocarbons, with ≥30% of the products being the jet fuels. The excess H₂ can be separated and recycled (≥90%) for the hydrocracking reaction.

The sequential catalytic solvolysis process described herein is a cost-effective plastic waste recycling process because it is (1) a flexible process, for example, the feedstock does not need to be presorted and it is tolerant of contaminants; (2) it can be operated continuously and sequentially, for example, one of plastic is deconstructed in each stage and unreacted polymers are further deconstructed in a downstream stage; and (3) it is energy efficient. The process produces monomers produced or valued chemicals stage by stage from co-mingled plastics.

In embodiments, the monomers obtained by the methods (or processes) and systems described herein can undergo polymerization to fresh polyesters and polymides for everyday use. The low molecular weight hydrocarbons obtained by the methods (or processes and systems described herein can be used as liquefied gas.

The terms “a,” “an,” “the” and similar referents used in the context of describing the claimed subject matter (especially in the context of the following claims) are to be construed to cover both the singular and the plural, unless otherwise indicated herein or clearly contradicted by context.

In addition, unless otherwise indicated, numbers expressing quantities of ingredients, constituents, reaction conditions, and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±15% of the stated value; ±10% of the stated value; ±5% of the stated value; ±4% of the stated value; ±3% of the stated value; ±2% of the stated value; ±1% of the stated value; or ±any percentage between 1% and 20% of the stated value.

Recitation of ranges of values herein is merely intended to serve as a shorthand method of referring individually to each separate value falling within the range. Unless otherwise indicated herein, each individual value is incorporated into the specification as if it were individually recited herein. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.5, 2.7, 3, 4, 5, 5.1, 5.3, 5.8, and 6. This applies regardless of the breadth of the range. Moreover, any ranges cited herein are inclusive.

As will be understood by one of ordinary skill in the art, each embodiment disclosed herein can comprise, consist essentially of, or consist of its particular stated element, step, ingredient, or component. Thus, the terms “include” or “including” should be interpreted to recite: “comprise, consist of, or consist essentially of.” The transition term “comprise” or “comprises” means includes, but is not limited to, and allows for the inclusion of unspecified elements, steps, ingredients, or components, even in major amounts. The transitional phrase “consisting of” excludes any element, step, ingredient, or component not specified. The transition phrase “consisting essentially of” limits the scope of the embodiment to the specified elements, steps, ingredients, or components and to those that do not materially affect the embodiment. In embodiments, those that do not materially affect the embodiment are those elements, steps, ingredients, or components that do not reduce the embodiment's ability in a statistically significant manner to perform a function such as the deconstruction of plastic.

All methods described herein can be performed in any suitable order unless otherwise indicated herein or otherwise clearly contradicted by context.

The use of any and all examples, or exemplary language (e.g., “such as”) provided herein is intended merely to better illuminate the claimed subject matter and does not pose a limitation on the scope of claimed subject matter. No language in the specification should be construed as indicating any non-claimed element essential to the practice of the claimed subject matter.

Groupings of alternative elements or embodiments of the claimed subject matter disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

The following exemplary embodiments and examples illustrate exemplary methods provided herein. These exemplary embodiments and examples are not intended, nor are they to be construed, as limiting the scope of the disclosure. It will be clear that the methods can be practiced otherwise than as particularly described herein. Numerous modifications and variations are possible in view of the teachings herein and, therefore, are within the scope of the disclosure.

### Exemplary Embodiments

The following are exemplary embodiments:
1. A method of recycling co-mingled plastic containing one or more polyesters, one or more polyamides, and one or more polyolefins, wherein the method includes
   (a) deconstructing the one or more polyesters in the co-mingled plastic by solvolysis, optionally methanolysis, with one or more tertiary amine catalysts and an organic solvent, optionally methanol, ethanol, propanol, butanol, or polyols, such as polyethylene glycol, to obtain polyester monomers and derivatives thereof, and unconverted plastic containing one or more polyamides and one or more polyolefins;
   (b) deconstructing the one or more polyamides in the unconverted plastic by solvolysis, optionally hydrolysis, with one or more tertiary amine catalysts and a solvent, optionally water, phenol, cresol, or DMF, to obtain polyamide monomers and unconverted plastic containing one or more polyolefins; and
   (c) deconstructing the one or more polylefins in the unconverted plastic by hydrogenolysis with one or more supported metal catalysts and an organic solvent, such as a liquid alkane, optionally pentane, methylcyclohexane, hexane, heptane, octane, nonane, decane, undecane, dodecane, tridecane, tetradecane, pentadecane, and hexadecane, to obtain low molecular weight hydrocarbons (LMWH).
2. The method of embodiment 1, wherein the method is a continuous sequential catalytic solvolysis process.
3. The method of embodiment 1 or 2, wherein the method does not require presorting of the co-mingled plastic.
4. The method of any one of embodiments 1-3, wherein the method includes collecting or recovering the polyester monomers and derivatives thereof, polyamide monomers, and/or LMWH.
5. The method of any one of embodiments 1-4, wherein the one or more polyesters include polyethylene terephthalate (PET), polylactic acid (PLA), polycarbonate (PC), polybutylene terephthalate (PBT), polyurethane (PU), polycaprolactone (PCL), polyhydroxybutyrate (PHB), polyglycolic acid (PGA), polyethylene adipate (PEA), polyethylene terephthalate (PET), polybutylene terephthalate (PBT), polyethylene naphthalate (PEN), polytrimethylene terephthalate (PTT), polyester of 4-hydroxybenzoic acid and 6-hydroxynaphthalene-2-carboxylic acid (LCP), and polyester of bisphenol A and phthalic acid (PAR).
6. The method of any one of embodiments 1-5, wherein the one or more polyamides include poly(hexamethylene adipamide) (Nylon 6,6), polycaprolactam (Nylon 6), poly(hexamethylene dodecanediamide) (Nylon 6,12), poly(hexamethylene succinamide) (Nylon 4,6), poly(hexamethylene sebacamide) (Nylon 6,10), and poly(ω-undecanamide) (Nylon 11), semi-aromatic polyamides such as polyphthalamides (PPA), poly(hexamethylene teraphthalamide) (PA 6T), and poly(hexamethylene isophthalamide) (PA 6I).
7. The method of any one of embodiments 1-6, wherein the one or more polyolefins include high density polyethylene (HDPE), low density polyethylene (LDPE), linear LDPE (LLDPE), polypropylene (PP), poly(butylene), poly(butyl ethylene), poly(cyclohexylethylene), poly(ethylene), poly(isobutene), poly(isobutylethylene), poly(propylene), poly(propylethylene), and poly(tert-butylethylene).
8. The method of any one of embodiments 1-7, wherein the one or more tertiary amine catalysts include linear amines, aromatic amines, cyclic amines, and diamines.
9. The method of any one of embodiments 1-8, wherein the one or more tertiary amines catalysts include tripropylamine (TPA), triethylamine (TEA), N,N-dimethylaniline (DMA), 4,N,N-trimethylaniline (TMA), N-methylpiperidine (NMP), 1,8-Diazabicyclo[5.4.0]undec-7-ene (DBU), N,N,N′,N′-Tetramethylethylenediamine (TMEDA), N,N,N′,N′-Tetramethyl-1,3-propanediamine (TMPDA), and N,N,N′,N′-Tetraethylethylenediamine (TEEDA).
10. The method of any one of embodiments 1-9, wherein the one or more tertiary amine catalysts deconstructing the polyesters include NMP, TEA, and TEEDA, optionally wherein the tertiary amine catalyst for methanolysis includes NMP.
11. The method of any one of embodiments 1-10, wherein the one or more tertiary amine catalysts for deconstructing the polyamides include TEA, TPA, NMP, and TEEDA, optionally wherein the tertiary amine catalyst for hydrolysis includes TEA.
12. The method of any one of embodiments 1-11, wherein the supported metal catalyst include supported ruthenium (Ru/C) catalyst, supported platinum catalyst, supported rhodium catalyst, and supported nickel catalyst.
13. The method of any one of embodiments 1-12, wherein the method further includes separating the one or more catalysts and/or solvent from the polyester monomers and/or polyamide monomers, and optionally, wherein separating includes, distillation, flash distillation, membrane pervaporation, and/or crystallization.
14. The method of any one of embodiments 1-13, wherein the method further includes separating the one or more supported metal catalysts from the LMWH, and optionally wherein separating includes filtration or distillation.
15. The method of any one of embodiments 1-12, wherein the method further includes recycling the catalysts and solvents.
16. The method of any one of embodiments 1-15, wherein the derivatives of the polyester monomers include dimethyl terephthalate (DMT) and ethylene glycol (EG).
17. The method of any one of embodiments 1-16, wherein the monomers of the polyamides include ε-caprolactam.
18. The method of any one of embodiments 1-17, wherein the deconstructed products of the polyolefins include alkanes, optionally C₇ to C₃₈ alkanes.
19. The method of any one of embodiments 1-18, wherein the deconstructed products of the polyolefins can be used as hydrocarbon fuels.
20. The method of any one of embodiments 1-19, wherein the method further includes mixing the co-mingled plastic with the tertiary amine catalyst and methanol in a vessel and heating the mixture to a set temperature of less than 200° C., and optionally wherein the method includes heating the mixture from 80° C. to 180° C., 100° C. to 160° C., or 120° C. to 160° C., or heated to 100° C., 120° C., or 160° C.
21. The method of embodiment 20, wherein the temperature is increased incrementally every 15 to 60 minutes, and optionally wherein the temperature is increased 10° C. every 30 minutes.
22. The method of embodiment 20 or 21, wherein the method further includes sealing and purging the vessel containing the mixture with N₂ and/or H₂, and releasing the gas to keep at atmospheric pressure at room temperature, and optionally wherein prior to heating, the vessel is purged two times, three times, or four times with 300 psi to 500 psi of N₂ and/or H₂ or 400 psi of N₂ and/or H₂.
23. The method of any one of embodiments 1-22, wherein the method further includes washing the unconverted plastic containing one or more polyamides and one or more polyolefins with one or more organic solvents, optionally methanol, and drying the unconverted plastics prior to hydrolysis.
24. The method of any one of embodiments 1-23, wherein the method further includes mixing the unconverted plastic containing one or more polyamides and one or more polyolefins with a tertiary amine catalyst and aqueous solvent and heating the mixture to a set temperature of less than 300° C., and optionally wherein the temperature for hydrolysis of the unconverted plastic includes 200° C. to 270° C., 200° C. to 250° C., 220° C. to 250° C., 230° C. to 250° C., 240° C. to 250° C., or 250° C.
25. The method of embodiment 24, wherein the method further includes sealing and purging the vessel containing the mixture with N₂ and/or H₂, and releasing the gas to keep at atmospheric pressure at room temperature, and optionally wherein prior to heating, the vessel is purged two times, three times, or four times with 300 psi to 500 psi of N₂ and/or H₂ or 400 psi of N₂ and/or H₂.
26. The method of any one of embodiments 1-25, wherein the method further includes washing the unconverted plastic containing one or more polyolefins with one or more aqueous solvents, optionally water, and drying the unconverted plastics prior to hydrogenolysis.
27. The method of any one of embodiments 1-26, wherein the method further includes mixing the unconverted plastic containing one or more polyolefins with a supported metal catalyst and hexane and heating the mixture to a set temperature of less than 260° C., and optionally wherein the temperature for hydrogenolysis of the unconverted plastic includes 200° C. to 260° C., 200° C. to 240° C., 200° C. to 230° C., 200° C. to 220° C., 210° C. to 230° C., or 220° C.
28. The method of embodiment 27, wherein the method further includes sealing and purging the vessel containing the mixture with N₂ and/or H₂, releasing the gas to keep at atmospheric pressure at room temperature, and pressurizing the vessel with H₂ at room temperature, and optionally wherein prior to heating, the vessel is purged two times, three times, or four times with 300 psi to 500 psi of N₂ and/or H₂ or 400 psi of N₂ and/or H₂ and optionally wherein the vessel is pressurized with H₂ to 20 bar to 40 bar or 30 bar.
29. The method of any one of embodiments 1-28, wherein the method further includes pretreating the co-mingled plastic with one or more organic solvents prior to deconstruction, and optionally wherein the one or more organic solvents include methanol, acetone, or a mixture thereof.
30. A method of deconstructing one or more polyesters, wherein the method includes deconstructing the one or more polyesters by solvolysis, optionally methanolysis, with one or more tertiary amine catalysts in a solvent, optionally methanol, ethanol, propanol, butanol, or polyols, such as polyethylene glycol, and obtaining polyester monomers and derivatives thereof.
31. The method of embodiment 30, wherein the one or more polyesters include polyethylene terephthalate (PET), polylactic acid (PLA), polycarbonate (PC), polybutylene terephthalate (PBT), polyurethane (PU), polycaprolactone (PCL), polyhydroxybutyrate (PHB), polyglycolic acid (PGA), polyethylene adipate (PEA), polyethylene terephthalate (PET), polybutylene terephthalate (PBT), polyethylene naphthalate (PEN), polytrimethylene terephthalate (PTT), polyester of 4-hydroxybenzoic acid and 6-hydroxynaphthalene-2-carboxylic acid (LCP), and polyester of bisphenol A and phthalic acid (PAR).
32. The method of embodiment 30 or 31, wherein the one or more tertiary amine catalysts include linear amines, aromatic amines, cyclic amines, and diamines.
33. The method of any one of embodiments 30-32, wherein the one or more tertiary amines catalysts include tripropylamine (TPA), triethylamine (TEA), N,N-dimethylaniline (DMA), 4,N,N-trimethylaniline (TMA), N-methylpiperidine (NMP), 1,8-Diazabicyclo[5.4.0]undec-7-ene (DBU), N,N,N′,N′-Tetramethylethylenediamine (TMEDA), N,N,N′,N′-Tetramethyl-1,3-propanediamine (TMPDA), and N,N,N′,N′-Tetraethylethylenediamine (TEEDA).
34. The method of any one of embodiments 30-34, wherein the one or more tertiary amine catalysts for methanolysis include NMP, TEA, and TEEDA, optionally wherein the tertiary amine catalyst for methanolysis includes NMP.
35. The method of any one of embodiments 30-34, wherein the method further includes separating the one or more catalysts and/or solvent from the polyester monomers and/or derivatives thereof and optionally, wherein separating includes, distillation, flash distillation, membrane pervaporation, and/or crystallization.
36. The method of any one of embodiments 30-35, wherein the method further includes recycling the catalyst and solvent.
37. The method of any one of embodiments 30-36, wherein the derivatives of the polyester monomers include dimethyl terephthalate (DMT) and ethylene glycol (EG).
38. The method of any one of embodiments 30-37, wherein the method further includes mixing the one or more polyesters with the tertiary amine catalyst and methanol in a vessel and heating the mixture to a set temperature of less than 200° C., and optionally wherein the method includes heating the mixture from 80° C. to 180° C., 100° C. to 160° C., or 120° C. to 160° C., or heated to 100° C., 120° C., or 160° C.
39. The method of embodiment 38, wherein the temperature is increased incrementally every 15 to 60 mintues, and optionally wherein the temperature is increased 10° C. every 30 minutes.
40. The method of embodiment 38 or 39, wherein the method further includes sealing and purging the vessel containing the mixture with N₂ and/or H₂, and releasing the gas to keep at atmospheric pressure at room temperature, and optionally wherein prior to heating, the vessel is purged two times, three times, or four times with 300 psi to 500 psi of N₂ and/or H₂ or 400 psi of N₂ and/or H₂.
41. The method of any one of embodiments 30-40, wherein the method further includes treating the one or more polyesters with one or more organic solvents prior to deconstruction, and optionally wherein the one or more organic solvents include methanol, acetone, or a mixture thereof.
42. A method of deconstructing one or more polyamides, wherein the method includes solvolysis, optionally hydrolysis, with one or more tertiary amine catalysts and a solvent, optionally water, phenol, cresol, or DMF, and obtaining polyamide monomers.
43. The method of embodiment 42, wherein the one or more polyamides include poly(hexamethylene adipamide) (Nylon 6,6), polycaprolactam (Nylon 6), poly(hexamethylene dodecanediamide) (Nylon 6,12), poly(hexamethylene succinamide) (Nylon 4,6), poly(hexamethylene sebacamide) (Nylon 6,10), and poly(ω-undecanamide) (Nylon 11), semi-aromatic polyamides such as polyphthalamides (PPA), poly(hexamethylene teraphthalamide) (PA 6T), and poly(hexamethylene isophthalamide) (PA 6I).
44. The method of embodiments 42 or 43, wherein the one or more tertiary amine catalysts include linear amines, aromatic amines, cyclic amines, and diamines.
45. The method of any one of embodiments 42-44, wherein the one or more tertiary amines catalysts include tripropylamine (TPA), triethylamine (TEA), N,N-dimethylaniline (DMA), 4,N,N-trimethylaniline (TMA), N-methylpiperidine (NMP), 1,8-Diazabicyclo[5.4.0]undec-7-ene (DBU), N,N,N′,N′-Tetramethylethylenediamine (TMEDA), N,N,N′,N′-Tetramethyl-1,3-propanediamine (TMPDA), and N,N,N′,N′-Tetraethylethylenediamine (TEEDA).
46. The method of any one of embodiments 42-45, wherein the one or more tertiary amine catalysts for hydrolysis include TEA, TPA, NMP, and TEEDA, optionally wherein the tertiary amine catalyst for hydrolysis includes TEA.
47. The method of any one of embodiments 46, wherein the method further includes separating the one or more catalysts and/or solvent from the polyamide monomers, and optionally, wherein separating includes, distillation, flash distillation, and/or membrane pervaporation.
48. The method of any one of embodiments 42-47, wherein the method further includes recycling the catalysts and solvents.
49. The method of any one of embodiments 42-48, wherein the monomers of polyamides include ε-caprolactam.
50. The method of any one of embodiments 42-49, wherein the method further includes mixing the one or more polyamides with a tertiary amine catalyst and aqueous solvent and heating the mixture to a set temperature of less than 300° C., and optionally wherein the temperature for hydrolysis of the unconverted plastic includes 200° C. to 270° C., 200° C. to 250° C., 220° C. to 250° C., 230° C. to 250° C., 240° C. to 250° C., or 250° C.
51. The method of embodiment 50, wherein the method further includes sealing and purging the vessel containing the mixture with N₂ and/or H₂, and releasing the gas to keep at atmospheric pressure at room temperature, and optionally wherein prior to heating, the vessel is purged two times, three times, or four times with 300 psi to 500 psi of N₂ and/or H₂ or 400 psi of N₂ and/or H₂.
52. A method of deconstructing one or more polyolefins, wherein the method includes hydrogenolysis of the one or more polyoefins with one or more supported metal catalysts and an organic solvent, such as a liquid alkane, optionally pentane, methylcyclohexane, hexane, heptane, octane, nonane, decane, undecane, dodecane, tridecane, tetradecane, pentadecane, and hexadecane, and obtaining low molecular weight hydrocarbons (LMWH).
53. The method of embodiment 52, wherein the one or more polyolefins include high density polyethylene (HDPE), low density polyethylene (LDPE), linear LDPE (LLDPE), polypropylene (PP), poly(butylene), poly(butyl ethylene), poly(cyclohexylethylene), poly(ethylene), poly(isobutene), poly(isobutylethylene), poly(propylene), poly(propylethylene), and poly(tert-butylethylene).
54. The method of embodiment 52 or 53, wherein the supported metal catalyst include supported ruthenium (Ru/C) catalyst, supported platinum catalyst, supported rhodium catalyst, and supported nickel catalyst.
55. The method of any one of embodiments 52-54, wherein the method further includes separating the one or more supported metal catalysts from the LMWH, and optionally wherein separating includes filtration or distillation.
56. The method of any one of embodiments 52-55, wherein the deconstructed products of the polyolefins include alkanes, optionally C₇ to C₃₈ alkanes.
57. The method of any one of embodiments 52-56, wherein the deconstructed products of polyolefins can be used as hydrocarbon fuels.
58. The method of any one of embodiments 52-57, wherein the method further includes mixing the one or more polyolefins with a supported metal catalyst and hexane and heating the mixture to a set temperature of less than 260° C., and optionally wherein the temperature for hydrogenolysis of the unconverted plastic includes 200° C. to 260° C., 200° C. to 240° C., 200° C. to 230° C., 200° C. to 220° C., 210° C. to 230° C., or 220° C.
59. The method of embodiment 58, wherein the method further includes sealing and purging the vessel containing the mixture with N₂ and/or H₂, releasing the gas to keep at atmospheric pressure at room temperature, and pressurizing the vessel with H₂ at room temperature, and optionally wherein prior to heating, the vessel is purged two times, three times, or four times with 300 psi to 500 psi of N₂ and/or H₂ or 400 psi of N₂ and/or H₂ and optionally wherein the vessel is pressurized with H₂ to 20 bar to 40 bar or 30 bar.
60. A system for recycling co-mingled plastic containing one or more polyesters, one or more polyamides, and one or more polyolefins, wherein the system includes
   (a) a reactor tank for deconstructing the one or more polyesters in the co-mingled plastic by solvolysis, optionally methanolysis, with one or more tertiary amine catalysts in a solvent, optionally methanol, ethanol, propanol, butanol, or polyols, such as polyethylene glycol, to obtain polyester monomers and derivatives thereof, and unconverted plastic containing one or more polyamides and one or more polyolefins;
   (b) a reactor tank for deconstructing the one or more polyamides in the unconverted plastic by solvolysis, optionally hydrolysis, with one or more tertiary amine catalysts and a solvent, optionally water, phenol, cresol, or DMF, to obtain polyamide monomers and unconverted plastic containing one or more polyolefins; and
   (c) a reactor tank for deconstructing one or more polyolefins in the unconverted plastic hydrogenolysis with one or more supported metal catalysts and an organic solvent, such as a liquid alkane, optionally pentane, methylcyclohexane, hexane, heptane, octane, nonane, decane, undecane, dodecane, tridecane, tetradecane, pentadecane, and hexadecane, to obtain low molecular weight hydrocarbons (LMWH).
61. The system of embodiment 60, wherein the reactor tank for deconstructing polyester by solvolysis, optionally methanolysis, is connected to the reactor tank for deconstructing polyamides by solvolysis, optionally hydrolysis, through a line for moving unconverted plastic containing one or more polyamides and one or more polyolefins to the reactor tank for deconstructing polyamides by solvolysis, optionally hydrolysis, wherein the reactor tank for deconstructing polyamides by solvolysis, optionally hydrolysis, is connected to the reactor tank for deconstructing polyolefins by hydrogenolysis through a line for moving unconverted plastic containing one or more polylefins to the reactor tank for hydrogenolysis, and the reactor tank for hydrogenolysis is connected to a vessel for collecting or recovering residual plastics through a line for moving the residual plastics to the vessel.
62. The system of embodiment 60 or 61, wherein each of the reactor tanks is connected to an individual separation apparatus for separating the catalyst and solvent from the polyester monomers and derivatives thereof, for separating the catalyst and solvent from the polyamide monomers, or for separating the supported metal catalyst and solvent from the LMWH.
63. The system of embodiment 62, wherein each of the separation apparatus is connected to its respective reactor tanks for recycling the separated catalyst and solvent.
64. The system of embodiment 62 or 63, wherein each the separation apparatus is further connected to an individual vessel for collecting the polyester monomers and derivatives thereof, for collecting polyamide monomers, or for collecting LMWH.
65. The method of any one of embodiments 1-59 and the system of any one of embodiments 60-64, wherein the method and system are for recovering polyester monomers and derivatives, polyamide monomers, and LMWH.
66. The method of any one of embodiments 1-59 and 65 and the system of any one of embodiments 60-65, wherein the method and system includes recovering polyester monomers and derivatives, polyamide monomers, and LMWH

### EXAMPLES

### Example 1A. Highly Selective Deconstruction of Polyesters in Multi-Material Plastics Waste

Summary A decades-long accumulation of waste plastics has caused a significant negative impact on the environment. Plastic recycling could address this long-standing problem. However, the complex composition of multi-material plastics limits the technical feasibility of sorting and decreases the economic soundness of recycling. An efficient approach to selectively deconstruct polyesters, either stand-alone or in a mixture without sorting, with the tertiary amine catalysts, e.g., N-methylpiperidine (NMP), is reported. For instance, the post-consumer PET bottle materials were depolymerized into their monomers, ethylene glycol (EG) and dimethyl terephthalate (DMT), both in ˜100% yields, under mild conditions (160° C. and 1 h). The ab-initio molecular dynamics (AIMD) study suggested that the low basicity of NMP attributed to the high selectivities to the PET monomers. In situ and operando ¹H and ¹³C NMR demonstrated that methanol's nucleophilicity was enhanced via hydrogen bonding with NMP, facilitating the PET ester bond cleavage. Furthermore, this generic catalytic approach has been shown for deconstructing other polyesters, including polylactic acid (PLA), polycarbonate (PC), polybutylene terephthalate (PBT), or selectively deconstructing PET in multilayer packaging materials.

Introduction. Plastics are already an inalienable part of life today. However, for decades, mismanaged post-consumer plastics are not effectively recycled, resulting in the plight of discarded plastics piling up in landfills and the ocean and causing detrimental effects on the environment. Besides, plastic production is energy-intensive and accounts for more than 3% of total US energy consumption. Recycling plastic seems to be an appealing approach to address this long-standing problem and enhance environmental sustainability. Yet, less than 10% of plastics are currently recycled, most of which are downcycled mechanically (via sorting, melting, and reprocessing), or repurposed into low-value products. For instance, even though PET (polyethylene terephthalate), a widely used polyester material making up ˜18% of global plastic production, is the most recycled plastic in industry, the recycling rate of PET plastic is still limited (e.g., in the United States, only 29.1% PET bottles and jars were recycled in 2018). Nevertheless, the complex composition of co-mingled or multi-material waste plastics limits the technical feasibility of physical sorting and decreases the economic soundness of mechanical recycling. Therefore, innovations in plastic chemical recycling methods are urgently needed to selectively deconstruct polymers in mixed plastic waste.

Chemical recycling, also known as closed-loop recycling, breaks the deadlock over the properties of recycled plastics as long-chain waste polymers are decomposed to produce the same molecular building blocks (monomers) that were originally used to make them. The advantage of closed-loop recycling is that these monomers can be repeatedly re-polymerized to produce high-performance materials with the same properties as the original ones. Among all the post-consumer plastics types, condensation polymers such as polyester and polyamide (PA) can be depolymerized into monomers by solvolysis and be used to produce virgin polymer resins. However, the market share of PAs is rather small compared to polyesters.

The chemical recycling processes of polyester plastics include hydrolysis, glycolysis, and methanolysis. Hydrolysis of polyesters usually requires strong acid or base catalysts, such as sulfuric acid or potassium hydroxide, which are corrosive at elevated reaction temperatures. Glycolysis exhibits a low tolerance of the contaminations because of the high boiling points of the solvent and the products and low monomer recoveries in the presence of the catalysts. Methanolysis is featured with the low cost of the solvents and has a high tolerance to the contaminations from post-consumer polyesters.

The high catalytic efficiency and stability of catalysts and the integration between the methanolysis and product separations are the key to successful closed-loop recycling. Loop™ (Loop Industries, Los Angeles, CA) in Canada and Carbios™ (Carbios, Paris, Franc) in France have developed a viable long-term solution to produce terephthalic acid (PA) or dimethyl terephthalate (DMT) and ethylene glycol (EG) from waste PET plastic under strongly alkaline conditions. The researchers at International Machine Business (IBM) developed a new catalytic process using 1,8-diazabicyclo(5.4.0)undec-7-ene (DBU) and 1,5,7-triazabicyclo[4.4.0]dec-5-ene (TBD) as the catalysts called VolCat to convert PET into Bis(2-hydroxyethyl) terephthalate(BHET) in ethylene glycol solvent at 200° C. Various other catalysts, such as ZnO-NPs/NBu₄CI, zinc acetate, aluminum triisopropoxide (AIP), triazabicyclodecene:methanesulfonic acid (TBD:MSA), etc., could result in an environmentally effective method of recycling polyester plastic wastes. However, the current state-of-the-art catalysts have various drawbacks such as poor stability, difficult separations, toxicity, or high cost. Hence, developing more robust, efficient, and easily separable catalysts is much desired for the methanolysis of polyesters.

Methanolysis of polyesters is a transesterification reaction that is usually slow but can be accelerated by incorporating a base. Amines are considered good sources of Lewis base. Primary and secondary amines are chemically reactive with alcohols or with polyester monomers due to the active hydrogen in the amino groups so that they are excluded from the study. Tertiary organic amines are featured without an active hydrogen atom connecting the N-center, and thus the amidation of PET can be mitigated. In addition, tertiary amines have the lowest boiling points relative to all types of amines attributing to the minimal intermolecular hydrogen bonding. As tertiary amines are fairly volatile and thus can be easily separated by distillation. Besides, it is widely accepted that tertiary amines catalyze transesterification reactions due to their Lewis basicity. Herein, in this paper, four types of tertiary organic amines, including linear, cyclic, aromatic, and diamines, were used as catalysts in the individual methanolytic depolymerization of polyesters. The influence of contaminants in the PET feedstock, such as colorants in PET textile and bottle, on the PET deconstruction, was also investigated. The mechanisms of the tertiary organic amines catalyzed methanolysis of post-consumer PET were investigated by operando and in situ magic-angle spinning (MAS) NMR characterizations and ab-initio molecular dynamics calculations. Finally, a variety of polyester plastics, including post-consumer PET textile, poly(lactic acid) (PLA), polycarbonate (PC), polybutylene terephthalate (PBT), were converted to the corresponding monomers/esters in the methanolysis process with the best-performed amine catalyst. Selective recycling of the polyesters in the co-mingled plastics, polyester blend with other polymers, and multilayer polyester-containing packaging materials was challenging in the waste plastic recycling and upcycling sectors. For example, poly(lactic acid) (PLA) can contaminate the polyethylene terephthalate (PET) waste stream, resulting in poorer recovery and increased cost by necessitating investment in new sorting equipment. Pre-sorting of plastics before recycling is expensive and time-intensive and recycling requires large amounts of energy and often results in low-quality polymers. In this paper, the selective methanolysis of polyesters in the plastic mixtures was applied to avoid the need for physical sorting, resulting in “chemical sorting” at the molecular level and simultaneously upcycling.

Materials and methods. The post-consumer polyethylene terephthalate (PET) sample was the Kirkland Signature Premium Drinking Water bottle. The PET textile sample was provided by the Department of Apparel, Merchandising, Design, and Textiles at Washington State University. The commercial-grade poly(lactic acid) (PLA) samples 4043D, 6060D, 6202D, and 2500HP were donated by NatureWorks. The polycarbonate (PC) sample was Corning® (Corning Incorporated, Corning, NY) square polycarbonate storage bottle from Sigma Aldrich. The poly(1,4-butylene terephthalate) (PBT) sample was purchased from Sigma Aldrich. Other plastics, including polyethylene(PE), polyvinyl chloride (PVC), polypropylene(PP), polystyrene (PS), and Nylon 6 were purchased from Sigma-Aldrich. The multilayer packaging materials, including PET/PA/PE film for beer/milk package and PET/PE film for vacuum seal storage, were purchased from Walmart.com. Quantitative analysis of PET in multilayer samples was carried out by ¹H-NMR spectroscopy using the calibration curve method. Methanol (EMD Millipore, ≥99.8%), N-methylpiperidine (NMP) (Sigma-Aldrich, 99%), Tripropylamine (Sigma-Aldrich, ≥98%), Triethylamine (Alfa Aesar, 99%), N,N-dimethylaniline (Sigma-Aldrich, 99%), 4,N,N-trimethylaniline (Sigma-Aldrich, 99%), 1,8-Diazabicyclo[5.4.0]undec-7-ene (Sigma-Aldrich, 98%), N,N,N′,N′-Tetramethylethylenediamine (Alfa Aesar, 99%), N,N,N′,N′-Tetramethyl-1,3-propanediamine (Sigma-Aldrich, 99%), N,N,N′,N′-Tetraethylethylenediamine (Sigma-Aldrich, 98%), 1,1,1,3,3,3-Hexafluoro-2-propanol (Alfa Aesar, 99%), Chloroform-d (Sigma Aldrich, 99.8 atom % D, contains 0.03% (v/v) TMS), Acetone (Avantor Performance Materials, LLC, 99.3%), Dimethyl terephthalate (Sigma-Aldrich, ≥99%), Ethylene glycol (Sigma-Aldrich, 99.8%), 1,4-Butanediol (Sigma-Aldrich, 99%), Methyl (S)-(−)-lactate (Alfa Aesar, 97%), Bisphenol A (Sigma-Aldrich, ≥99%) were used in this example. All chemicals were acquired in their pure form and utilized without any prior treatment.

Catalytic reaction methodologies. The catalytic reactions were performed in the Multiple Reactor System (Parr Series 500, 45 mL) incorporated with the temperature controller (4871 series). Generally, the reactants (PET bottle sample, or PET textile sample, or PLA pellets, or PC bottle sample, or PBT pellets, or plastics mixture, or multilayer packaging films), the solvent (methanol), and a selected volume of tertiary organic amine catalyst were placed in the vessels. The vessels were sealed and purged three times with N₂. The reactors were not pressurized at room temperature. The reaction mixture was subjected to simultaneous magnetic stirring (700 rpm) and heating to the set temperature (30 min) and kept at the set temperature for the set reaction duration. After the reaction, the reaction vessels were immediately quenched in cooling water for fast cooling.

The PET methanolysis reactions with NMP were repeated five times during the catalyst stability test. After each run, the liquid in the vessel was collected and transferred into a centrifuge tube (45 mL) and subjected to centrifugation in an Eppendorf 5810 R Centrifuge. Then, the supernatant was filtered with a 0.45 μm PES filter to remove the small PET particles. Next, a certain amount of 0.2 M NMP methanol solution was added until the apparent recycled solution volume reached 20 mL. Finally, the fresh PET sample (0.1 g) was added for the recyclability test. The above recycling procedures were repeated five times to estimate the catalytic stability of NMP in the methanolysis of PET.

To separate the dyes and to investigate the effect of dyes on the PET degradation performance, colored PET textiles were subjected to individual pretreatment with methanol, acetone, and a mixture of methanol and acetone. The pretreatment system was kept at 50° C. while being stirred overnight. The PET textiles were then washed with the corresponding solvent at least three times and dried in air to obtain the white PET textiles. The methanolysis procedure of white PET textiles was the same as that of the colored PET textiles.

Chemical analysis. Since there is no evidence of gas products formation, the reactor was disassembled without venting after a reaction. The vessels were rinsed with the solvent, and the solid residues were collected. All the liquid phases were subjected to filtration (0.45 μm syringe filter) prior to analysis. The liquid phase was then analyzed by a GCMS QP-2020 (Shimadzu) to investigate the unknown components, and both GCMS QP-2020 and GC-FID (GC-2010, Shimadzu) were used to quantify the products. After the determination of the product contents, the yields of the dimethyl terephthalate (D) and the ethylene glycol (E) were calculated by the following equations.

$$D = \frac{{n}_{1}}{{n}_{0}} \times 100 \% \qquad ( 1 )$$

$$E = \frac{{n}_{2}}{{n}_{0}} \times 100 \% \qquad ( 2 )$$

Where nₒ is the moles of the repeat unit of fresh PET reactants before reaction, n, is the moles of dimethyl terephthalate after the reaction, and n₂ is the moles of ethylene glycol after the reaction. The yields of other monomers or esters from other polyesters were also calculated following a similar procedure.

NMR Experiments. ¹H-NMR measurement was conducted with a 400 Liquid State NMR (One Probe, X-tunable and ¹H) over 256 scans, one-second relaxation delay, and 45 degrees of pulse angle. The fresh and residual samples, the liquid product, the standard dimethyl terephthalate (DMT) sample, standard ethylene glycol (EG) sample, 1,1,1,3,3,3-hexafluoro-2-propanol, and NMP were tested by ¹H-NMR.

For the NMR measurement of fresh PET, one piece of scrap from a transparent PET bottle was dissolved in 1 mL of 1,1,1,3,3,3-hexafluoro-2-propanol (HFIP), then 1 mL of chloroform-d (99.8 atom % D, contains 0.03% (v/v) TMS) was added when PET was completely dissolved. For the NMR measurement of residues after a reaction, the residual was separated from the liquid products by centrifugation in an Eppendorf 5810 R Centrifuge. The residual samples or the liquid products were dried in a fume hood overnight. The dried residual samples or liquid products were also dissolved in 1 mL of 1,1,1,3,3,3-hexafluoro-2-propanol (HFIP) in a 2 mL autosampler glass vial, in which 1 mL of chloroform-d (99.8 atom % D, contains 0.03% (v/v) TMS) was also added. After the liquid was completely mixed, the supernatant was transferred into an NMR tube.

A fixed amount of NMP was dissolved in 1 mL of chloroform-d (99.8 atom % D, contains 0.03% (v/v) TMS), and the solution was transferred into an NMR tube. One piece of standard dimethyl terephthalate sample and one drop of standard ethylene glycol sample were dissolved in 1 mL of chloroform-d (99.8 atom % D, which contains 0.03% (v/v) TMS) separately, and the clear solution was also individually transferred into an NMR tube.

Results and Discussion.

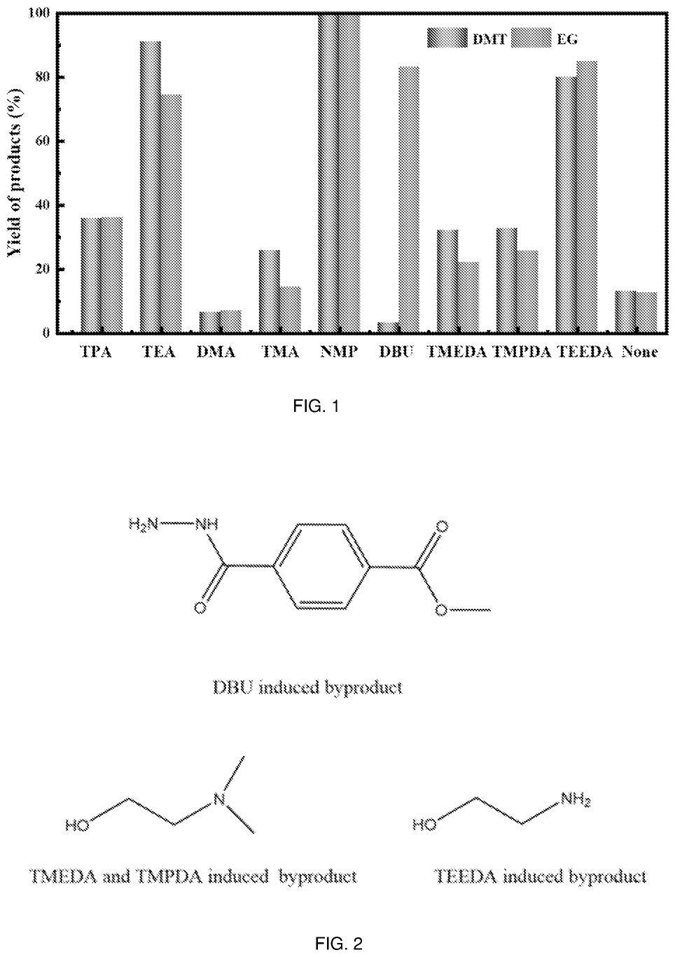

Catalyst screening. Complete depolymerization of PET can be accomplished under supercritical methanol conditions in the absence of a catalyst; though, the major drawback of such a process is the high operational cost due to high pressure and temperature. Complete depolymerization of transparent PET bottle material in this example can be achieved at the elevated reaction temperature, i.e., 200° C. Thus, a catalyst is required to lower the reaction temperature. The catalytic activities of the four types of tertiary organic amines, including (1) linear amines: triethylamine (TEA), tripropylamine (TPA), (2) aromatic amine: N,N-dimethylaniline (DMA), 4,N,N-trimethylaniline (TMA), (3) cyclic amines: N-methylpiperidine (NMP), 1,8 Diazabicyclo[5.4.0]undec-7-ene (DBU), and (4) diamines: N,N,N′,N′-Tetramethyl-1,3-propanediamine (TMPDA), N,N,N′,N′-Tetramethylethylenediamine (TMEDA), and N,N,N′,N′-Tetraethylethylenediamine (TEEDA), were assessed, based on the yields of DMT and EG from the methanolysis of PET bottle, as shown in FIG. 1. In the absence of catalysts, the yields of DMT and EG are 13.1% and 12.0%, respectively. The low yields of DMT and EG indicated that the depolymerization of the post-consumer PET bottle at low temperatures was hardly accomplished in the absence of a catalyst. With the incorporation of catalyst, i.e., NMP, the yields of DMT and EG both reached ˜100% at 160° C. By contrast, the catalytic activities of the rest of the tertiary amines are inferior to that of NMP.

TEA was more active than TPA in terms of yields of DMT and EG. The catalytic activity of TPA was inhibited due to the steric hindrance of propyl groups. However, TEA also yielded a byproduct, which lowered the yield of EG. When DBU was used, the yield of DMT was only 3.1%, whereas the yield of EG is up to 83.3%. Though NMP and DBU have a similar molecular structure, NMP is a mild base while DBU owns strong basicity. The pKa value and steric hindrance of tertiary amines are closely related to their catalytic activities. When the temperature approached 140° C., the DBU decomposition started. Thus, the exposed N-atom can react with terephthalate through amidation, leading to the poor yield of DMT. Similar results were observed when the diamines TMEDA, TMPDA, and TEEDA were used at elevated temperatures. The byproducts are listed in FIG. 2.

The catalytic performance of different tertiary amines depends on the nature of the catalysts. The individual DMT and EG yields along with the total yield (DMT+EG) were ranked, as shown in Table 1. The individual/total yields of DMT and EG were acquired experimentally, which exhibits the influence of the basicity on the catalytic performance. The efficiency of a tertiary-amine catalyst in depolymerizing PET seems to be related to its acidity: the stronger acidity the catalyst, the higher yield of the DMT and EG products. For several unstable tertiary amines such as DBU, their pKa values show less correlation extent to the individual yield of DMT or EG. Among all the tertiary amines investigated in this example, NMP exhibited the lowest pKa, as well as the highest PET depolymerization efficiency. This result indicates that weak bases in methanol solvent may enhance the selectivity to monomers.

TABLE 1
Yields of the monomer from the depolymerization
of PET bottle, and the yields ranks.

| | Yields (%) | | | Yields Ranks (%) | | |
|---|---|---|---|---|---|---|
| Catalyst^{a} | DMT | EG | DMT + EG | DMT | EG | DMT + EG |
| DBU | 3.1 | 83.3 | 86.4 | 8 | =2 | 3 |
| DMA | 6.4 | 6.8 | 13.2 | 7 | 8 | 8 |
| NMP | 100 | 100 | 200 | 1 | 1 | 1 |
| TEA | 91.2 | 74.5 | 165.7 | 2 | 3 | =2 |
| TEEDA | 80.1 | 85.1 | 165.2 | 3 | =2 | =2 |
| TMA | 25.8 | 14.3 | 40.1 | 6 | 7 | 7 |
| TMEDA | 32.1 | 22 | 54.1 | =5 | 6 | 6 |
| TMPDA | 32.7 | 25.6 | 58.3 | =5 | 5 | 5 |
| TPA | 35.8 | 36 | 71.8 | 4 | 4 | 4 |

^{a}Tripropylamine (TPA), Triethylamine (TEA), N,N-dimethylaniline (DMA), 4,N,N-trimethylaniline (TMA), N-methylpiperidine (NMP), 1,8-Diazabicyclo[5.4.0]undec-7-ene (DBU), N,N,N′,N′-Tetramethylethylenediamine (TMEDA), N,N,N′,N′-Tetramethyl-1,3-propanediamine (TMPDA), N,N,N′,N′-Tetraethylethylenediamine (TEEDA).

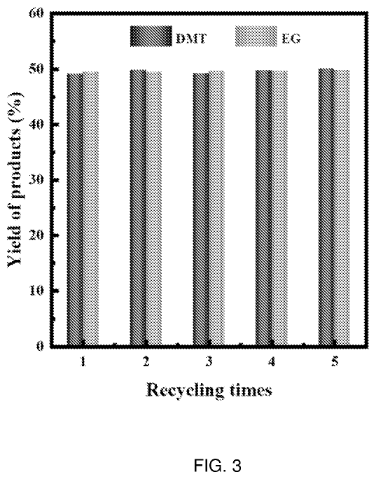

FIG. 3 presents that the catalytic stability of NMP was excellent because both DMT and EG yields were maintained at ˜50% during five consecutive runs (each run was for a half-hour at 160° C.). In contrast, a poor yield of DMT was obtained in the presence of DBU at the same temperature, and it was found that DBU was thermally unstable. Similarly, with triazabicyclodecene (TBD), which has a similar structure to DBU, as the catalyst for PET depolymerization, Jehanno et al. found that TBD started to decompose at 150° C. In this example, it has been corroborated that cyclic tertiary amines containing only single bonds such as NMP are more thermally stable than those with unsaturated double bonds. The equivalent yields of DMT and EG suggested that NMP could maintain superior catalytic stability over an extended time.

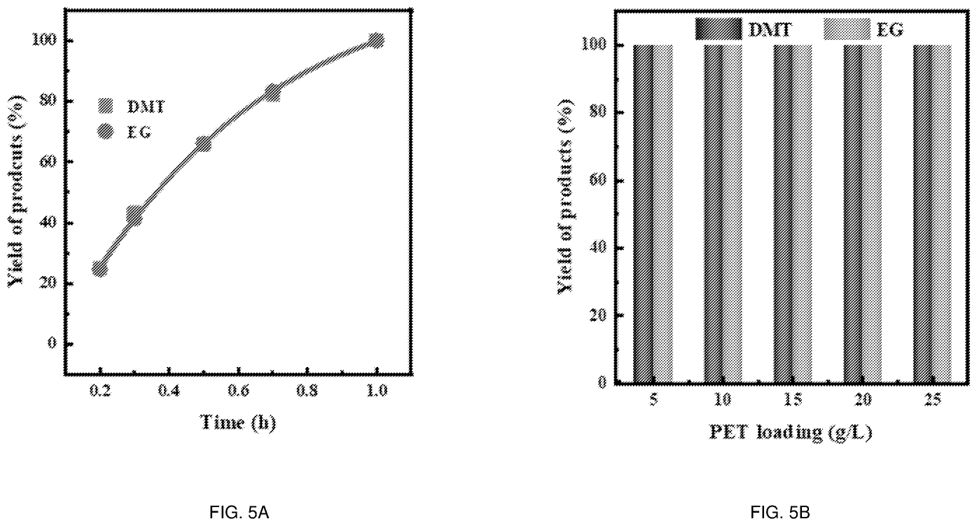

Selective deconstruction of polyesters. Elevated reaction temperature facilitated the formation of DMT and EG, as shown in FIG. 4A. As the reaction temperature increased from 120° C. to 160° C.), EG and DMT's yields increased from 0.73% and 0.77% to ˜ 100%, respectively. However, in the absence of the catalyst, a higher reaction temperature was required to reach a similar catalytic performance. For the complete catalyst-free methanolytic depolymerization of post-consumer PET, the reaction temperature was elevated up to 200° C., indicating that the presence of the NMP reduced the reaction temperature remarkably. By contrast, when conventional catalysts, such as aluminum triisopropoxide (AIP), zinc acetate, manganese acetate, lead acetate, sodium hydroxide, and [Bmim][BF₄] are used, higher reaction temperatures are also required. On the other hand, low product yields and the toxicity of conventional catalysts are major issues in the development of efficient processes. Elevating reaction time also accelerated the depolymerization of PET in methanol, as shown in FIG. 5A. When the reaction duration was elevated from 0.1 h to 1 h, the yields of DMT and EG increased from 43.3 to 100% and from 41.4 to 100%, respectively. In contrast, a much longer reaction time is required in the presence of the above-mentioned conventional catalysts. Thus, NMP accelerated the rate of depolymerization of PET than conventional catalysts. Apart from the temperature and time influence, PET loading was increased almost fivefold, and both yields of DMT and EG were maintained at 100%, indicating that NMP has a high tolerance to high PET loading, as shown in FIG. 5B. Glycolysis and methanolysis are mainly employed for PET recycling on a commercial scale. Though some catalysts, such as [Bmin][OH], [Bmim][ZnCl₃], [Bmim]Cl, metal salts, TBD, and N-heterocyclic carbenes demonstrated excellent catalytic activities in glycolysis of PET, higher reaction temperature and longer time are needed compared to NMP.

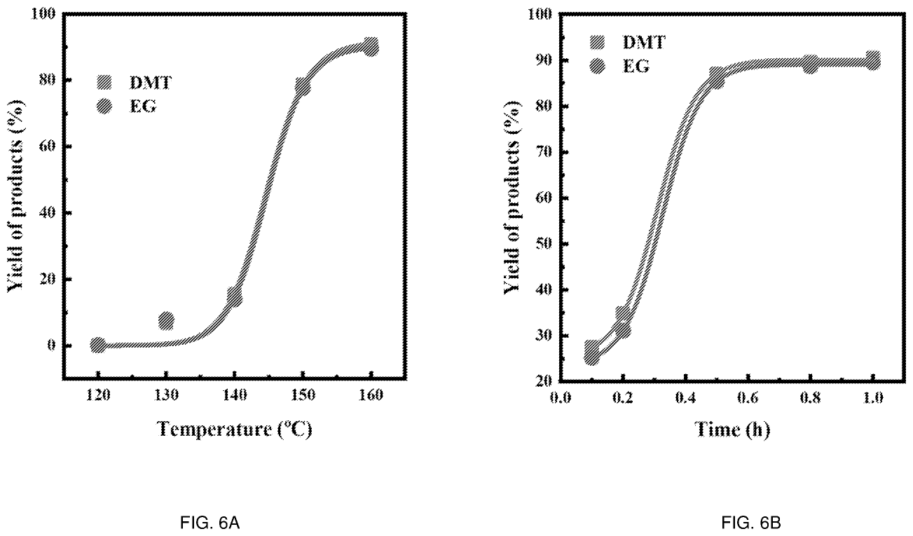

Recycling post-consumer textile in an eco-friendly way is another challenge in the textile industry. In this example, the incorporation of NMP resulted in the high yields of EG (89.5%) and DMT (90.8%) at 160° C., as shown in FIG. 6A. However, in a catalyst-free system, an elevated reaction temperature was also needed to target a similar catalytic performance. The presence of NMP reduced the reaction temperature remarkably. Elevating reaction temperature resulted in the efficient depolymerization rate of post-consumer PET textile in the presence of methanol. Extending reaction time also facilitated the formation of PET monomers (FIG. 6B).

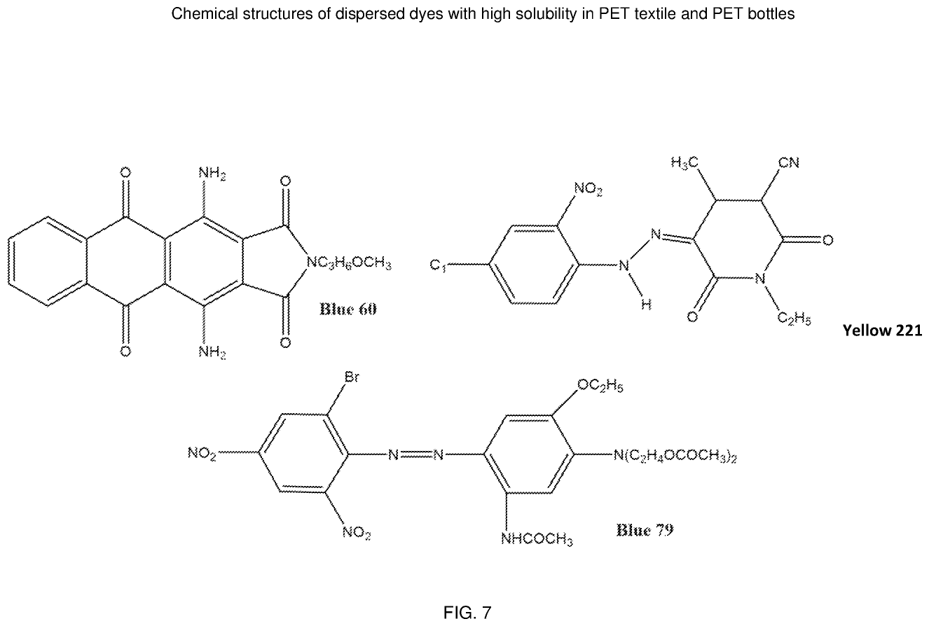

Waste plastics that contain colored dyes may undergo undesirable side reactions during the recycling process. Most of the organic pigments have—NHR, —NR₂, —NHCOR, —COR, —OR groups, and their chemical structures are shown in FIG. 7.

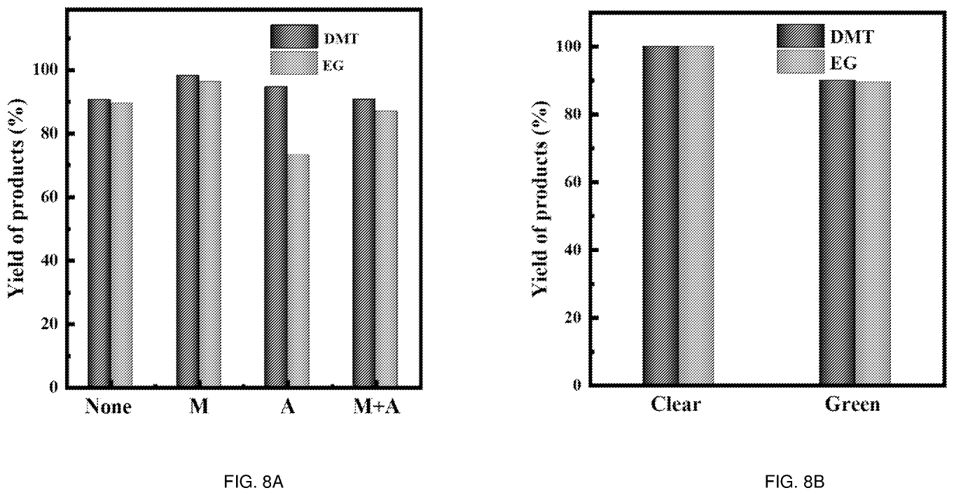

The amine groups in the dispersed dyes behave as a Lewis base, which can “compete” with NMP in the methanolysis of PET thus resulted in byproducts. Therefore, the dyes in PET textile can reduce the yields of DMT and EG due to their reactive nature, as shown in FIG. 8A. Despite the presence of NMP, color changes in the post-reaction solution were observed. Dispersed dyes are insoluble in water but are soluble in methanol. After methanol pretreatment, the yields of DMT and EG improved i.e., 97.2% and 96.2%, respectively. On the other hand, the changes in DMT and EG yields after acetone or the mixture of acetone and methanol pretreatment were shallower than methanol pretreatment. Acetone pretreatment resulted in the yields of EG (73.2%) and DMT (94.6%). Methanol and acetone mixture pretreatment resulted in the yields of EG (86.9%) and DMT (90.7%). The aforementioned treatments indicated that acetone is not a suitable treatment option.

In the depolymerization process, the impact of the color dyes in the PET bottle on the DMT and EG yields are illustrated in FIG. 8B. Herein, the yields of DMT and EG from packaging green PET bottles were lower than that from clear PET bottles, indicating that some dyes are reactive during PET depolymerization. Hence, pretreatment is necessary for waste PET polyester with colors because the amine groups in dyes can catalyze methanolysis of PET and potentially results in byproducts.

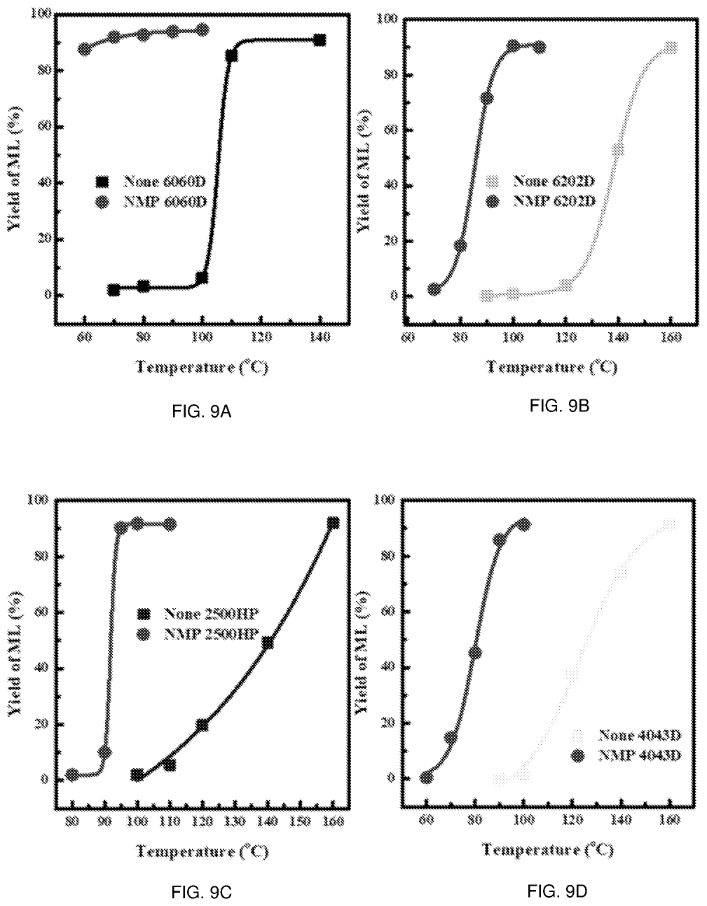

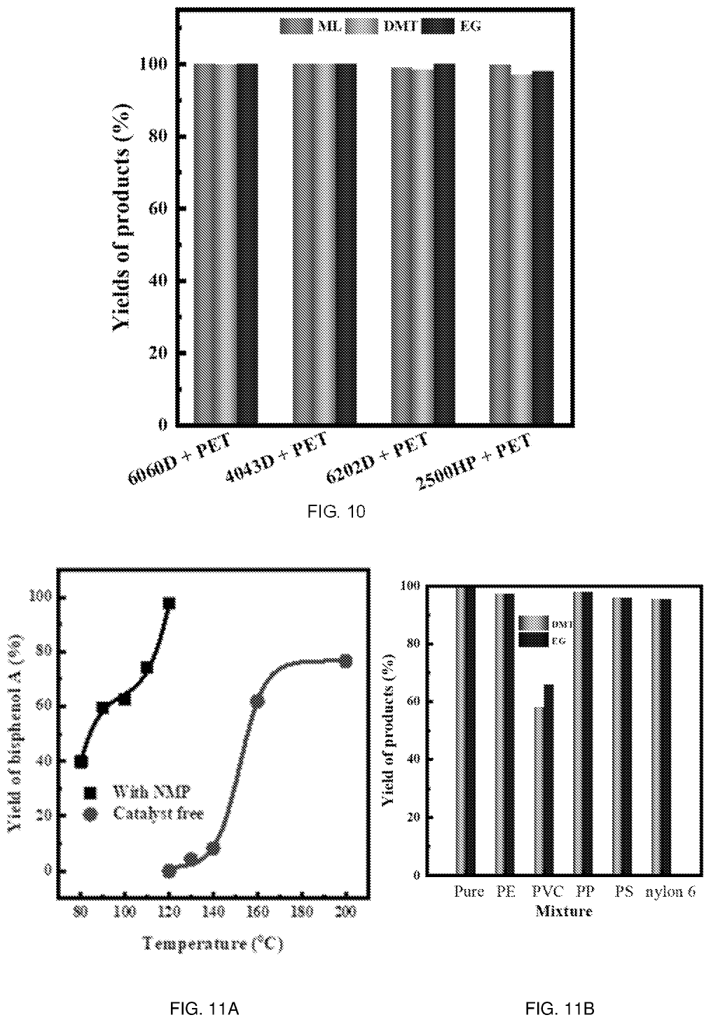

Recycling PLA is a sustainable option than biodegradation. Herein, the PLA 4043D, 6060D, 6202D, and 2500HP were individually employed into NMP-catalyzed depolymerization in methanol. FIG. 4B demonstrates that increasing reaction temperature enhanced the depolymerization rate of PLA pellets with high methyl lactate (ML) yields. In a catalyst-free system, complete depolymerization of PLA pellets is achieved at elevated temperature i.e., >160° C., as shown in FIGS. 9A-9D, indicating that NMP significantly reduced the reaction temperature. In a catalyst-free system, complete depolymerization of the PC bottle is achieved at above 200° C., as shown in FIG. 10. In this example FIG. 4C, when NMP was used as the catalyst, ˜100% yield of BPA (bisphenol A), one of the monomers of PC, was obtained at 120° C. which is much lower than 200° C. Polybutylene terephthalate (PBT) and PET are analogous in molecular structure and functional groups. However, PBT is more resilient to alkali treatment than PET. In this example, complete depolymerization of PBT was achieved in the presence of NMP at 160° C., and 100% of dimethyl terephthalate (DMT) and 95% of 1,4-butanediol (1,4-BD) were also obtained, as shown in FIG. 4D.

The selective recycling of waste plastics containing different components was proved to be challenging in the waste plastic recycling and upcycling sectors and needs to be developed in the future. For example, the poly(lactic acid) (PLA) bottles can contaminate the polyethylene terephthalate (PET) waste stream, resulting in poorer recovery and increased cost by necessitating investment in new sorting equipment. However, the separation of PET and PLA is not efficient because of their similar densities, which made the National Association for PET Container Resources (NAPCOR) in the USA refuse to introduce waste PLA in their current schemes for recycling PET. Though zinc acetate was successfully employed to yield waste lactate esters from PLA, while under the same reaction conditions, PET remains as an unconverted solid which can undergo further chemical recycling. There are temperature differences between the PLA and PET deconstruction; thus, the sequential process was created for the selective methanolysis of each polyester from the PLA and PET mixture stream with ca. 100% ML, DMT, and EG yields (FIG. 11A).

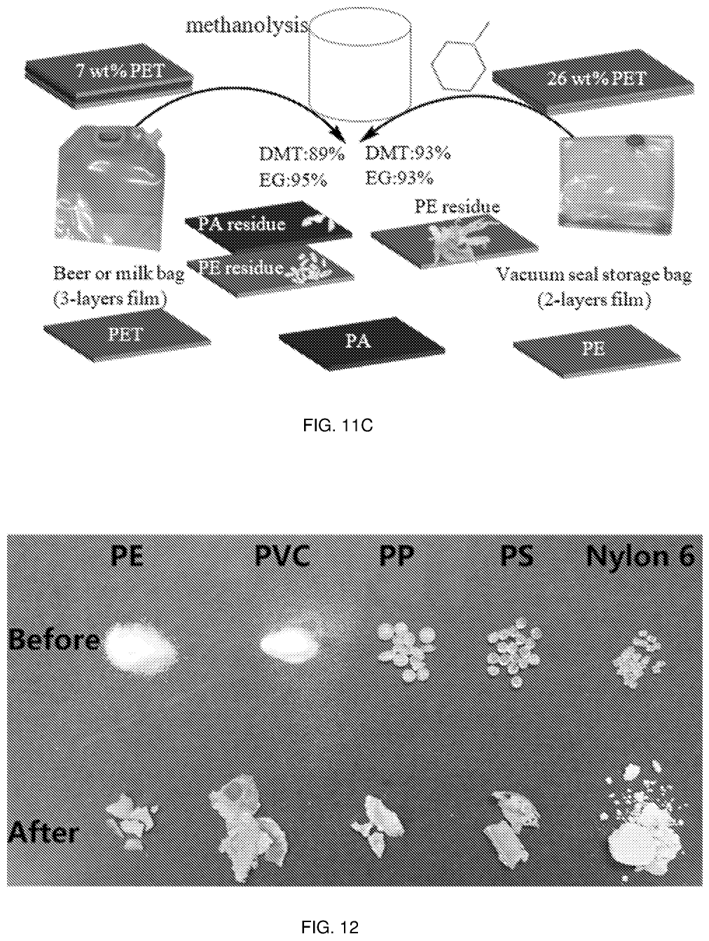

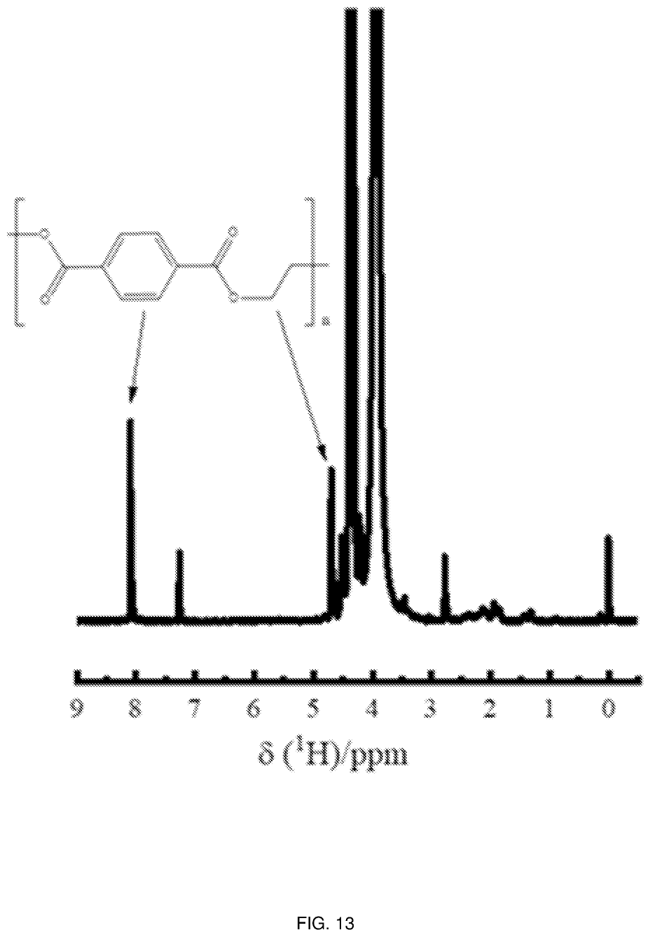

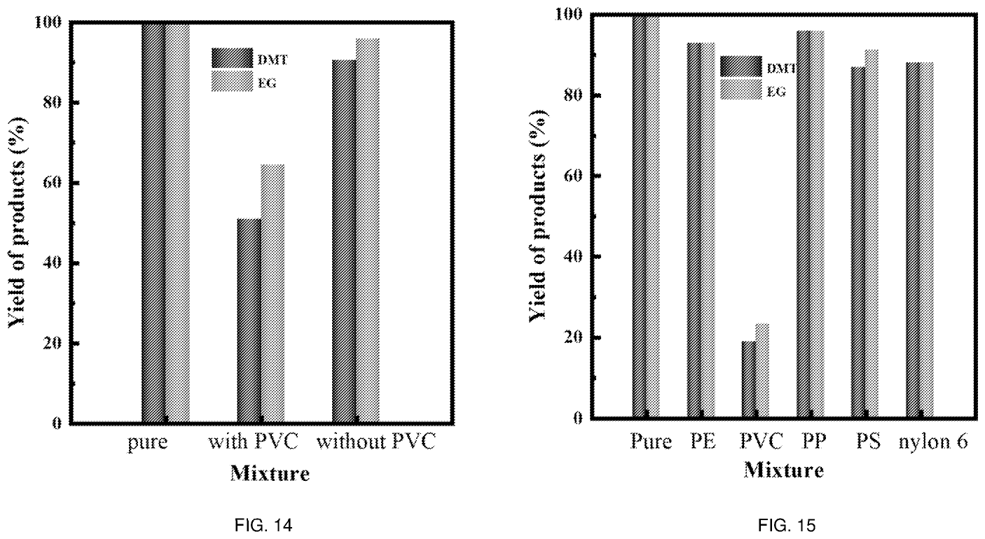

In the presence of equivalent other plastics (except PVC), the yields of DMT and EG only declined slightly (FIG. 11B), suggesting that the melting of polyolefins (PE, PP, PS) or the swelling of polyamides (Nylon 6) can reduce the degradation rate of PET (FIG. 12). PVC showed a significant negative effect on the PET deconstruction because of the dechlorination of PVC under basic conditions, generating the yellow polymer that covered the surface of PET, as demonstrated by the residual PET (FIG. 13). If the five times other plastics were added, the yields of DMT and EG declined more obviously (FIG. 14), especially in the case of PVC. The PVC was also demonstrated to be the dominantly limiting productivity of DMT and EG and threatening the selective deconstruction of polyesters (FIG. 15). PVC contaminants can destruct PET recycling due to the evolution of hydrochloric acid from PVC after heating. Therefore, it is necessary to kick the special plastics, e.g. PVC, before the depolymerization of polyesters.

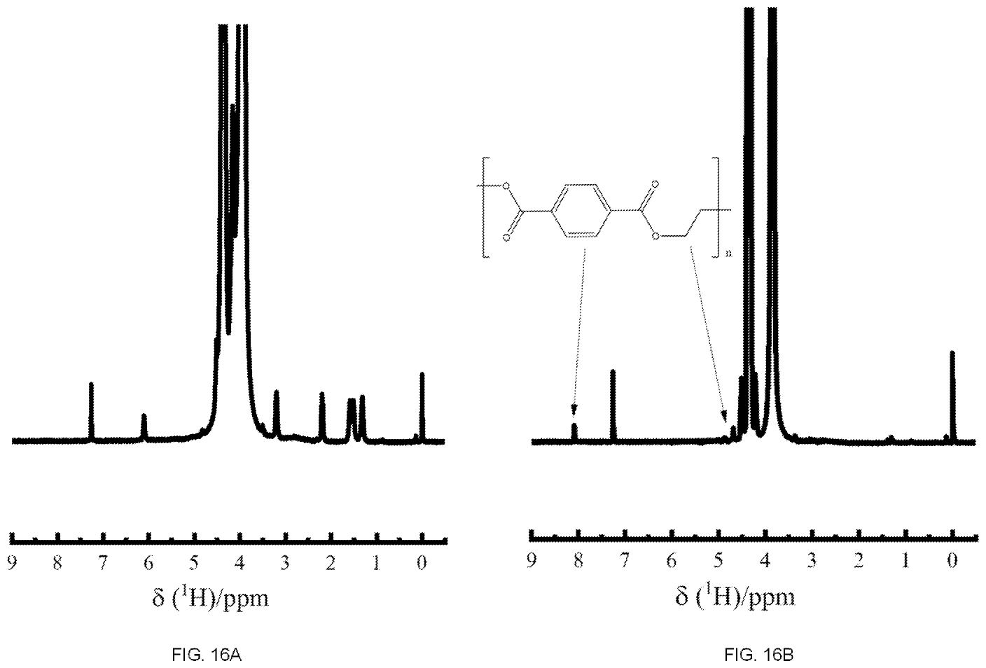

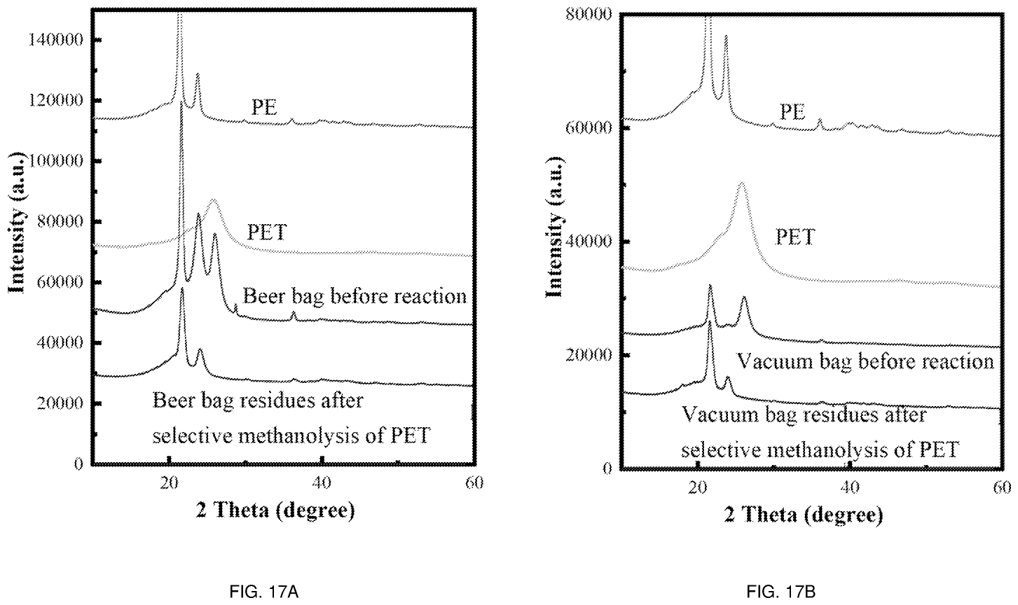

It is hard to recycle/reuse multilayer packaging material effectively because multilayered plastics have several thin sheets of materials (including aluminum, plastics, and paper) that are laminated together and are difficult to separate. Over 45% of plastic waste generated in 2015 was from packaging materials which consist of multilayered materials. Some important limitations of polyethylene films are poor gas barrier properties, low-temperature resistance, and difficulty to bond. Thus, PET was used to improve these properties. To demonstrate the selective deconstruction of PET from multilayer films, PET/PA/PE (beer or milk bag) or PET/PE (vacuum seal storage bag) multilayer packaging materials were used as the feedstock in the NMP catalyzed methanolysis. As can be seen in FIG. 11C, the selective deconstruction of PET in beer/milk bag and vacuum seal storage bag yielded 89% and 95% EG and 93% DMT and 93% EG, respectively, because of the above-mentioned effect of PA and PE. The solid residues isolated from the methanolysis of beer or milk bag were essentially close to pure PE or PA components, as demonstrated by ¹H NMR spectra (FIG. 16A), PET content is too low to be detected) and XRD patterns of the solid residues (FIGS. 17A, 17B). Interestingly, the PA residue and PE residue were separated because of the swelling of PA and the melting of PE, respectively. However, the PET residue from the vacuum seal storage bag with higher PET content (26 wt %) was still observed as the PET signal in ¹H NMR spectra appeared in FIG. 16B.

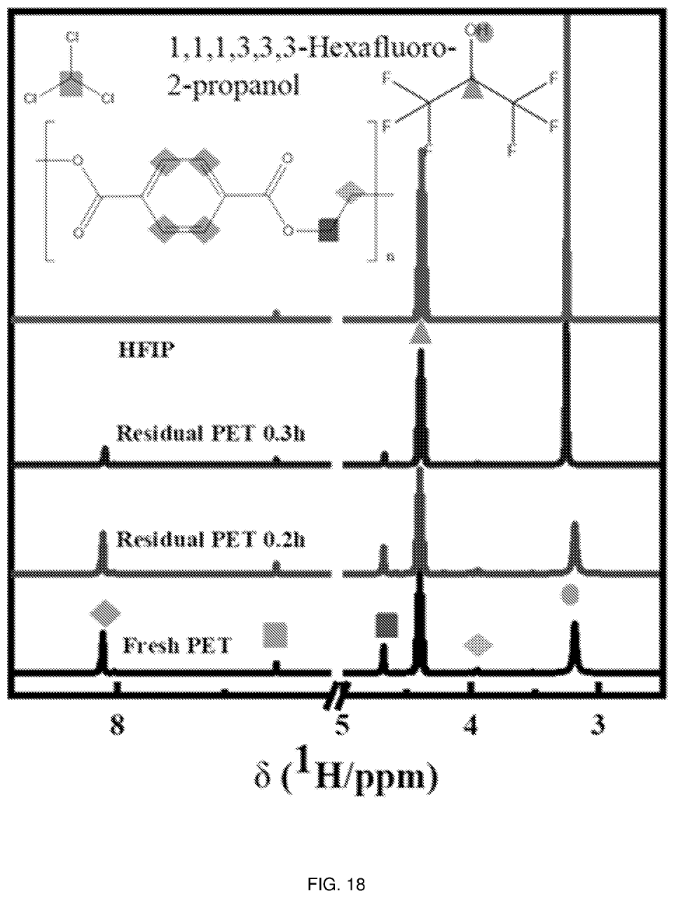

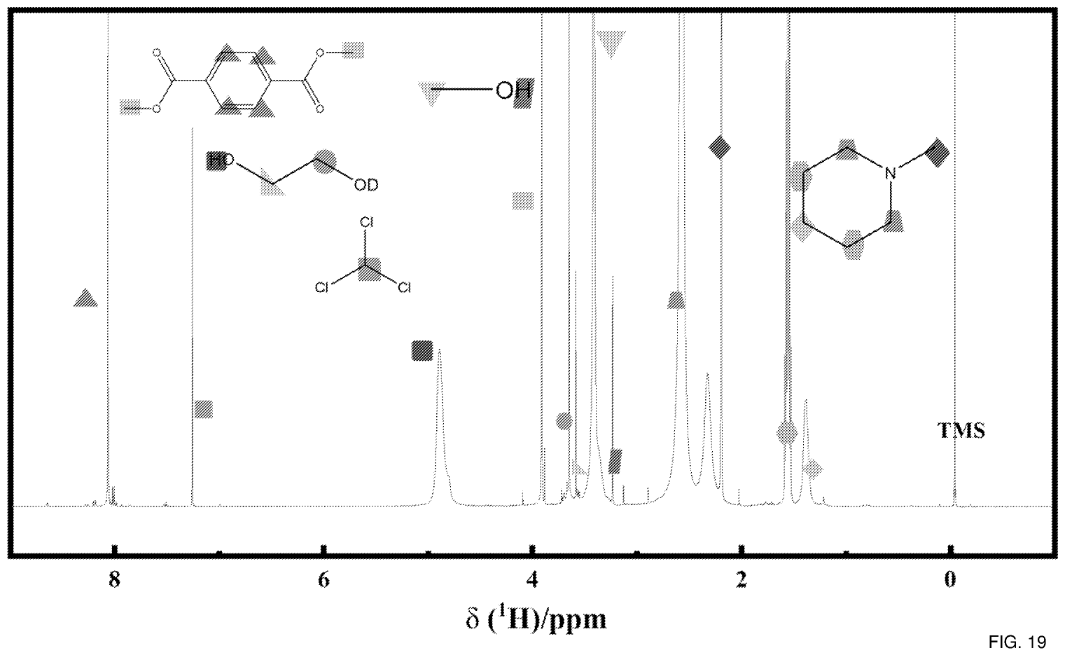

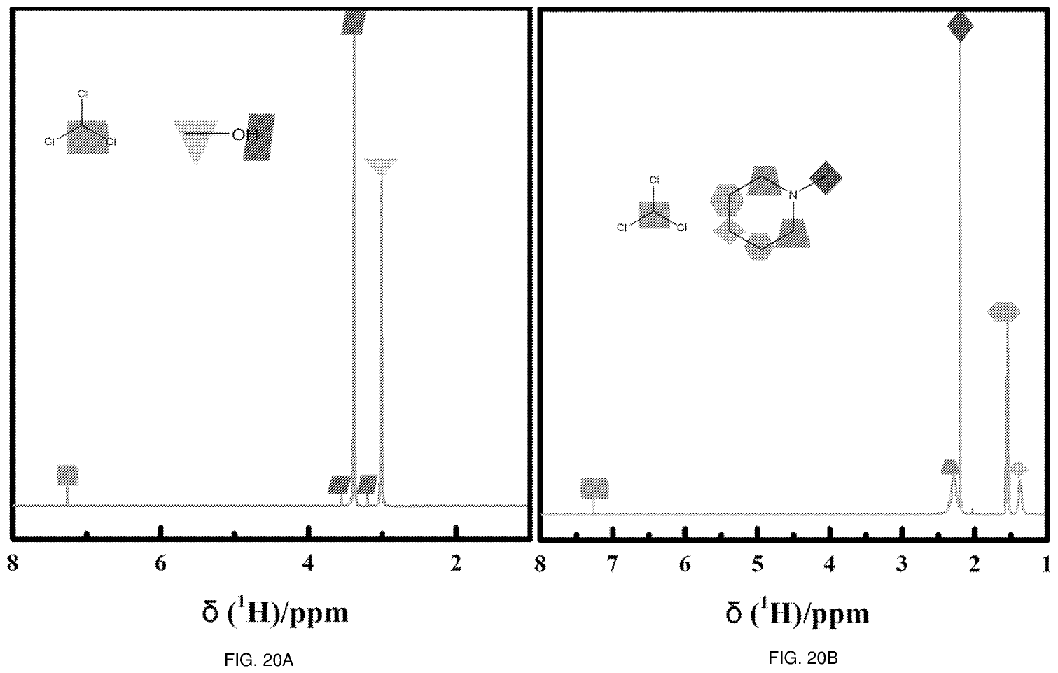

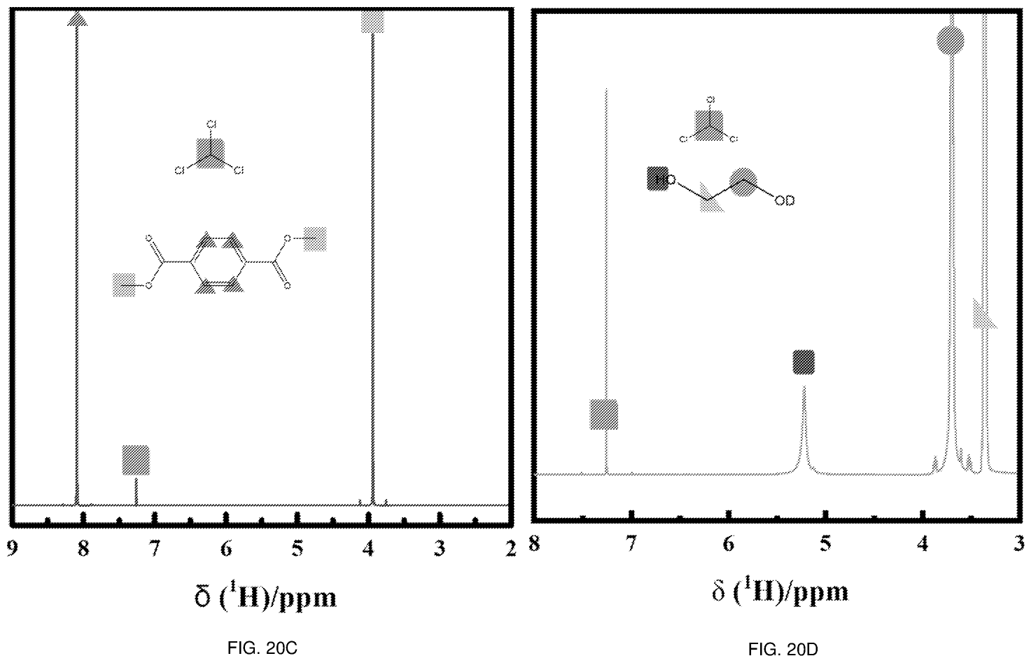

The ex-situ NMR characterization was also conducted to probe the PET depolymerization mechanism. The ¹H NMR spectra of the fresh and residual PET samples are almost identical, indicating no oligomers or byproducts were formed and deposited on the residual PET samples, as shown in FIG. 18. The ¹H NMR spectra of the products after partial depolymerization of PET demonstrated that DMT and EG are the only liquid-phase products after a reaction for 0.2 h, as shown in FIG. 19. Likewise, no oligomer signals were observed in the liquid-phase product samples. This result is confirmed by comparing the ¹H NMR spectra of the pure DMT and EG (FIGS. 20A-20D). Hence, it can be considered that PET undergoes chain-end scission during the NMP-catalyzed methanolysis rather than random scission in supercritical methanol.

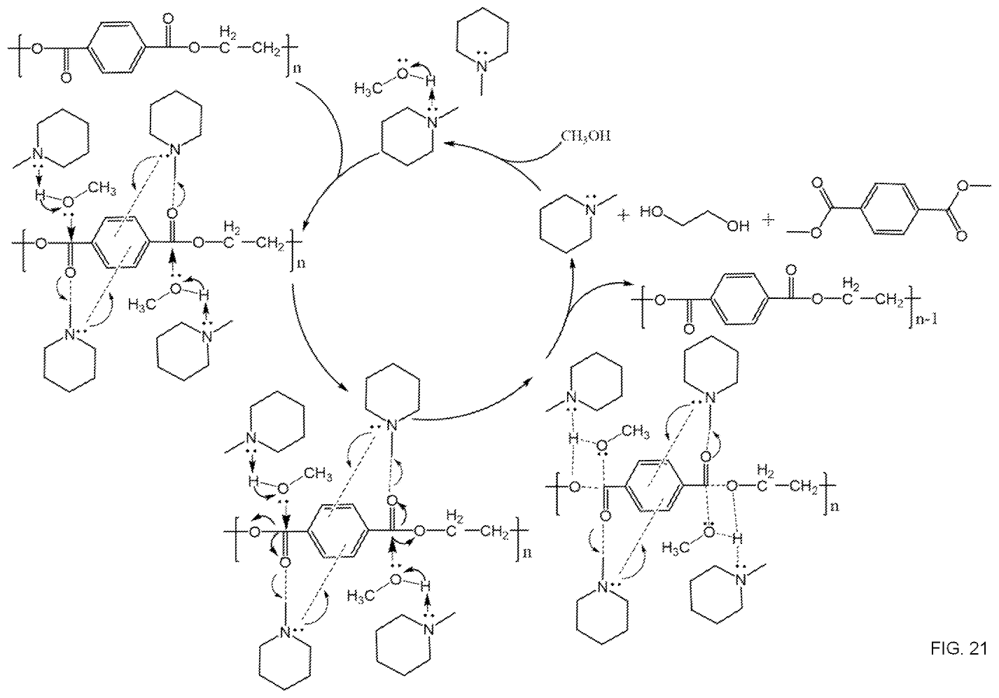

Proposed reaction pathway for depolymerization of PET. NMP is expected to act as a Lewis base in methanol solvent. The proposed reaction pathway for NMP-catalyzed methanolytic depolymerization of post-consumer PET is depicted in FIG. 21. The mixture of methanol and NMP is proved to be homogeneous, which caused aggregation through O—H . . . N bond. NMP dissolves in methanol, and the free electrons in NMP make it behave as a Lewis base. The NMP readily extracts a proton from methanol, resulting in the formation of the methanol/NMP complexes, which is important for increasing the nucleophilicity of methanol oxygen. On the other hand, two kinds of hydrogen bonds, i.e., with one between N of NMP and H of the benzene ring of PET and the second one between the carbonyl oxygen of PET and methyl H of NMP are responsible for the ester bonds activation. The activated oxygen in the methanol attacks the activated carbonyl group in a PET polymer unit, resulting in electron transfer of the ester bonds. The electron rearrangement causes the formation of the hydrogen bonding with the backbone oxygen of PET, and the methoxide transfer, generating a tetrahedral intermediate. The formation of the new alcohol and the restoration of the amine catalyst resulted in the formation of the monomers, DMT and EG, and the corresponding chain-cut PET. During the “dehydrogenation” of NMP complexes, the free electrons in NMP are released and can abstract another methanol molecule, starting another catalytic cycle. The chain-cut PET is further catalyzed by the same mechanism to generate the final products, DMT and EG. Catalyzed by the transesterification reaction, PET repeat units are isolated from PET polymer via only chain-end scission. As a result, the final degradation products DMT and EG were obtained. This mechanism is different from the traditional random scission mechanism in the methanolysis of PET under supercritical conditions.

Conclusion. In this example, four types of tertiary organic amine were investigated in the methanolytic depolymerization of post-consumer PET material. The catalytic performance of NMP was superior compared to other tertiary amines: NMP-catalyzed reaction achieved the highest yields of DMT (100%) and EG (100%) in an hour at the mild temperature, i.e., 160° C. Furthermore, NMP exhibited stable catalytic capacity over an extended time in the PET methanolysis. Removal of colorants in the post-consumer PET is necessary for mitigating their reaction with PET repeat units. Selective depolymerization of the post-consumer PET textile, the post-consumer PC bottle, the PBT pellets, and the PLA pellets (4043D, 6060D, 6202D, 2500HP), the PET/PLA mixture, the PET and other plastic mixture, and the PET in multilayer packaging materials were demonstrated using the NMP-catalyzed methanolysis.

AIMD based pKa calculations revealed that the efficiency of a tertiary amine catalyst in depolymerizing PET follows its acidity, where catalysts that are more acidic yield more DMT and EG products. In situ ¹H and ¹³C MAS NMR combined with DFT-NMR chemical shift computational modeling are utilized for an in-depth understanding of the reaction mechanism. It is proposed that NMP forms a hydrogen bond with methanol and DMT/PET carbonyl oxygen as well, which can promote nucleophilicity of methanol oxygen and activate carbonyl carbon of PET respectively. After carbonyl carbon is activated, the oxygen of methanol with promoted nucleophilicity by hydrogen bonding with NMP can readily attack carbonyl carbon of PET to break an ester bond. A possible reaction pathway of NMP-catalyzed methanolytic depolymerization of post-consumer PET is proposed. These findings demonstrated an in-depth understanding of NMP-catalyzed degradation of polyesters to their monomers or upgraded chemicals in the methanol solvent.

### Example 1B. Selective Deconstruction of Post-Consumer Polyester Plastics

Recycling post-consumer textile in an environmentally friendly way is another challenge in the textile industry. 5.8 million tons of textiles were discarded, but 4.3 million tons of waste textiles were buried in the landfill or incinerated in the United States. PET is the most consumed polymer in the textile industry, and textile products account for 42±3% of the consumption of PET. In particular, PET textile has captured the market of textile fiber next only to cotton. Since most fabrics are a blend of various fiber types and separation of each type is impossible, recycling post-consumer textile while maintaining the quality of fibers is challenging. The lack of a market, technology, equipment, and consumer awareness is another challenge for recycling waste textiles. Mechanical recycling of PET textile reduces molecular weight or intrinsic viscosity of recycled PET textile. Although alkaline (such as NaOH, KOH), concentrated acid, sodium sulfate can catalyze PET textile depolymerization, separating the catalysts from products is costly, and the quality of recovered PET often deteriorates.

Color dyes in waste plastic are coloring contaminants leading to undesirable side reactions during the recycling process. In particular, disperse dyes, which are composed of anthraquinone or azo, are commonly used for dying PET plastic products. PET has higher sorption of dispersed dye than other polyesters, such as PLA, indicating disperse dyes have a high affinity to PET textile fiber. The detailed information regarding commercial dispersed dyes in PET can be found in this document. The chemical recycling process (glycolysis of PET) cannot produce clear virgin PET when colorants or dyes are not removed. The dyes in waste textile also posed a severe environmental impact on aqueous effluent. Removing color dyes in the PET recycling process is essential, but the technology is limited.

PLA is biodegradable as it can be mineralized into water and carbon dioxide once buried in the soil. However, the micro-organisms in the environment can only degrade the PLA with a molecular weight below 10,000 Da, and they are not widely distributed in the natural environment. Therefore, recycling PLA is a better option than biodegradation of PLA in terms of sustainability. Though the catalysts, such as Zn (OAc)₂, Cu(OAc)₂, [Bmim][OAc], [Bmim][OAc]—Zn(OAc)₂, 3[Bmim][OAc]—Zn(OAc)₂, 2[Bmim][OAc]—Zn(OAc)₂, 2[Bmim][OAc]—Cu(OAc)₂, [HSO₃-mim]HSO₄, FeCl₃, or [Bmim] FeCl₄ have shown their catalytic activities in the methanolysis of PLA, higher reaction temperature or longer reaction time were needed when compared to NMP.

Polycarbonate (PC) is abundantly found in waste electrical and electronic equipment (WEEE). However, the contaminants, such as toxic additives, brominated flame retardants, or polyvinyl chloride, render WEEE unsuitable for recycling. Although various studies focus on depolymerizing PC, the disadvantage of these methods are high reaction temperatures and using toxic catalysts. In the catalyst-free system, complete depolymerization of the PC bottle is achieved at above 200° C., as shown in FIGS. 9A-9D. A case in point is the alkali-catalyzed methanolysis of PC. In this example (FIG. 11B), when NMP was used as the catalyst, ˜100% yield of BPA(bisphenol A), one of the monomers of PC, was obtained at 120° C. which is much lower than 200° C. When [Bmim][CI] and [Bmim][Ac] are used, lower reaction temperatures are needed when compared to NMP. Ionic liquid not only serves as the catalyst, but it also can be used as a solvent. However, the problematic separation of the ionic liquid made them inferior to NMP.

In supercritical methanol, random scission is predominant at the initial stage of PET depolymerization. Then specific scission proceeds predominantly in the homogeneous phase as the PET polymer is cleaved into soluble oligomers. Therefore, PET monomers may not be produced until near the end of depolymerization in supercritical methanol. With random scission, possibilities of forming byproducts cannot be ruled out for the methanolysis of PET. However, in this example, NMP-catalyzed PET depolymerization may behave differently since the reaction temperature is much lower than that of supercritical methanol.

### Example 2. Closed-Loop Recycling of Nylon 6 Enabled by Amine Induced Hydrolysis

Summary Due to the non-biodegradation of polyamide 6 (Nylon 6), waste Nylon 6 can even remain the robustness for centuries in the natural environment. To alleviate the serious environmental issues posed by waste Nylon 6, recycling Nylon 6 is considered sustainable. However, since C—N bond cleavage in the amide functional group is more stubborn than the C—O bond cleavage in the ester group, recycling Nylon 6 usually requires a high reaction temperature. In order to reduce the reaction temperature of hydrolysis of Nylon 6, efficient catalysts are necessary to investigate. Herein, hydrolysis of Nylon 6 into ε-caprolactam was catalyzed by triethylamine (TEA) in water media. The effects of reaction conditions, including temperature, time, Nylon 6 loading, and volume of TEA on yields of ε-caprolactam were examined. The reusability of TEA in the hydrolysis of Nylon 6 is subsequently investigated. The yields of ε-caprolactam remained relatively stable during five recycling times maintained at 13%. The ¹H-NMR results demonstrated that the random scission was the depolymerization mechanism of Nylon 6 in water. A possible reaction pathway of TEA-catalyzed hydrolytic depolymerization of Nylon 6 is proposed. These findings showed a fully understanding of TEA-catalyzed degradation of Nylon 6 to ε-caprolactam in water.

Introduction. Global fiber consumption has been readily increasing due to the growth in the world population and overall improvement of living standards. In particular, the demand for fiber made of polyamide 6 and polyamide 66 increases 2.3% and 2.7%, respectively in 2020. The global production of polyamides has reached 7 Mt/y by 2015 and is expected to increase annually by 3% within 2020. Polyamides are polymers where the monomer units are linked by an amide group. Polyamide 6 (PA 6 or Nylon 6) is a high-strength engineering thermoplastic, extensively used to manufacture automobile parts, engineering parts, and textile fibers. Furthermore, polyamides (PAs) as the major component of fishing nets, are annually discarded 640000 tons and constituted approximately 10% of marine waste. PAs have excellent chemical resistance, which restrains degradation in the natural environment. In addition, disposed of PA waste will persist for at least decades or even centuries. Due to the relatively high price of its monomer, ε-caprolactam, recycling waste Nylon 6 is economically desirable and alleviates environmental issues.

There are two main methods, namely mechanical or chemical recycling processes for recycling waste PAs. Mechanical recycling preserves the molecular structure because the waste PA is crushed, washed, dried and then re-granulated. However, this process cannot make full use of the waste PAs. The performance of recycled PAs is relatively poor, and it can only be used in low-end occasions. After one or two cycles, the polymer chain cannot continue to be recovered by this method due to a large number of breaks in the polymer chain. On the other hand, the waste PA can be chemically reacted under certain conditions to generate oligomers, PA monomers, and their derivatives. Then, the monomers for preparing PA or other chemicals are obtained through separation, to achieve the recycling of PA. The advantages of chemical recycling over mechanical recycling include lower energy requirements, compatibilization of mixed plastic wastes to avoid the need for sorting, and expanding recycling technologies to traditionally non-recyclable polymers. Chemical recycling of PAs includes thermal degradation, hydrolysis, ammonolysis, enzymatic hydrolysis and supercritical (sub-supercritical) depolymerization. Owing to the fact that C—N bond cleavage in the amide functional group is more stubborn than the C—O bond cleavage in the ester group, depolymerization of polyamide requires much higher reaction temperature than depolymerization of polyesters. For example, the reaction temperature for ionic liquid-catalyzed depolymerization of Nylon 6 and polylactic acid (PLA) are 300° C. and 115° C., respectively. ε-Caprolactam, which is the essential segment of Nylon 6, can be recovered from the chemical recycling of Nylon 6, which includes ammonolysis (ammonia), hydrolysis (water or steam) and glycolysis (glycols).

In the case of ammonolysis of Nylon 6, the reaction conditions are rather intense. The reaction temperature and pressure range from 300 to 350° C. and from 500 to 2500 psi, respectively and at least one mole of ammonia per mole of the amide group in Nylon polymer is needed. Besides ammonolysis of Nylon 6, glycolysis of Nylon 6 in boiling ethylene glycol yields oligoamides with amino- and hydroxyl end-groups using zinc acetate, sodium glycolate, and poly(phosphoric acid). Glycolysis of Nylon 6 is conducted at a temperature range of 200 to 300° C. and resulted in low selectivity of the products. In the absence of a catalyst, hydrolysis of Nylon 6 is carried out at a temperature range from 573 K to 673 K under 35 MPa, and Nylon 6 melts at 488 K then produces e-ε-caprolactam. High-temperature and high-pressure catalyst-free hydrolysis reaction conditions need high requirements for equipment materials, whereas acid or base catalytic hydrolysis can avoid this problem. To overcome the drawbacks of HCl volatilization and serious corrosion on equipment, solid super acid SO₄²⁻/ZrO₂—TiO₂—La was used as a catalyst to investigate the hydrolysis reaction of Nylon 6, and the yield of ε-caprolactam reached 75.1% at 190° C., within 130 min. Recovering ε-caprolactam by alkaline hydrolysis is not as popular as acid hydrolysis. The commonly used bases are alkali/alkaline earth oxides, hydroxides, carbonate, etc. Even though a high yield of ε-caprolactam can be obtained in the mineral base/acid-induced hydrolysis, it is hard to recover pure monomers from aqueous solutions due to the presence of the catalysts. On the other hand, CaCO₃ from the backing of the waste carpet may cause the deactivation of the catalyst.

The mineral base/acid-catalyzed hydrolysis can give a high monomer yield, but several purification steps are required. Therefore the aim of this paper was to highly efficient recycle both ε-caprolactam and catalyst with minimal separation after hydrolysis. Amines are also bases because the nitrogen atoms in the amine molecule have unshared electron pairs that accept protons and make the amine basic. If volatile amines are used for the hydrolysis of PAs, the purification steps can be simplified. However, the presence of active hydrogen atom in primary amines and secondary can also induce the nucleophilic attack on PA, which can generate different amides. Only the tertiary amines in which all of the hydrogens in an ammonia molecule have been replaced by hydrocarbon groups can improve the selectivity of PA monomers because of their non-reactive property. Thus different volatile tertiary amines-catalyzed hydrolytic depolymerization of Nylon 6 to produce its monomer ε-caprolactam was investigated in this example. Complete conversion of Nylon 6 into the ε-caprolactam facilitates isolation and purification because the volatile amine and the solvent water can be separated by distillation simultaneously. The reaction conditions were optimized, and the activation energy (Ea) of trimethylamine (TEA)-catalyzed hydrolysis of Nylon 6 was determined. Nuclear magnetic resonance (NMR) was employed to investigate the cleavage of the amide bonds during hydrolysis. Furthermore, a reaction pathway of TEA-catalyzed hydrolytic depolymerization of polyamide 6 was proposed.

Materials and Methods.

Materials. All chemicals were used as received. The Nylon 6 pellets were purchased from Sigma-Aldrich. Triethylamine (TEA, Alfa Aesar, 99%), tripropylamine (TPA, Sigma-Aldrich,98%), N-methylpiperidine (NMP, Sigma-Aldrich, 99%), 1,8-Diazabicyclo[5.4.0]undec-7-ene (DBU, Sigma-Aldrich, 98%), N,N,N′,N′-Tetraethylethylenediamine (TEEDA, 98%), N,N-dimethylaniline (DMA, Sigma-Aldrich, 99%), and N,N-diethylaniline (DEA, Sigma-Aldrich, ≥99%) were used as the catalysts. Chloroform-d (Sigma Aldrich, 99.8 atom % D, contains 0.03% (v/v) TMS), and trifluoroacetic acid-d (Sigma-Aldrich, 99.5 atom % D) were used for the NMR measurement. ε-Caprolactam (Sigma-Aldrich, 99%) was used as the standard sample. DI water with a specific resistance of 18.2 MΩ cm was prepared through an ultrapure water system (ELGA PURELAB FLEX) and used as the solvent.

Catalytic reaction procedures. The reactions were carried out in a 45 mL Parr Series 5000 Multiple Reactor System with a 4871 series temperature controller. In general, the feedstock, the solvent (DI water), and a certain amount of amine were separately added to the vessels. The vessels were sealed, purged three times with 400 psi N₂. The vessels were not pressurized for any reactions at room temperature. The mixture was magnetically stirred at 700 rpm while being heated to the set reaction temperature in half hour and kept at the set temperature for the set reaction time. After the reaction, the vessels were immediately quenched for fast cooling. The reactors were cooled down to room temperature at the end of the reactions.

To examine the catalytic stability of TEA in the hydrolysis of Nylon 6, the following procedures were repeated five times. After disassembling the reactor, the reaction solution was collected in a centrifuge tube, which was then centrifuged by Centrifuge 5810 R 15 amp version (Eppendorf). Then 1 mL of the clear reaction solution was sampled then analyzed by a GCMS QP-2020 (Shimadzu) to quantify the products. After analysis, the clear reaction solution and additional 0.1 g Nylon 6 were added into the same 45 mL Parr Series 5000 Multiple Reactor for next run under the same reaction conditions, and the same steps were repeated for five times. A standard solution composed of 20 mL of DI water and 5 mL TEA was prepared for compensating potential reaction solution lost during operation.

Analysis. Since no gas products were generated, the reactor was dissembled after it was cooled down to room temperature. After dissembling the reactor, the reactor was rinsed with the solvent (DI water). The liquid phase was filtered through a 0.45-micron syringe filter before analysis. A Shimadzu GC(GC-2010) was used to identify and quantify the products. After the determination of the product contents, the yield of ε-caprolactam (E) was calculated by the following equation,

$$E = \frac{{n}_{1}}{{n}_{0}} \times 100 \%$$

where nₒ is the moles of repeating unit of Nylon 6 before reaction, n, is the moles of ε-caprolactam.

¹H-NMR measurement. One piece of fresh Nylon 6 pellet was dissolved in 1 mL of trifluoracetic acid-d. The residual Nylon 6 was separated from the liquid product after centrifugation by Eppendorf 5810 R Centrifuge. The residual Nylon 6 was dried in an oven at 50° C. overnight. The dried residual Nylon 6 was also dissolved in 1 mL of trifluoracetic acid-d. After the Nylon 6 was completely dissolved, the supernatant solution was transferred into the NMR tubes.

The aqueous solution from the reactor was freeze-dried by a Freezone Freeze Dryer from Labconco overnight to remove water. Then the residual was dissolved in 1 mL of chloroform-d and transferred into an NMR tube.

A fixed amount of TEA was dissolved in 1 mL of chloroform-d, and the solution was transferred into an NMR tube. One piece of ε-caprolactam was dissolved in 1 mL of chloroform-d, and the clear solution was also transferred into an NMR tube.

¹H-NMR measurement was conducted with a VARIAN 400 MHZ SPECTROMETER (One Probe, X-tunable and ¹H) over 256 scans, one-second relaxation delay, and 45 degrees of pulse angle. The fresh and residual Nylon 6, liquid product, the standard ε-caprolactam sample, and TEA were tested by ¹H-NMR.

Results and Discussion.

Catalyst screening. Hydrolytic depolymerization of Nylon 6 conducted under subcritical and supercritical water often resulted in a low yield of ε-caprolactam. In this example, amine-assisted hydrolysis was employed for the Nylon 6 deconstruction to obtain ε-caprolactam. Herein, the catalytic performance of four types of tertiary amines, including (1) linear amines: TEA and TPA, (2) aromatic amine: DEA, and DMA), (3) cyclic amines: NMP and DBU, and (4) diamines: TEEDA, on the depolymerization of Nylon 6 were assessed based on the corresponding yields of ε-caprolactam.

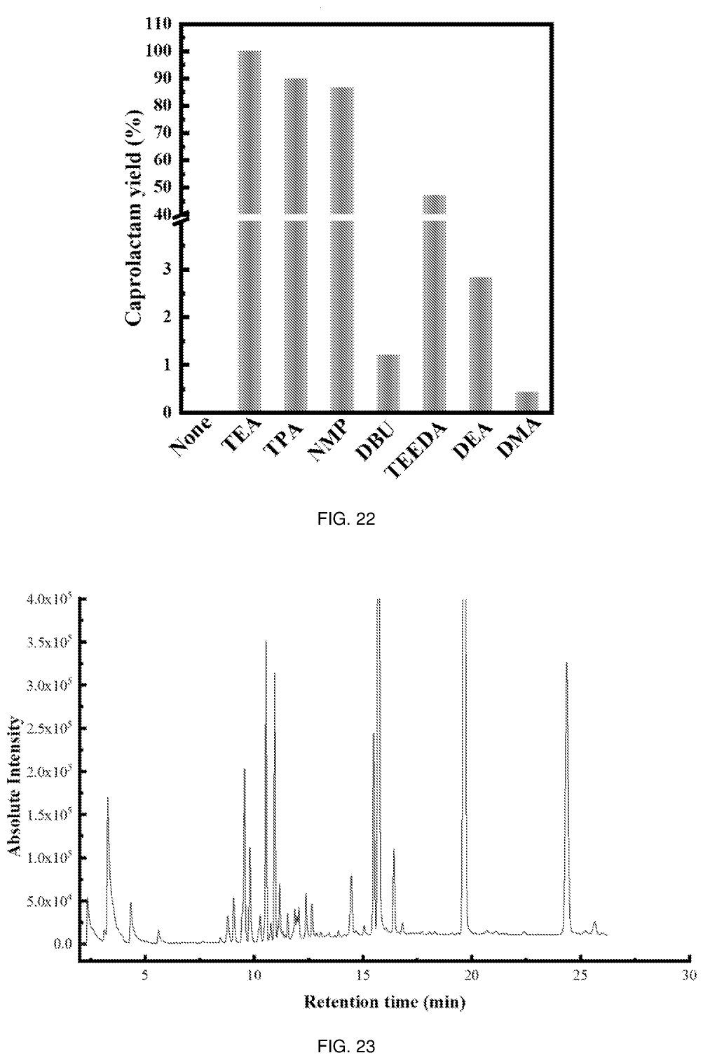

In the absence of an amine catalyst, hydrolysis of Nylon 6 hardly proceeded so that the yield of ε-caprolactam can be negligible at 250° C. for 6 h, as shown in FIG. 22. Triethylamine (TEA)-catalyzed hydrolysis of Nylon 6 yielded 100% ε-caprolactam, whereas the catalytic activities of the rest tertiary amines are inferior to TEA with respect to yield of ε-caprolactam. Increasing steric bulkiness associated with alkyl substituents of tertiary amines reduces their catalytic activities. Thus, ε-caprolactam yields generated by TPA or NMP induced hydrolysis were decreased gradually. DBU is considered a strong base. However, when the reaction temperature was above 140° C., DBU decompose automatically, as can be seen in FIG. 23. Thus poor ε-caprolactam yield was obtained. When diamine TEEDA was employed, only 47% ε-caprolactam was obtained. Aromatic amines are featured with low solubility in water so that hydroxyl ions by the hydrolysis of aromatic amines are poor, resulting in the poor hydrolysis of Nylon 6.

The catalytic activities of tertiary amines and their pH value and steric hindrance are highly connected due to the hydrolysis process. The pH values of each tertiary amine in aqueous media are summarized in Table 2. Comparing the pH values along with the catalytic performance of TEA (12.24), NMP (11.96), and TPA (10.99) reflects that hydrolysis of Nylon 6 is favored in more basic conditions. However, DBU with a higher pH value (13.12) than TEA is detrimental to the formation of ε-caprolactam because of the decomposition. Also, straight-chain tertiary amine is much stronger amine than the branched tertiary amine. Thus, TEA is superior to diamine TEEDA in the depolymerization of Nylon 6. Lower pH values of DEA and DMA are correlated with their solubility so that water-soluble amines are preferred in the hydrolysis of Nylon 6.

TABLE 2
pH values of four types of tertiary organic amines. The pH values of all types
of tertiary amines used in this example were measured and summarized in Table 2.

| Tertiary | | | Critical | Solubility in | |
|---|---|---|---|---|---|
| organic | pH | Boiling | point | water | |
| amines | values | point | (K) | (25° C.) | Miscibility |
| TEA | 12.24 | 88.8° C. | 262.5 | 6.86 × 10⁴ mg/L | Miscible with water |
| | | | | | below 18.7° C. |
| TPA | 10.99 | 156 | 557.50 | 0.75 mg/ml at | |
| | | | | 25° C. | |
| NMP | 11.96 | 107.0° C. | Not available | Soluble in water | NMP-water system |
| | | | | | shows a miscibility |
| | | | | | gap at lower critical |
| | | | | | solution temperature |
| | | | | | (316.7K) |
| DBU | 13.12 | 80.0° C. | Not available | 1.0 g/L | Miscible with water |
| DMA | 6.92 | 193° C. | 687.7K | 1,454 mg/L at | Not available |
| | | | | 25° C. | |
| DEA | 9.51 | 216.3° C. | Not available | 139 mg/L at | Not available |
| | | | | 25° C. | |
| TEEDA | 11.64 | 192° C. | Not available | Not available | Not available |

Triethylamine (TEA); Tripropylamine (TPA); N-methylpiperidine (NMP); 1,8-Diazabicyclo[5.4.0]undec-7-ene (DBU); N,N,N′,N′-Tetraethylethylenediamine (TEEDA); N,N-diethylaniline (DEA); N,N-dimethylaniline (DMA).

Tertiary amines only have active N atoms as the proton acceptors but no proton contribution, so that only unidirectional hydrogen bonding between tertiary amines and water can be observed. Strong hydrogen bonding at low temperatures can result in homogeneous amine aqueous solutions. However, the increase in temperature breaks unidirectional hydrogen bonding and strengthens hydrophobic interactions, generating two immiscible liquid phases. Since TEA and water system are immiscible at a temperature above its upper consolute temperature (18.5° C.), TEA and water are miscible during hydrolysis reactions. Though the amines-induced hydrolysis of Nylon 6 is complicated, TEA presents the best catalytic performance in hydrolytic depolymerization of Nylon 6 at 250° C. It is also noted that with TEA, the selectivity to ε-ε-caprolactam was close to 100% in the Nylon 6 depolymerization. On the other hand, as can be seen in Table 2, except DBU, TEA with the lowest boiling point can be separated from water and ε-caprolactam by distillation. Thus TEA is chosen as the catalyst for the rest of the studies in this example.

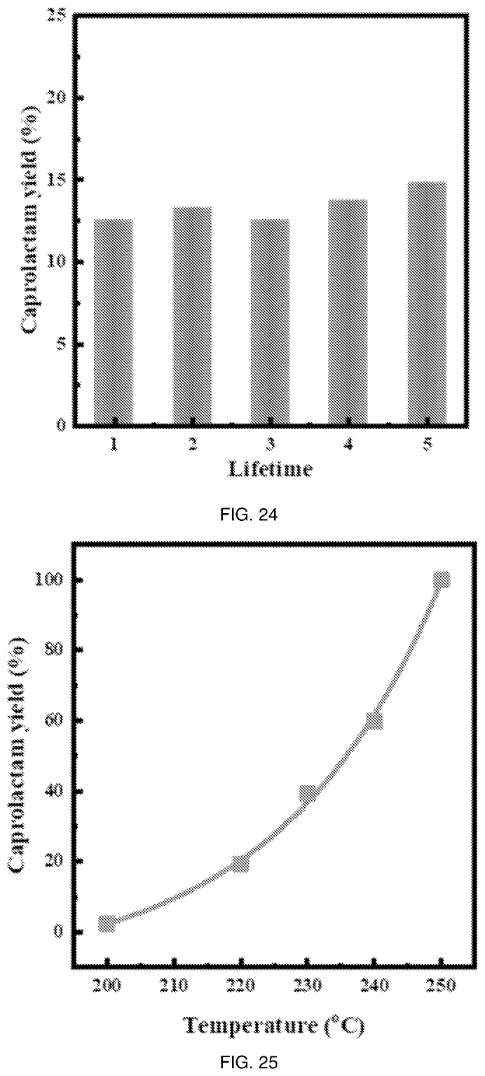

According to the definition of a catalyst, the catalyst will not be consumed during the chemical reaction. A catalyst can still maintain the original chemical state and continue to play a catalytic role. At elevated temperatures, the catalysts may be deactivated after repeated use because the catalyst may undergo a series of physical and chemical changes in a certain reaction, such as the DBU catalyst in a previous study. TEA is a stable organic base and remains stable to backbone hydrolysis. FIG. 24 presented that the yield of ε-caprolactam was approximately maintained constant during five recycling times. Thus, the catalytic activity of TEA during hydrolysis of Nylon 6 was relatively stable after the hydrolysis reaction at elevated temperatures.

Catalytic performance of TEA. Augmenting reaction temperature and extending reaction time accelerated the rate of hydrolysis of Nylon 6, as shown in FIG. 27. When the reaction temperature was increased from 200° C. to 250° C., the yield of ε-caprolactam increased from 2% to 100%. Whereas the catalysts, such as ionic liquids, solid acid, zeolite H-Beta, α-alumina supported KOH, or phosphotungstic heteropoly acid was used in hydrolysis of Nylon 6, the reaction temperature was up to 300° C. TEA presented superior catalytic activity in terms of reducing the reaction temperature for hydrolysis of Nylon 6 remarkably.

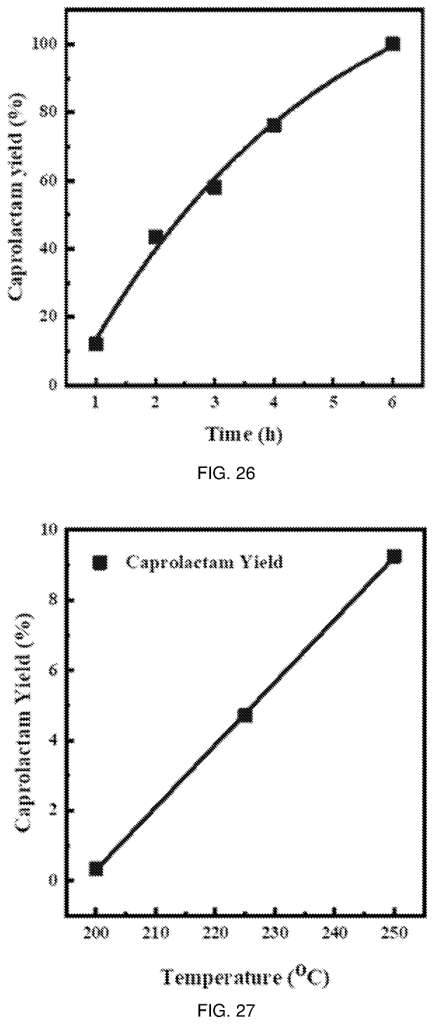

In addition to increasing reaction temperature, extending reaction time benefited the formation of ε-caprolactam (FIG. 26). When the reaction time was extended from 1 h to 6 h, the yield of ε-caprolactam augmented from 10% to 100%. By contrast, for the catalysts with poorer catalytic performance, e.g., NMP (FIG. 27), a longer reaction time would be needed to achieve complete conversion of Nylon 6. Hydrolytic depolymerization of Nylon 6 with sulfuric acid is still incomplete after 20 h. Thus base induced hydrolysis was more favorable for the deconstruction of Nylon 6.

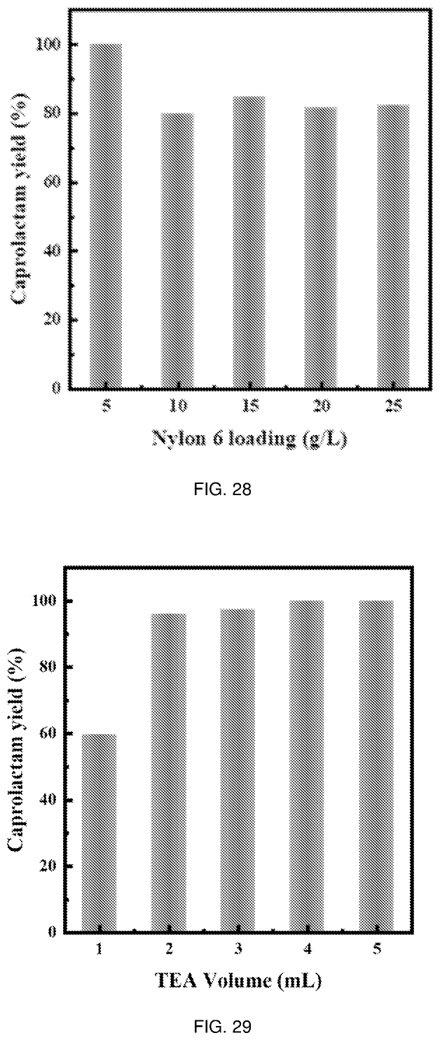

After the hydrolysis temperature and time were optimized at 250° C. and 6 h, the effect of Nylon 6 loading on the yield of ε-caprolactam was investigated, as shown in FIG. 28. Increasing Nylon 6 loading from 5 g/L to 25 g/L while maintaining TEA concentration resulted in a decrease in the yield of ε-caprolactam, meaning that the catalyst was not enough in the hydrolysis process. When the Nylon 6 loading was increased fivefold, the yield of ε-caprolactam decreased from 100% to 82%.

Decreasing the amount of TEA to no less than 2 mL led to a minor effect on the yield of the ε-caprolactam (FIG. 29). However, when 1 mL catalyst was used, the coke was observed, meaning that the Nylon 6 cannot be completely degraded to monomers.

Mechanistic insight to TEA-catalyzed hydrolytic depolymerization of Nylon 6. Since Nylon 6 is insoluble in a water-based solution, its hydrolysis reaction is commonly conducted at supercritical conditions. Hydrolysis of Nylon 6 using supercritical water resulted in intramolecular back-biting process, and the hydrothermal effect possibly generated oligomers, which are soluble in water, at supercritical water condition.

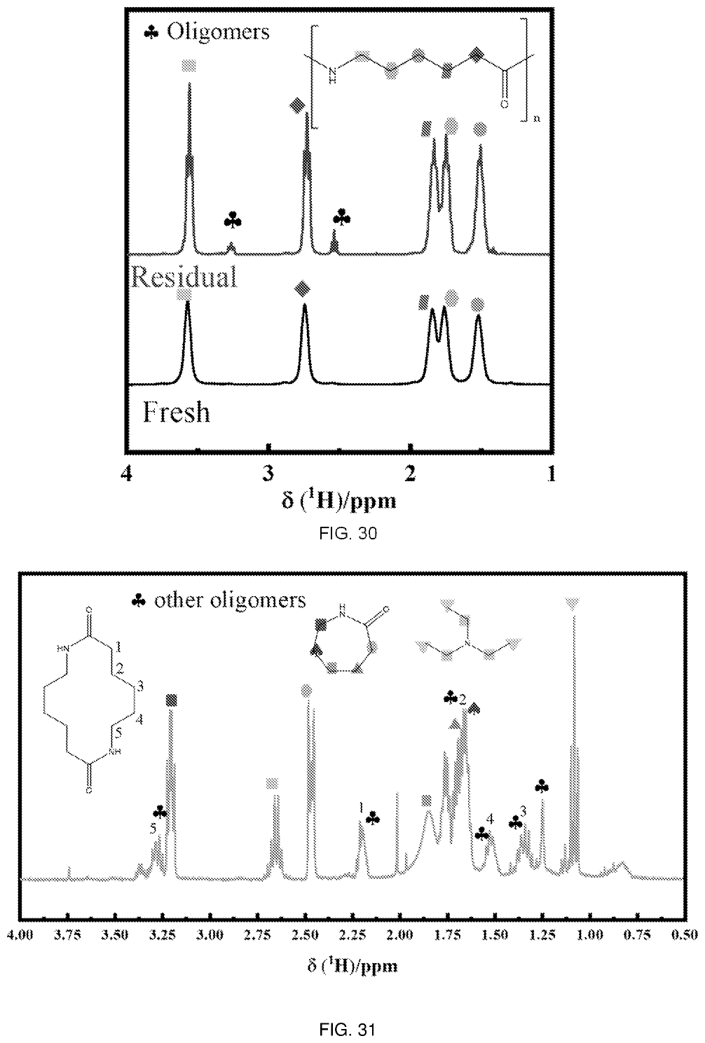

In this example, the reaction temperature (250° C.) is lower than supercritical water condition (373° C.). To probe the molecular-level mechanism for changes of Nylon 6 chain, the proton NMR experiments were conducted for the solid residues and the liquid products in these experiments. Comparing the ¹H NMR of the fresh Nylon 6 and the Nylon 6 residues, the ¹H NMR results are somewhat different, which indicates that there were structure changes after the hydrolysis of the fresh Nylon 6, as shown in FIG. 30. Note that the peaks at 1.519, 1.761, 1.846, 2.743, and 3.569 ppm were assigned for the methylene groups in the Nylon 6 polymer unit, respectively, meaning that the main component of the solid residues is still Nylon 6. However, there were additional peaks at 2.533 and 3.266 ppm assigning for the methylene groups near carbonyl group and N atom of insoluble Nylon 6 oligomers, respectively. There were oligomers in the solid residue, suggesting that the depolymerization of Nylon 6 occurred at the random position of the chain.

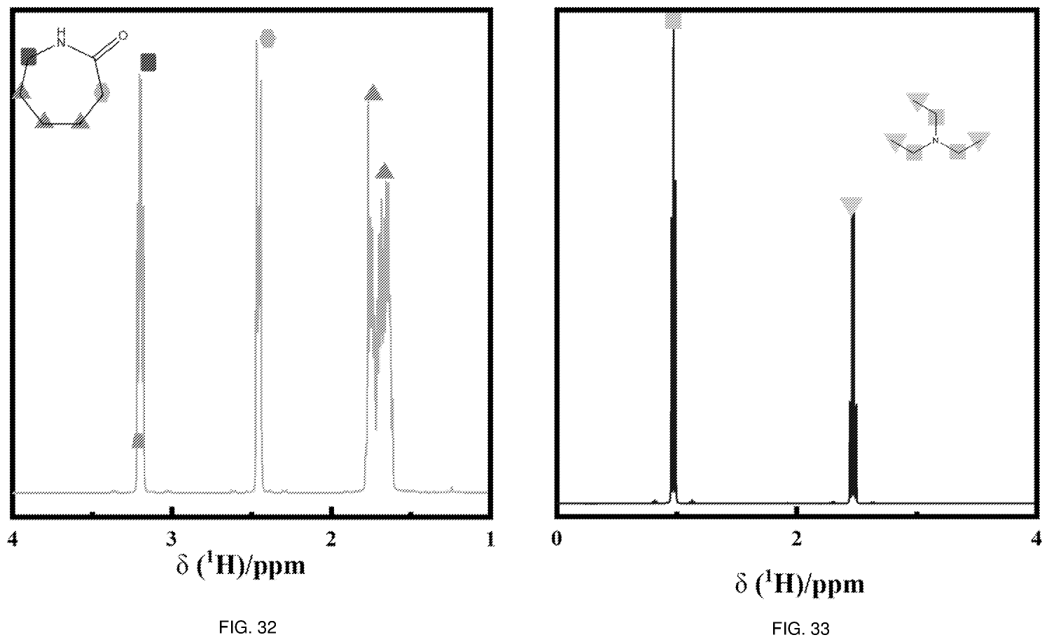

The ¹H NMR spectra of the soluble products from the catalyzed hydrolysis were performed to further determine the products in the liquid phase. After the hydrolysis of Nylon 6, the ¹H spectra in FIG. 31 shows there is ε-caprolactam as the main product according to the signals of 3.20 (CH₂—NH), 2.49 (CH₂—CO), 1.85 (—CH₂—), 1.65 (—CH₂—), and 1.68 (—CH₂—) ppm (FIG. 32), which is in good agreement with the literature. Note that the signals at 1.056 and 2.628 were assigned to the triethylamine, as shown in FIG. 33. Further, there are signals at 3.28 (CH₂—NH), 2.21 (CH₂—CO), 1.67 (—CH₂—), 1.53 (—CH₂—), and 1.34 (—CH₂—) ppm assigning to caprolactam cyclic dimer, namely 1,8-diazacyclotetradecane-2,9-dione. Other soluble oligomers signals of polyamide 6 were also observed, indicating that random scission is the depolymerization mechanism in TEA-catalyzed hydrolysis of polyamide 6. Combining the insoluble oligomers ¹H NMR signals of solid residues and the water-soluble oligomers, it is concluded that random scission is the depolymerization mechanism in the hydrolysis of Nylon 6 in the presence of TEA.

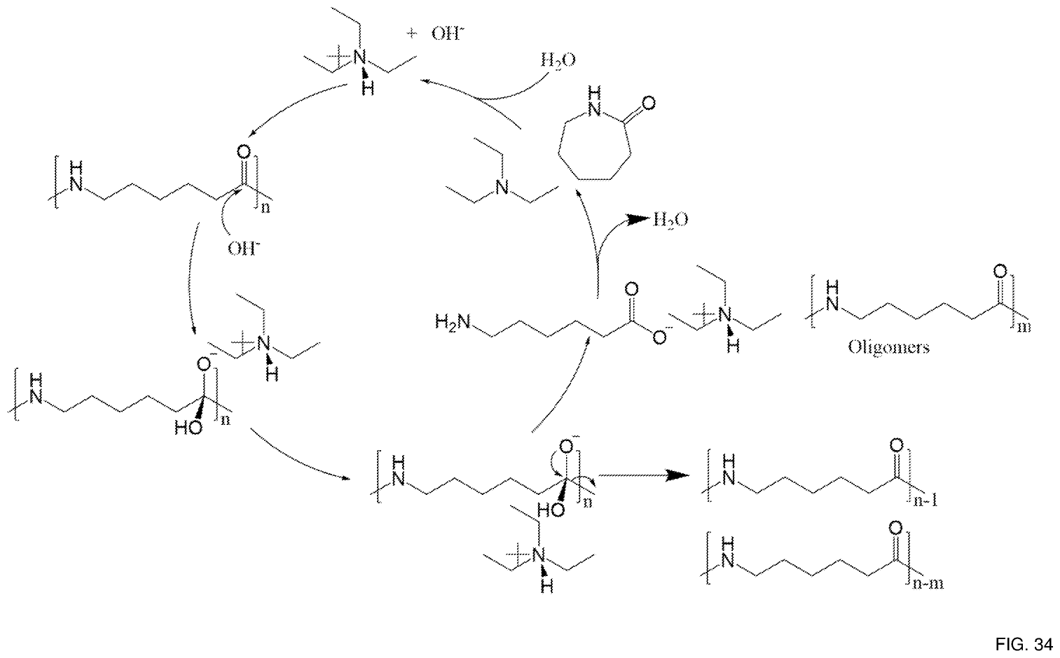

The proposed reaction pathway of TEA-catalyzed hydrolytic depolymerization of polyamide 6 is depicted in FIG. 34. TEA acts as a base due to the lone pair electrons of the N atom, and the basicity of it can be transferred to the water as the O—H group of water is the common proton donor. The water dissociation in terms of hydrogen and hydroxyl ion concentration was the determining factor for a hydrolysis reaction. Therefore, TEA can be readily protonated by water while forming the weak hydrogen bonding structure, so TEA⁺ and OH⁻ are generated. The nucleophilic attack of the hydroxide ion at the carbonyl group in a Nylon 6 polymer unit generated the ionized intermediate. The electron transfer of the intermediate resulted in the cleavage of the amide bonds, generating deprotonated 6-aminocaproic acid, the ε-caprolactam oligomers, and the corresponding chain-cut polyamide 6. The corresponding oligomer will undergo a similar reaction gradually until it is completely degraded. The cyclodehydration of deprotonated 6-aminocaproic acid to produce ε-caprolactam occurred easily, so that the catalyst TEA can be regenerated for the next run. At last, all the feedstock is deconstructed to ε-caprolactam monomer.

Conclusion. Four types of tertiary organic amine were employed in hydrolytic depolymerization of Nylon 6 for the first time, and TEA with strong basicity and stability were superior to other amines in catalyzing the hydrolysis reaction. The catalytic activities of tertiary amine are highly associated with their pH values and steric hindrance of substituents. Complete hydrolytic depolymerization of Nylon 6 was achieved at 250° C. for 6 h, and the yields of ε-caprolactam reached 100%. The NMR results with oligomers of Nylon 6 demonstrated that the random scission was the depolymerization mechanism of Nylon 6 in amine-induced hydrolysis. A possible reaction pathway of TEA-catalyzed hydrolytic depolymerization of Nylon 6 is proposed. These findings showed a full understanding of TEA-catalyzed degradation of Nylon 6 to ε-caprolactam in water.

### Example 3. Deconstruction of High-Density Polyethylene into Liquid Hydrocarbon Fuels and Lubricants by Hydrogenolysis Over Ru Catalyst

Summary. Polyethylene (PE) is the most popular plastic globally, and the widespread use of plastics has created severe environmental issues. High energy consumption in the current process makes its recycling a challenging problem. In this example, the depolymerization of high-density polyethylene (HDPE) was conducted in various liquid-phase solvents with the Ru/C catalyst under relatively mild conditions. The maximum yields of the jet-fuel-range and lubricant hydrocarbons were 60.8 wt % and 31.6 wt %, respectively. After optimizing the reaction conditions (220° C. and 60 bar of H₂), the total yield of liquid hydrocarbon products reached approximately 90 wt % within only one hour. The product distribution could be tuned by the H₂ partial pressure, the active metal particle size, and the solvents. The solvation of PE in the different solvents determined the depolymerization reaction kinetics, which was confirmed by the molecular dynamics (MD) simulation results.

Introduction. The accumulation of waste plastics in landfills and oceans has caused a global environmental crisis. In particular, microplastics have been entering the food chain and become a potential threat to human health. Though there are thousands of plastic materials in use, only six of them, polyethylene (PE, high and low density), polypropylene (PP), polyvinyl chloride (PVC), polystyrene (PS, including expanded PS or EPS), polyurethane (PUR), and polyethylene terephthalate (PET), are widely used. Collectively, ˜6.3 billion metric tons of plastic waste had been produced by 2015, among which 79% was landfilled, 12% was incinerated, and only 9% was recycled. PE is the polymer with the most massive volume produced globally, and the production could reach over 100 million tonnes per year. Therefore, the efficient upcycling of waste plastics, especially PE, is critical to mitigating the severe environmental problem.

Waste plastics recycling technologies mainly include three ways: mechanical recycling, incineration, and chemical recycling. Mechanical recycling is the only technology used commercially for the large-scale plastic recycling process, but it still suffers from decreasing product quality after the consecutive melting and remolding cycles. Although incineration converts mixed waste plastics to heat and electricity, the energy recovery efficiency cannot be as much as that from chemical recycling due to the massive loss of energy. Therefore, chemical recycling is considered a promising process to realize waste plastics valorization, in which plastics are the low-cost feedstock to produce value-added chemicals or fuels.

Recently, pyrolysis has been extensively investigated as a chemical recycling technology. The world's largest resin producers, including Chevron Phillips Chemical (CPC), Saudi Basic Industries Corporation (SABIC), and BASF, have been using this technology to produce circular polymers from plastics waste. Indeed, CPC has already accomplished the first commercial-scale production of circular PE in the United States. Besides the commercial application, catalytic pyrolysis has also drawn many attractions from research communities. The production of syngas or liquid hydrocarbon fuels from PE waste is technically feasible. However, elevated temperatures (>300° C.) are needed in catalytic pyrolysis processes, which may not be economically sound due to the high energy consumption. Moreover, it is challenging to control product distribution at high temperatures. Besides linear alkanes, branched, cyclic, and aromatic hydrocarbons are produced during pyrolysis. Aromatics are of value, but they can readily be transformed into coke that might cause catalyst deactivation. Even though the catalyst could be regenerated after burning the coke, the operation cost would increase substantially.

Therefore, developing effective catalytic processes that could selectively convert PE to high-value chemicals under mild reaction conditions is of utmost importance for chemical upcycling of PE waste plastics. For instance, Sadow and coworkers designed a mesoporous catalyst with a Pt core@SiO₂ shell structure to selectively convert HDPE to a narrow distribution of diesel and lubricant-range alkanes in a solvent-free system (300° C., 24 hours, 1.38 MPa H₂). The polymer molecules thread and bind into the silica pores, and the small-molecule products desorb and exit the pores after the cleavage from the polymer end at the active sites on the Pt metal catalyst surface. Likewise, Scott and coworkers developed a tandem solvent-free hydrogenolysis/aromatization process to produce valuable alkyl aromatics from PE with a Pt/Al₂O₃ catalyst at 280° C. Although these solvent-free methods provided a strategy for manufacturing higher-value products from PE waste, the kinetic performance is still an issue, which requires an extended processing time (24 hours).

In general, compared with solvent-free pyrolysis, PE depolymerization can be promoted dramatically using solvents, where mass transfer and heat transfer rates can be improved. Adams et al. used ionic liquids to convert PE at 120° C., and the yield of low-molecule-weight hydrocarbons reached 95% in 72 hours. Though the reaction temperature was much lower, the reaction time had to be prolonged to achieve satisfactory outcomes. Meanwhile, the separation might be an issue as another solvent was needed to extract the products from the ionic liquid solvent. Jia et al. reported that PE was degraded into transportation fuels and waxes through cross-alkane metathesis with hexane, 98% of which were converted into liquid hydrocarbon oils at 150° C. in 3 days. Ideally, a well-designed solvent system with appropriate heterogeneous catalysts could promote highly selective PE depolymerization under mild conditions. However, for the current solvolysis process, catalytic deconstruction rates still need to be enhanced. Practically, recovery, reuse, and the lifetime of solvents and catalysts could also be the limiting factor for large-scale applications.

In a previous study, ruthenium on carbon catalyst was found to be able to convert n-heptadecane to short-chain hydrocarbons at mild conditions. Ruthenium catalyst is known to be capable of cleaving the C—C bond. The dehydrogenative chemisorption of the hydrocarbons is considered as the first step in the mechanism of hydrogenolysis on active metal, and then the formed hydrogen deficient surface species go through C—C bond scission. After the cleavage of C—C, the reaction is finally completed by hydrogenation and desorption. PE has the simplest structure of any polymers, consisting of long hydrocarbon chains. The remarkably high activity of ruthenium catalyst in the hydrogenolysis of polyethylene has also been reported by Rorrer et al. in the absence of solvent. It is hypothesized that ruthenium catalysts can break the C—C bonds in PE polymer using a suitable solvent. Hence, in the current example, the conversion of PE to liquid fuels was investigated with Ru/C catalyst in the liquid-phase reaction, which has not been previously reported.

Materials and Methods. The feedstocks, HDPE plastic water jugs, were collected from the local recycling center in Pullman, Washington. Before the experiment, the jug was cleaned with DI water and dried at 100° C., and then was cut into strips (5 mm×5 mm). All chemicals were used as received without further treatment. The catalysts, Ru/C (5% Ru basis), Pd/C (5% Pd basis), Pt/C (5% Pt basis), Rh/C (5% Rh basis), the catalyst precursors, copper(II) nitrate trihydrate (99%), Iron(III) nitrate nonahydrate (98%), and the self-synthesized catalyst support, activated charcoal Norit® (Norit International, Amersfoort, Netherlands), were supplied from Sigma-Aldrich. Nickel(II) nitrate hexahydrate (99%) was purchased from Millipore Sigma. P-xylene (99%) was purchased from Alfa Aesar. Ultrapure water (specific resistance of 18.2 MΩ cm⁻¹), n-pentane (Alfa Aesar, 98%), n-hexane (J. T. Baker, 95%), methylcyclohexane (Alfa Aesar, 99%), decalin (Tokyo Chemical Industry Co., 99%) were used as the solvents.

5% Cu/C, 5% Fe/C, and 5% Ni/C were synthesized through impregnation with copper nitrate trihydrate, iron nitrate nonahydrate, and nickel nitrate hexahydrate, respectively, as the metal precursors and activated charcoal Norit® (Norit International) as the support. After being dried, the as-prepared 5% Ni/C, 5% Fe/C, and 5% Ni/C samples were calcinated at 350° C. (Ni/C) or 500° C. (Fe/C and Ni/C) for 3 hours in an atmosphere of nitrogen. Finally, the catalysts were reduced in H₂ flow at 400° C. (Ni/C) or 500° C. (Fe/C and Ni/C) for five hours prior to use.

Characterization. The specific surface area of the catalysts was determined through single-point adsorption of N₂ at 77K with a Micromeritics Autochem II 2920. The samples were prepared in Helium at 200° C. for 1 hour before nitrogen adsorption (30% N₂/He).

The CO pulse chemisorption was used to determine the metal dispersion, active metal particle size, and metallic surface area. The test was carried out on a Micromeritics Autochem II 2920. The sample was reduced for two hours at 300° C. with 10% H₂/Ar at a 50 mL/min flow rate and then purged with Helium for one hour at a flow rate of 50 mL/min. After the sample was cooled to ambient temperature, 10% CO/He was added at each pulse, and the CO uptake profile was measured using a TCD detector until no CO was adsorbed. The Ru dispersion was calculated assuming a CO:Ru stoichiometry of 1:1.

The fresh and spent Ru/C catalysts were characterized by transmission electron microscopy (TEM) on a JEOL 2010 J microscope at an accelerating voltage of 200 kV. The Gatan Digital Micrograph software was used to conduct data processing and analysis. The catalyst powder samples were dispersed on the Formvar film nickel grids (200 mesh).

The X-ray photoelectron spectroscopy (XPS) analyses were carried out on a Kratos AXIS-165 with a monochromatized Al-Kα X-ray anode (1486.6 eV) by using the C 1s peak at 284.6 eV as the internal reference. The deconvolutions of Ru 3p were analyzed with the software of XPSPEAK Version 4.1.

The crystalline catalyst structure was evaluated by X-ray powder diffraction (XRD, Rigaku Miniflex 600), using Co-Kα radiation source (λ=Å) at a 2θ step of 10°-90° with a step size of 0.02°.

Thermal gravimetric analysis (TGA) was performed using TA instruments Q50. The samples were loaded in aluminum crucibles and heated in air flow (60 ml/min) from 25° C. to 600° C. at a heating rate of 10° C./min.

Reaction procedure. The depolymerization experiments were carried out in a 45 mL elevated-pressure & temperature Parr Series 5000 Multiple Reactor System with a 4871 temperature controller. In a typical experiment, a certain amount of HDPE strips and catalyst were loaded in 25 mL solvents. The vessels were sealed, purged five times with 400 psi N₂, followed by three times with 400 psi H₂, and then pressurized with H₂ to the set pressure at ambient temperature. Then the reactor was heated up to the set reaction temperature with magnetic stirring at 700 rpm. After the reaction, the vessel was quenched in a cold bath for fast cooling.

Analysis. After the reaction, the reactor was connected to a gas chromatograph (GC) Shimadzu GC-2014 with a thermal conductivity detector (TCD) to analyze the gas phase product samples. The columns included a right 12.5 m(L)×0.32 mm(ID) packed column, which is comprised of 3 m Hayesep D, 4 m HS, and 2.5 m HN, and a left 2 m (L)×0.32 mm(ID) 10% Carbowax 20 m Ch packed column. After the reactor was dissembled, the solid catalyst and non-dissolvable residues were filtered out of the liquid phase. Then the liquid product samples were collected, and the internal standard, p-xylene, was added. The liquid samples were analyzed by a GC/MS QP-2020 (Shimadzu) to identify and quantify the unknown products. The GC/MS QP-2020 was equipped with a Shimadzu SH-Rxi-5SIL MS column (30 m×0.25 mm ID, 0.25 um film thickness), a flame ionization detector (FID), and a high-performance ion source. The following definitions were used to quantitate the weight yield (y):

$$y = \frac{\sum {m}_{x}}{{m}_{0}} \times 100 \%$$

Where m₀ is the weight of the HDPE feedstock before reaction, mₓ is the weight of the alkane hydrocarbons after the reaction, where x means the carbon number.

Molecular Dynamics Simulations. A PE molecule of C₁₀₀H₂₀₂ in length was packed into five different simulation boxes of 10×10×10 nm³. Each box was filled with one of the five different solvents: methylcyclohexane, n-pentane, n-hexane, water, and decalin. Water was modeled using the SPC/E water forcefield, while the forcefields for the organic solvents were obtained from the Automated Topology Builder (ATB) repository. For decalin, the isomer used was trans-decalin, as trans-decalin is more stable than its cis-counterpart due to its di-equatorial chair conformation. Each system was simulated using the GROMACS 2018.3 simulation package. Steepest descent algorithms were used to remove unfavorable contacts in the initial configuration. Electrostatic interactions were calculated with the particle mesh Ewald (PME) summation method with an electrostatic cutoff value of 1.0 nm and van der Waals cutoff value of 1.0 nm. The system was evolved in the NPT ensemble (temperature 493 K, pressure 1 atm) for 2 ns using the Donadio-Bussi-Parrinello thermostat (time constant τ=0.1 ps) and the Berendsen barostat (time constant τ=1 ps). A temperature of 493 K was chosen to be consistent with the experiment. All the dimensions of the box were allowed to change during the NPT simulation. The production runs were carried out in the NVT ensemble (temperature 493 K), where the temperature was maintained using the Donadio-Bussi-Parrinello thermostat (time constant τ=0.1 ps) for 500 ns.

The polymer structure in the solvent was captured through the average radius of gyration calculated over the entire simulation time of 500 ns. To assess the dynamic behavior of the polymer in different solvents, the end-to-end autocorrelation function was calculated according to the equation below:

$$e 2 e ( t ) ≡ \frac{< A ( t ) \cdot A ( 0 ) >}{< A ( 0 ) \cdot A ( 0 ) >}$$

where A is the vector from the first carbon atom to the last carbon atom along the polymer chain.

Hansen solubility parameters. Three different parameters, δD, δP, and δH for dispersion, polar and hydrogen-bonding, were used to evaluate the similarity between different materials. A sphere of the interaction radius (Ro) contains all the suitable solvents, and Eqn (1) describes the solubility distance (Ra) between two materials. Relative Energy Difference (RED) (Eqn. 2) is used to reflect the likelihood of the solvent (2) to dissolve the polymer (1). All the parameters and calculated results are shown in Tables 5 and 6.

(Ra)²=4(δD2−δD1)²+(δP2−δP1)²+(δH2−δH1)² Eqn. (1)

RED=Ra/Ro Eqn. (2)

Results.

Characterization of catalysts. Table 3 shows the structural parameters of the fresh and spent Ru/C catalysts. The specific surface area, the metallic surface area, and the active metal dispersion decreased after the first run but kept the same after the second run. The result showed that the catalyst structure became stable after the first cycle. The decrease in Ru dispersion may be partly due to metal leaching during the reaction. The Ru particle size increased from 2.9 nm to 4.1 nm, indicating that sintering occurred after the first run. These structural changes may explain the decrease in the catalytic activity after the first run.

TABLE 3
Physicochemical characterization results for the Ru/C catalysts

| | S_{BET} | Particle Size | Ru | Metallic Surface |
|---|---|---|---|---|
| Catalysts | (m² g⁻¹) | (nm) | Dispersion | Area (m² g⁻¹) |
| fresh Ru/C | 737.0 | 2.9 | 33.1% | 8.1 |
| Ru/C-used Cycle 1 | 704.3 | 4.1 | 24.3% | 5.9 |
| Ru/C-used Cycle 2 | 689.0 | 4.1 | 24.3% | 5.9 |

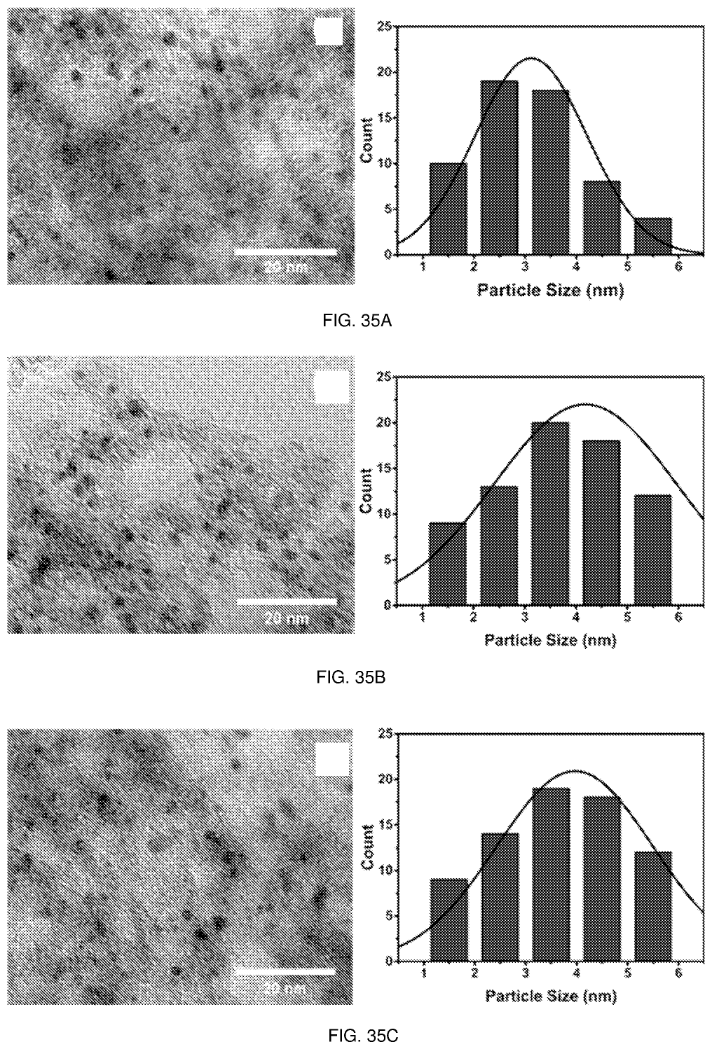

The TEM images of the fresh and spent Ru/C catalysts are shown in FIGS. 35A-35C, showing that the Ru nanoparticles are well dispersed on the carbon support. The mean particle size on the fresh catalyst was approximately 3.1 nm. A slight shift in the particle size distribution was observed on the used catalysts though the particle size was in the range of 2˜5 nm. According to the TEM images, the mean particle size of the spent Ru/C catalysts after the first and second cycle was 4.2 nm and 4.0 nm, respectively, which is consistent with the CO pulse chemisorption result. Both characterization results demonstrated that the aggregation occurred on the Ru/C catalyst after the first cycle, while the Ru particle size became nearly unchanged in the subsequent cycles.

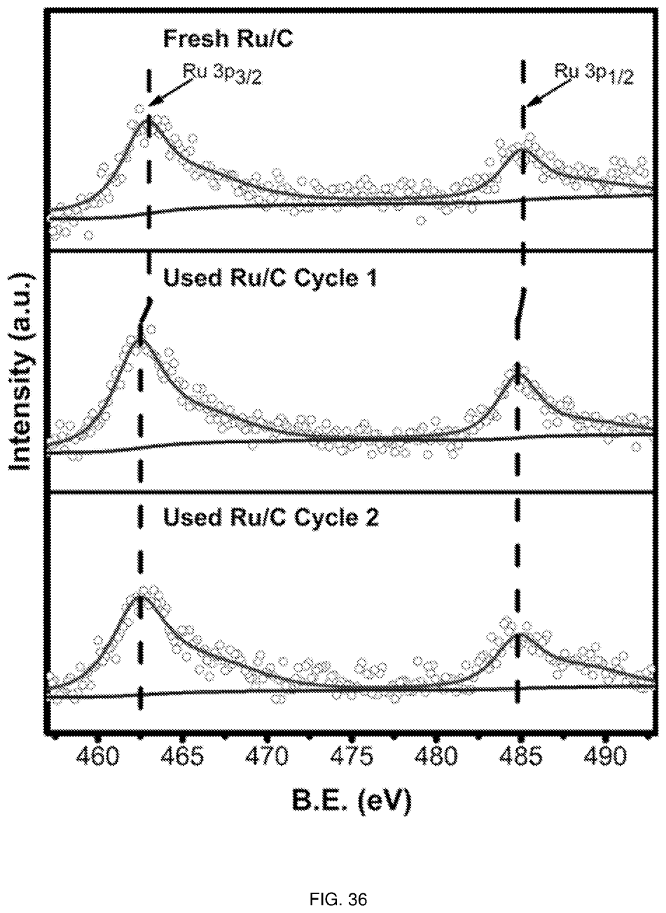

The X-ray photoelectron spectroscopy (XPS) was employed to investigate the valence state change in the ruthenium particles before and after the reaction. Since the Ru 3d doublet is overlapped with C 1s, Ru 3p is commonly used to characterize the change in the Ru element valence state. FIG. 36 shows that the Ru 3p_{1/2} and 3p_{3/2} binding energies of the fresh Ru/C catalyst are 462.9 and 485.0 eV, respectively, while those of the spent catalyst shift to low values, 462.4 and 484.8 eV, respectively, after the reaction, indicating that ruthenium oxide on the catalyst was reduced by H₂ during the reaction. Meanwhile, the Ru atomic percentage decreased from 1.6% to 1.05% after the first cycle, while it kept the same after the second cycle, which is consistent with the trend of the decrease in the metallic surface area in Table 3.

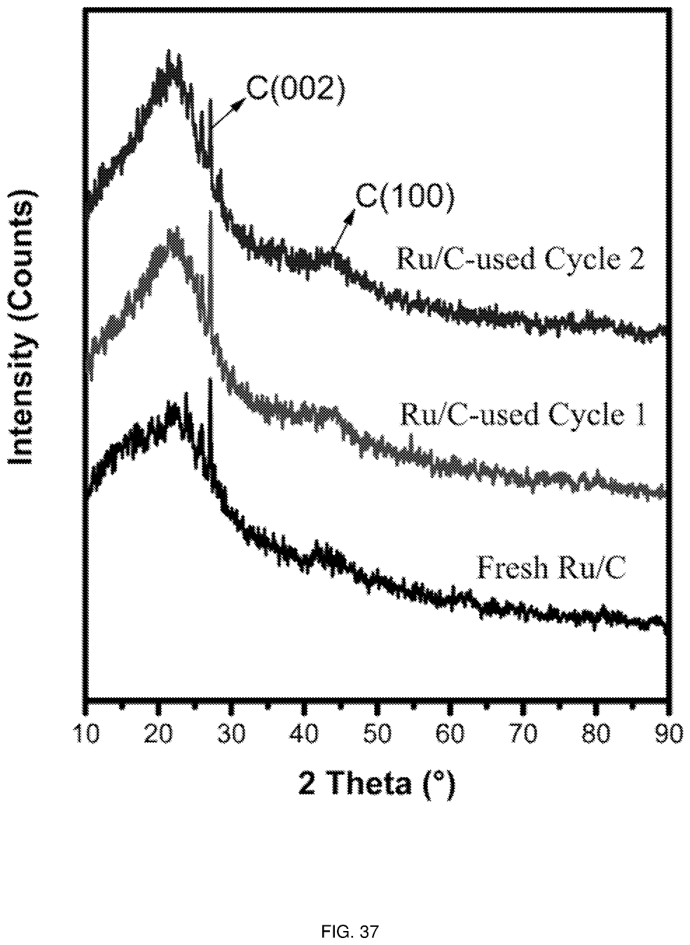

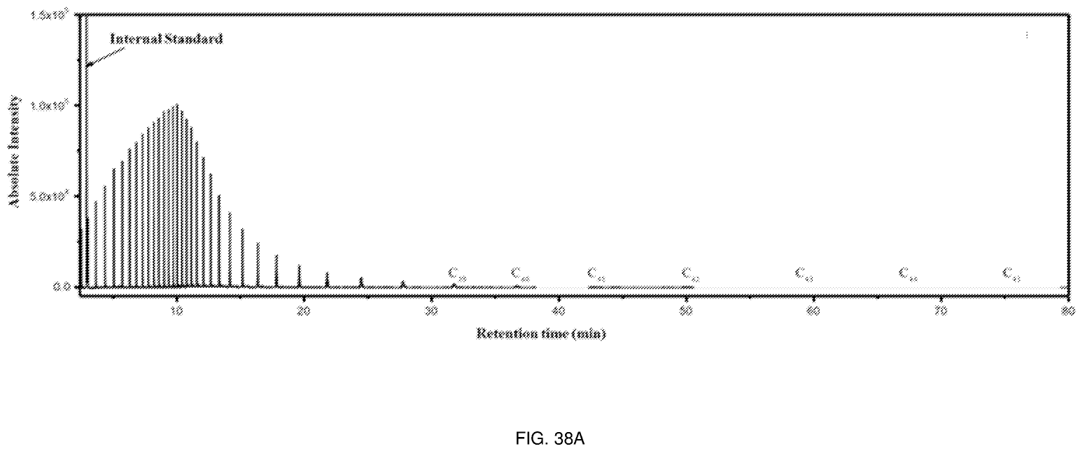

The crystalline structures of the fresh and used catalysts before and after the HDPE depolymerization, respectively, were characterized through XRD (FIG. 37). Two XRD diffraction peaks at about 2θ=25° and 43° are associated with the (002) and (100) phases of the carbon support. No ruthenium or ruthenium oxide peaks were observed, indicating that the ruthenium particles were very small and dispersed on the carbon support very well. No significant change in the XRD patterns was observed before and after the reaction, implying that the catalyst's crystal structure might be unchanged.

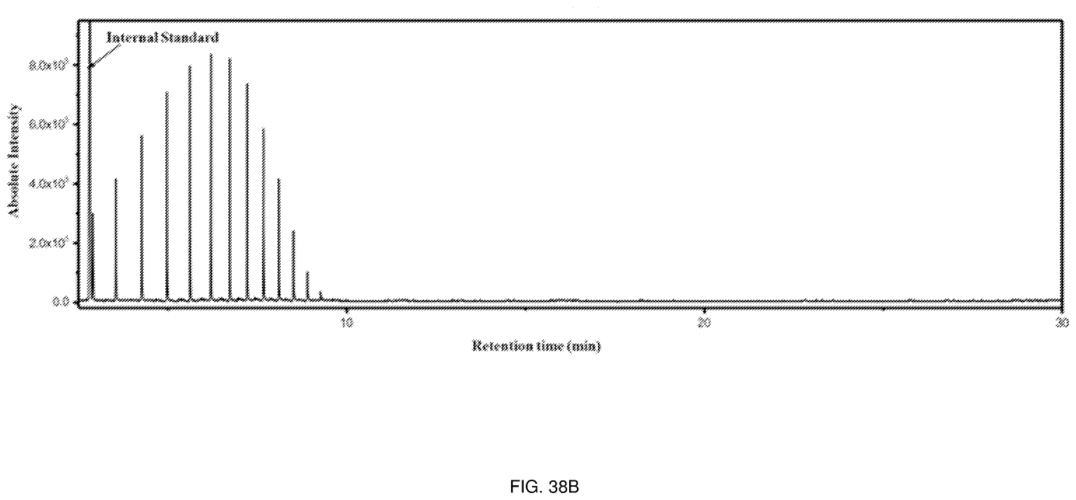

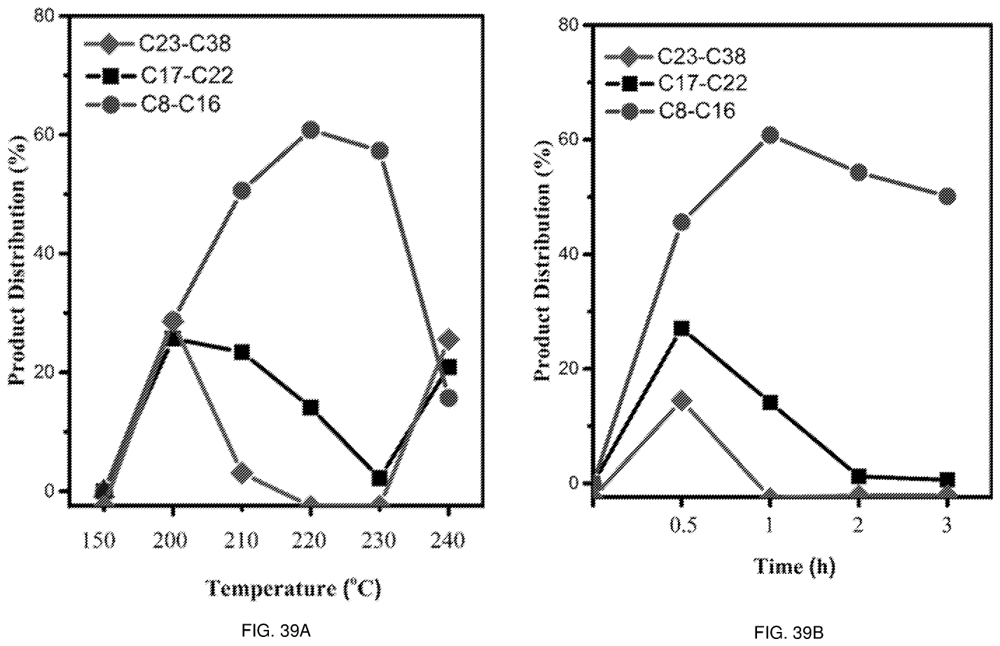

Catalyst screening. The HDPE depolymerization reaction was investigated with a variety of carbon-supported metal catalysts under the same reaction conditions. The experimental results in Table 4 show that the copper, iron, palladium, platinum, nickel catalysts displayed no effect on the HDPE depolymerization at 220° C. Though other groups reported that iron, palladium, nickel could promote the PE deconstruction, high temperatures (e.g., 430° C.) were still necessary for such processes. Recently, the Pt@SiO₂ catalysts were reported to carry out the hydrogenolysis of HDPE in a solvent-free system for an extended reaction time, 24 h, at a relatively low temperature (250° C.). In contrast, in this example, only <0.5 wt % of the HDPE depolymerization products (C8-C38) were detected on GC-MS with the Pt/C catalyst in n-hexane even reacted for 6 h at 250° C. The solvent system's poor performance may be ascribed to HDPE's low solubility in supercritical n-hexane (critical temperature: 234.5° C.). Rhodium was reported to own the catalytic ability in C—C cracking, which is similar to ruthenium. However, with the Rh/C catalyst, no detectable liquid hydrocarbon products by GC/MS were observed at 220° C. though there was no residue after the reaction. Long-chain hydrocarbons (>C₄₅) with high molecular-weights, which are beyond the detection limit of the mass spectrometer, could be the main products. As the temperature increased to 280° C., an ˜75.3 wt % yield of alkanes in the range of C8 to C38 was obtained (FIG. 38A), demonstrating that Rh is also active for C—C hydrogenolysis at elevated temperatures. In contrast, the full conversion of HDPE to hydrocarbon fuels by pyrolysis with the Ru/Y-zeolite catalyst was accomplished at 600° C. However, the severe coke deposition on the catalyst in pyrolysis raised concerns on the catalyst stability. Here, the Ru/C catalyst was superior among all the screened catalysts in this example. The HDPE strips were converted to 60.8 wt % jet-fuel-range and 14.1 wt % diesel-range alkanes at 220° C. in just 1 h with the Ru/C catalyst in n-hexane, and no long-chain products can be detected (FIG. 38B). Compared with other metals, ruthenium metal was reported to own the lowest activation energy in ethane hydrogenolysis, favoring the C—C bond cleavage. In the comparison of ethane hydrogenolysis on transition-metal catalysts, *CHCH* was found to be the primary intermediate in the C—C bond scission for Ru, Rh, and Pt, because it has the lowest free-energy barrier in C—C bond cleavage. Meanwhile, both *CHCH* and *CH₃CH* were considered dominant intermediates for Pd. Among these transition metals, the turnover rate in *CHCH* cleavage decreases in the order: Ru>Rh>Pt>Pd, which is consistent with the result that Ru could cleave the C—C efficiently and Pd has the lowest cleavage turnover rate.

TABLE 4
Performance of the screened catalysts in the depolymerization of HDPE. Reaction
condition: 0.1 g HDPE, catalyst 0.05 g, n-hexane 25 ml, p(H₂) = 30 bar, 700 rpm.

| | | | Temperature | Time | C8-C16 | C17-C22 | C23-C38 |
|---|---|---|---|---|---|---|---|
| Entry | Feedstock | Catalyst | (° C.) | (h) | (wt %) | (wt %) | (wt %) |
| 1 | HDPE | 5% Cu/C | 220 | 1 | 0 | 0 | 0 |
| 2 | HDPE | 5% Fe/C | 220 | 1 | 0 | 0 | 0 |
| 3 | HDPE | 5% Ni/C | 220 | 1 | 0 | 0 | 0 |
| 4 | HDPE | 5% Pt/C | 220 | 1 | 0 | 0 | 0 |
| 5 | HDPE | 5% Pd/C | 220 | 1 | 0 | 0 | 0 |
| 6 | HDPE | 5% Rh/C | 220 | 1 | 0 | 0 | 0 |
| 7 | HDPE | 5% Ru/C | 220 | 1 | 60.8 | 14.1 | 0 |
| 8 | HDPE | 5% Pt/C | 250 | 6 | 0.2 | 0.16 | 0.23 |
| 9 | HDPE | 5% Pd/C | 280 | 1 | 0.29 | 0.01 | 0.1 |
| 10 | HDPE | 5% Pt/C | 280 | 1 | 0.28 | 0.37 | 0.42 |
| 11 | HDPE | 5% Rh/C | 280 | 1 | 21.7 | 20.2 | 33.4 |

Tuning reaction parameters. The temperature effect on the HPDE depolymerization was shown in FIG. 39A. It was observed that no cracking product was detected at 150° C. When the depolymerization was carried out at 200° C., a complete HDPE conversion to liquid-phase alkanes was obtained. With increasing the temperature, the yield of high-molecular-weight alkane products decreased. The yield of the jet-fuel-range alkanes (C8-C16) reached a maximum of ˜60 wt % while that of the diesel fuels (C17-C22) was ˜15 wt % at 220° C., and almost all long-chain hydrocarbons (carbon number>23) were converted to short-chain alkanes in 1 hour. As the temperature increased to 230° C., the yields of jet- and diesel-fuel range alkanes decreased to ˜55 wt % and ˜5 wt %, respectively, due to the excess cracking. The HDPE polymer is difficult to be solvated in a supercritical solvent. At 240° C., which is higher than n-hexane's critical temperature (234.5° C.), an abrupt change in the product distribution compared to that at 230° C. was observed. The yield of the long-chain hydrocarbon products (C17-C38) increased dramatically from <5 wt % to −50 wt % as the temperature increased just 10° C. (from 230° C. to 240° C.), implying that the low solubility of HDPE in the supercritical n-hexane solvent could lead to much slow C—C bond cracking rates.

The reaction time is another crucial parameter to determine the product distribution. Here, the effect of reaction time on the HDPE depolymerization was also investigated, and the results were shown in FIG. 39B. Surprisingly, HDPE was rapidly degraded to liquid hydrocarbons (C number <38) in only 0.5 hours at 220° C. With increasing the reaction time, the yield of jet-fuel-range alkanes increased first and then decreased, ascribed to the excess cracking. The maximum yield (˜60 wt %) of jet-fuel range alkanes was achieved in 1 hour. Almost no high-molecular-weight products were observed after 1 hour.

Further, the catalyst loading effect on the depolymerization was also investigated by varying the amount of catalyst. As shown in FIG. 39C, the depolymerization reaction did not occur in the absence of a catalyst. The depolymerization reaction rate increased with the increasing catalyst loading. With a low loading of the catalyst ([Ru]/[HDPE] ratio was 2.1%), the yield of lubricant-range hydrocarbons (C24-C35) reached 31.6%. While the [Ru]/[HDPE] ratio increased to 8.3%, the yield of jet-fuel-range alkanes achieved the maximum value (˜60 wt %). As the catalyst amount continued to increase, the corresponding jet fuel yield decreased. Meanwhile, more short-chain hydrocarbons (carbon number <8) were observed after the [Ru]/[HDPE] ratio surpassed 1.2%, indicating an increasing amount of catalyst would promote the cracking reaction.

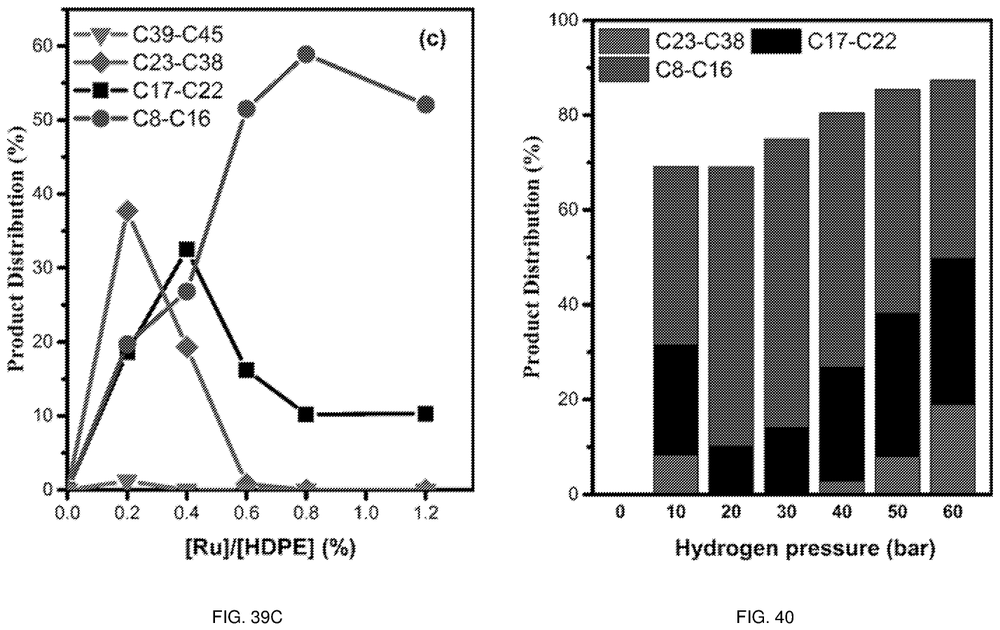

FIG. 40 shows that hydrogen pressure played a significant role in the HDPE depolymerization. In the absence of H₂, no product was detected. With increasing the H₂ pressure from 0 to 60 bar, the depolymerization reaction rate increased first, while then decreased after the H₂ pressure passed 30 bar, indicating higher hydrogen pressure may inhibit the depolymerization reaction. Iglesia and coworkers also observed that hydrogenolysis of the linear and branched alkanes (C₂-C₈) was reduced as the H₂ pressure increased. They found that H₂ pressure could also influence the C—C bond cleavage position in long-chain alkanes, probably due to the dehydrogenated intermediates formed by quasi-equilibrated adsorption and dehydrogenation. At low hydrogen pressures, the hydrogenolysis rates were proportional to the concentration of the reactive unsaturated intermediate [*CₙH_{2n+2-y}*], and the rates increased with hydrogen pressure. At high hydrogen pressures, the surface was mainly occupied by chemisorbed hydrogen atoms (H*), hindering the adsorption of intermediates and decreasing the hydrogenolysis rates. Note that Iglesia and coworkers studied the alkane hydrogenolysis in the gas phase, which may significantly differ from PE's hydrogenolysis in solvents. HDPE's structure resembles those of long carbon chain linear alkanes (varying in carbon chain length), consisting of only C_{secondary}-C_{primary} and C_{secondary}-C_{secondary} bonds. Hence, the Ru-catalyzed HDPE hydrogenolysis includes primarily two independent reactions: regioselective hydrogenolysis of the easily accessible C—C bonds (e.g., C_{secondary}-C_{secondary}), and hydrogenolysis of C_{secondary}-C_{primary} bonds (i.e., chain-end scission). Thus, the scission of C_{secondary}-C_{secondary} is preferred to acquire more valuable long-chain hydrocarbons.

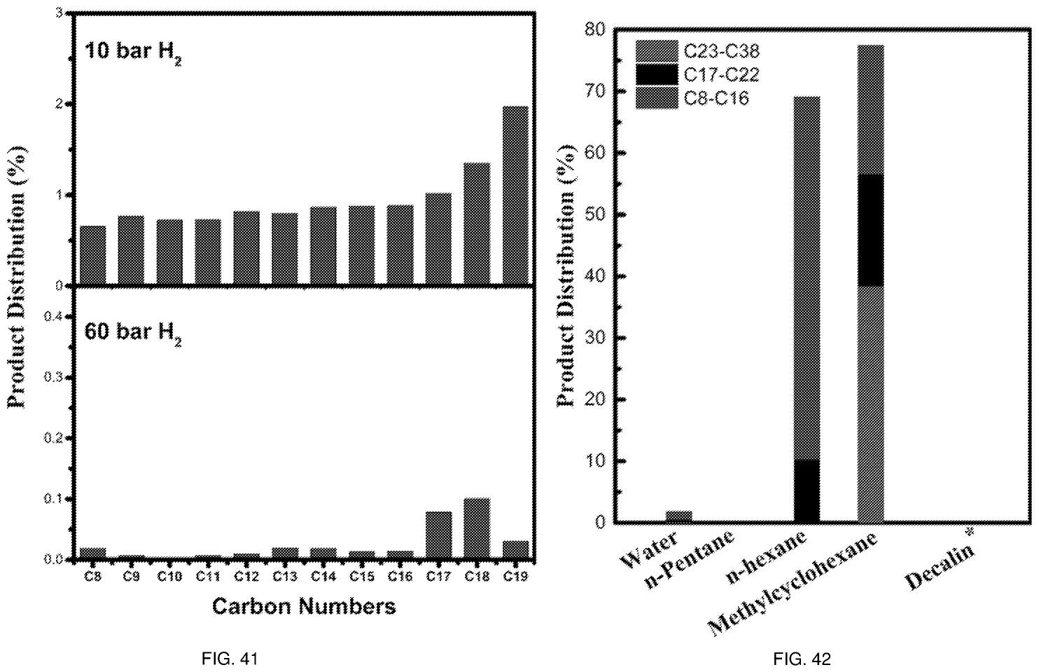

Also, the hydrogenolysis mechanism of linear liquid-phase alkanes would be analogous to the dissociation mechanism for the C—C bonds in HDPE and its degradation intermediates. Herein, the hydrogen pressure effect was further explored with eicosane, a C₂₀ linear alkane, as the probe reactant (FIG. 41). It was found that at low H₂ pressure (10 bar), the C₁₉ alkane, n-nonadecane, is the dominant product, indicating that terminal dissociation was the main pathway. With the H₂ pressure increasing to 60 bar, the main product was octadecane and heptadecane (C₁₈H₃₈ and C₁₇H₃₆), demonstrating that the primary pathway was changed to internal dissociation. Nakagawa et al. reported that with a Ru/CeO₂ catalyst and the absence of solvents, the reaction order to the H₂ partial pressure for cracking n-hexadecane (C₁₆H₃₄) was 0.4. The non-stoichiometric methane formation from n-hexadecane ([methane]-[C₁₅]=−0.8) was observed, indicating that high hydrogen pressure suppressed the excess methane formation, i.e., the cleavage of C_{secondary}-C_{primary}. The same group also observed that under higher hydrogen pressures, the yield of C₁₅ from terminal dissociation was lower than the average of the internal dissociation product yields, which is similar to the result that only a low yield of C₁₉ was obtained at 60 bar of H₂. Notably, Nakagawa et al. found no significant difference between the yields of C₂-C₁₄ hydrocarbons, while it was observed that main products, C₁₈ and C₁₇, were acquired with the presence of a solvent.

Likewise, HDPE is a linear alkane polymer containing predominantly secondary carbons and a few primary carbons; the influence of the hydrogen pressure on the hydrogenolysis of HDPE seems similar to that of eicosane. At low H₂ pressures, the liquid alkane products might mainly be generated from the terminal dissociation, which was suppressed with increasing the H₂ pressure. After the H₂ pressure passed a threshold value, the internal dissociation became dominant. At 60 bar of H₂, ˜90% of HDPE was converted to C₈₊ liquid hydrocarbon products, implying that internal dissociation is the primary depolymerization pathway at high H₂ pressures. However, both terminal and internal dissociation may co-exist in a wide range of H₂ pressures during the HDPE depolymerization.

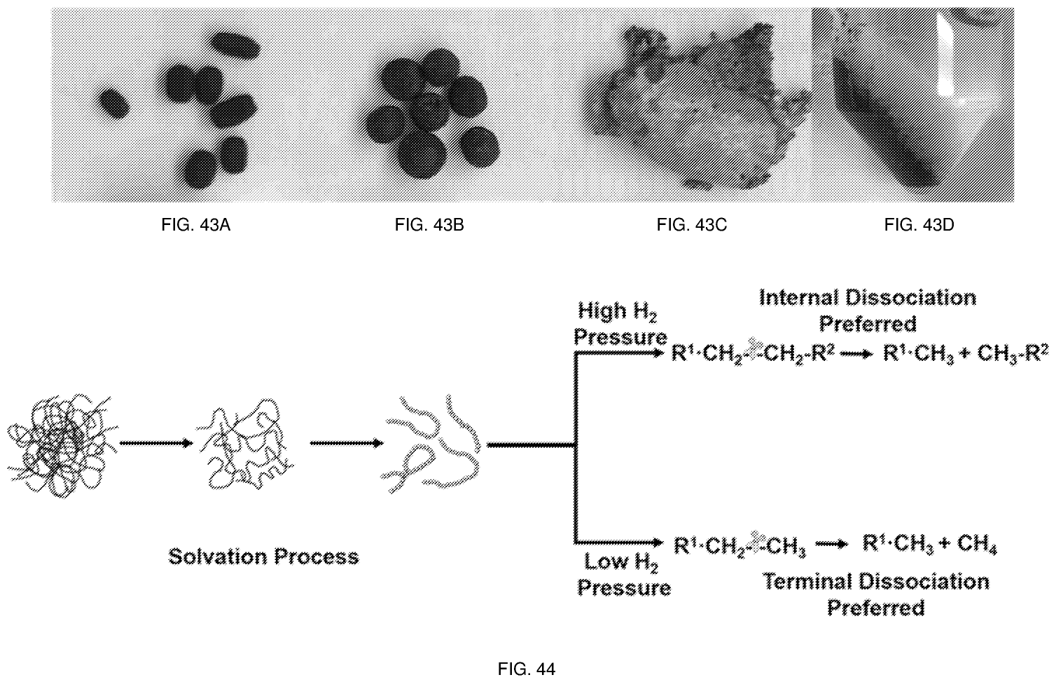

Solvent effect. Solute solubility and thermodynamic equilibrium coefficients are critical parameters that affect the reaction kinetics in solutions. Here, the role of different organic solvents in the HDPE depolymerization was investigated. In a polar solvent, e.g., water, it was found that the HDPE degradation rate was very slow at 220° C., as shown in FIG. 42. Typically, PE can be degraded in supercritical water whose dielectric constant is comparable to those of the polar organic solvents. Though the supercritical hydrolysis process requires a much high energy input, the low polarity of supercritical water facilitates polyethylene's dissolubility and thus promotes the reaction rate. However, at 220° C., subcritical water is much denser and more polar than supercritical water, leading to a low PE solubility and thus a slow depolymerization reaction rate. Meanwhile, it was observed that the HDPE strips were transformed into spherical solid particles after the reaction, which was different from those in the organic solvents (FIGS. 43A-43D). These plastic strips usually melted at over 150° C. The formation of spherical solids indicated that the plastic strips were melted but were not solvated in the water at 220° C. due to the low solubility HDPE in subcritical water. Therefore, non-polar solvents were preferred for polyethylene dissolution and depolymerization. FIG. 42 shows that n-hexane was the optimal organic solvent for the HDPE degradation with the Ru/C catalyst, while other non-polar solvents exhibited much different performance in the depolymerization reaction. Notably, no cracking products were detected in n-pentane solvent, although the polarity of n-pentane is much similar to that of n-hexane. Here, the reaction temperature (220° C.) was higher than n-pentane's critical temperature (196.45° C.), but lower than n-hexane's critical temperature (234.5° C.). Therefore, the supercritical pentane solvent behaved much differently from that at lower temperatures. HDPE polymers might not be solvated in the supercritical n-pentane, causing high mass and heat transfer resistance. It was also observed that the HDPE strips were transformed into the spherical particles in the supercritical n-pentane after the reaction, implying that HDPE were melted rather than dissolved.

The solvation effect was evaluated by using the Hansen Solubility Parameters (HSP), which is based on the theory of “Like Dissolves Like”. As shown in Tables 5 and 6, the relative energy difference (RED) of water and PE is much larger than 1, indicating that water is not a suitable solvent for PE. The RED values are less than 1 for other organic solvents that show a high affinity, consistent with the experimental results that HDPE polymer could be dissolved in these solvents. It is reasonable that polyethylene solvation in the solvents is the first step in the degradation reaction (FIG. 44). It was observed that the solvent molecular structure profoundly affects the depolymerization, as shown in FIG. 42. For instance, methylcyclohexane was not as efficient as n-hexane for depolymerization due to its obstructive cyclic molecular structure. Under identical reaction conditions, the dominant products with the n-hexane solvent are the medium-chain n-alkanes (C₈-C₁₆), while the longer-chain n-alkanes (C₁₇-C₃₈) are the main products in methylcyclohexane. Nevertheless, the appropriate inhibition effect on the PE depolymerization in methylcyclohexane was desired to control the product distribution, as the long-chain hydrocarbons (C₁₇-C₃₈) are the target products such as lubricants with a higher profit margin than the medium-chain n-alkanes (C₈-C₁₆), which are jet fuel components. A similar steric hindrance effect was also observed with decalin as the solvent, in which no cracking liquid hydrocarbon products were detected after the reaction. The solvated polymer molecules in decalin might be obstructed from being in contact with the heterogeneous Ru/C catalyst surface. Note that the molecular size of n-hexane is 1.03 nm (length)×0.49 nm(width)×0.4 nm(height), which is rather larger than methylcyclohexane (0.79 nm×0.73 nm×0.5 nm) and slightly longer than decalin (0.91 nm×0.72 nm×0.5 nm). Nevertheless, the linear molecules, e.g., n-hexane, were more flexible, compensating for their bulky molecular size. The similarity in shape between n-hexane and HDPE may facilitate the diffusion of large polyethylene oligomer molecules in the solvent, which allows the access of bulky reactant substrates to the Ru/C catalyst surface. Besides, methylcyclohexane and decalin are known as the hydrogen-donor solvents, which can transfer hydrogen even in the H₂ atmosphere. The solvent-donated H* could quickly react with the polymer radicals, terminating the consecutive cracking reactions.

TABLE 5
Hansen Solubility Parameters for Polyethylene (PE).

| | δD | δP | δH | Ro* |
|---|---|---|---|---|
| PE | 16.9 | 0.8 | 2.8 | 7.35 |

*Estimated Ro of PE at 333.15K.

TABLE 6
Hansen Solubility Parameters for various solvents.

| Solvent | δD | δP | δH | Ra | RED |
|---|---|---|---|---|---|
| n-hexane | 14.9 | 0 | 0 | 4.947727 | 0.67316 |
| methylcyclohexane | 16.0 | 0 | 1.0 | 2.668333 | 0.363038 |
| cis-Decalin | 18.8 | 0 | 0 | 4.787484 | 0.651358 |
| trans-Decalin | 18.0 | 0 | 0 | 3.649658 | 0.496552 |
| Water | 15.5 | 16.0 | 42.3 | 42.41615 | 5.770905 |

From the results of the MD simulations, PE adopts a compact conformation in pentane and hexane with the lowest radius of gyration value (R_{g}), followed by water and methylcyclohexane, and finally, it adopts an extended conformation in trans-decalin (Table 7). The extended conformation of PE in decalin can be attributed to the high degree of hydrophobicity of decalin solvent. A PE molecule is also hydrophobic in nature and thus prefers to be in hydrophobic solvents, resulting in the fully extended conformation of the PE molecule in hydrophobic solvents such as decalin.

TABLE 7
The average radius of gyration for one PE molecule in
different solvents during 500 ns NVT simulations.

| Solvent | PE Average Rg (nm) |
|---|---|
| Methylcyclohexane | 1.94 |
| n-pentane | 1.06 |
| n-hexane | 1.05 |
| Water | 1.93 |
| Transdecalin | 2.74 |

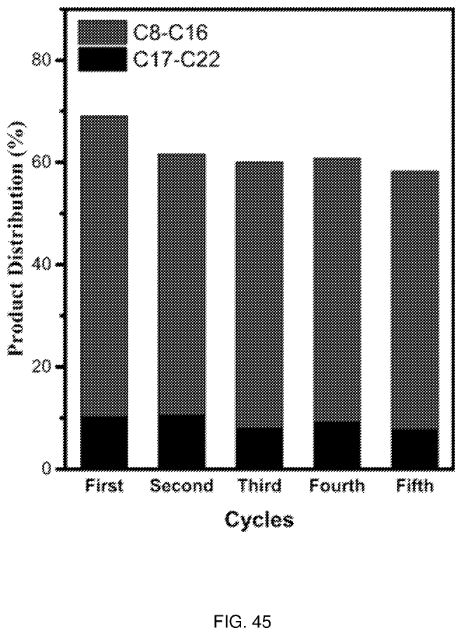

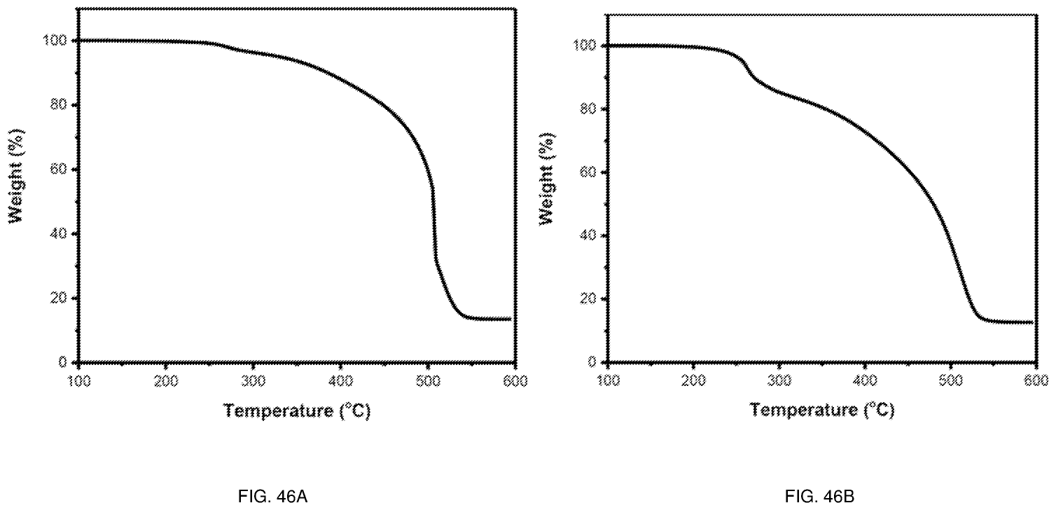

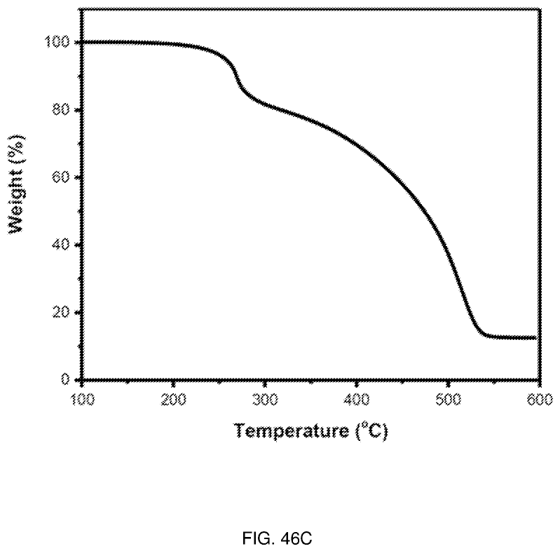

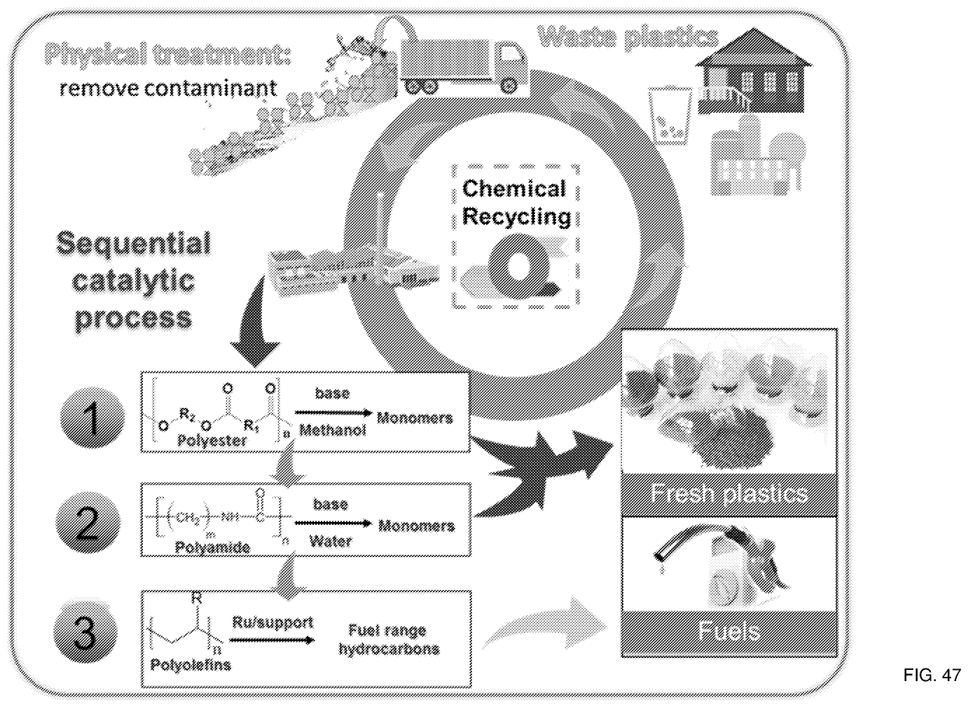

Stability. The catalyst stability is a big hurdle in plastic depolymerization via catalytic pyrolysis. In this example, the catalyst did not show severe deactivation in the n-hexane solvent after being used for five cycles (FIG. 45). The yield of jet-fuel-range alkanes (C₈-C₁₆) only decreased slightly after first use and then became stable in the subsequent runs, indicating that the catalyst stability would be reliable for the depolymerization. More short-chain hydrocarbons were observed to be generated after the first cycle, which may be ascribed to the Ru particle size increase. Nakagawa et al. found that the terminal dissociation was more prevalent if the Ru particle size is increased from <1.5 nm to >2 nm. Therefore, smaller particle size may favor the yield of jet-fuel-range products. Furthermore, the TGA curves show that the Ru loading decreased by 0.62% after the first cycle and kept almost the same after the second cycle (FIGS. 46A-46C), which is consistent with the trend of the decrease in the metallic surface area in Table 3. Both results demonstrated that Ru would not continuously leach after the first use.

Due to the high catalytic activity of Ru catalyst in cleavage of C—C bond, the solvent stability is of importance for the PE hydrogenolysis process. A blank experiment was conducted without the addition of HDPE (0.05 g Ru/C, 25 mL n-hexane, 220° C., p(H₂)=20 bar, 1h, 700 rpm). ˜5.6 wt % solvent (including 5.1 wt % loss by evaporation) was lost after the reaction, which was much lower than that in the cross alkane metathesis process for PE depolymerization (15.1 wt % loss) with light alkanes as both the solvent and feedstock, and (t-Bu₂PO-^{t-Bu}POCOP)Ir(C₂H₄)/γ-Al₂O₃ and Re₂O₇/γ-Al₂O₃ as catalysts at 175° C. in 4 days. Moreover, for process optimization, the short-chain hydrocarbon products from HDPE depolymerization could be reused as the makeup solvent in the process.

Discussion. In summary, an efficient liquid-phase hydrogenolysis process was demonstrated with the heterogeneous Ru/C catalyst for selective depolymerization of waste HDPE plastic under mild conditions. Approximately 90 wt % HDPE were converted to C₈₊ liquid hydrocarbon products in the n-hexane solvent within one hour under 30 bar H₂ at 220° C. The product distribution was able to be tuned by adjusting the process conditions, including catalyst loading, reaction temperature, hydrogen pressure, and reaction time. With high catalyst loading, high reaction temperature, or prolonged reaction time, excess cracking occurred during the reaction and led to the production of less valuable short-chain hydrocarbons. Hydrogen pressure played a significant role in the polymer dissociation pathway. Under low H₂ pressures, terminal dissociation was dominant, while internal dissociation was prevalent when the H₂ pressure increased.

Furthermore, solvents also profoundly affect the depolymerization reaction kinetics and product selectivity. The solvation ability of PE in solvents was a key factor for depolymerization. The degradation of HDPE in subcritical water was slow due to its low solubility in polar solvents. Among the non-polar hydrocarbon solvents, n-hexane, a linear alkane, was superior for HDPE depolymerization, compared with the cyclic alkanes, methylcyclohexane or decalin. The highest yield of jet-fuel-range hydrocarbons (C₈-C₁₆) reached 60.8 wt % in the n-hexane solvent at 220° C. The molecular dynamics simulations suggest that the interaction between PE polymer and solvent molecules causes the conformation of the PE polymer to change. The PE polymer with a low affinity towards solvent molecules tends to coil and then sieve through solvent molecules and get to the catalyst surface, where it will get cracked. PE adopts a compact coil conformation in pentane and hexane, followed by water, methylcyclohexane, and decalin. Although the steric hindrance from the solvents' cyclic molecular structure inhibited PE depolymerization, it promotes the production of long-chain hydrocarbons, such as lubricants.

### Example 4. Chemical Sorting of Waste Plastics Via Sequential Process

Summary Due to a loss in material properties during the recycling process, mechanical recycling, the most common recycling method, is inferior to chemical recycling. According to the recycling codes, the structure difference of plastics is the polymerization bonds, namely mainly ester bonds, amide bonds and carbon-carbon bonds. According to the results from previous findings on PET, Nylon 6 and HDPE deconstruction, a novel, highly efficient monomers and fuels production process is reported by sequentially cleaving the polar functional groups of the polyesters and polyamides and the non-polar C—C bonds of the polyolefins with different solvents and catalyst at different reaction temperatures to obtain the polyester monomers, polyamide monomers and low molecular weight hydrocarbons. The homogeneous catalyst can be recycled with the methanol or water solvent while leaving the solid residues for the next reaction step. After the exhaustion of the solid residues in the final step, the solid catalyst used in this step can be recycled. The monomers can undergo polymerization again to obtain fresh polyesters or polyamides with good material properties for everyday life. The low molecular weight hydrocarbons from polyolefins can be used as liquefied gas fuels, liquid transportation fuels or lubricants. A projected net present value (NPV) is positive, indicating that the sequential catalytic process for the co-mingled waste plastics conversion to monomers and fuels will make the plant profitable. These findings can address the large waste-disposal problems presented by currently used commingle plastics and multilayer packaging materials through the sequential chemical catalytic process.

Introduction. In 2019, the global production of plastics totaled nearly 368 million metric tons. Since 1950, there have been 8.3 billion tons of plastics produced worldwide, of which 50% of all plastic has sat in landfills or dumped in the natural environment and only 9 percent is adequately recycled. A large number of plastic garbage is directly discarded without treatment, which will not only cause serious environmental pollution, but also form countless microplastic particles under the action of external forces in nature. Because it is difficult to deconstruct these particles, they will remain in the food chain for a long time in this form, and eventually enter human bodies through drinking water and food, directly harming human health. With the increasingly serious plastic pollution, recycling is the best solution to plastic pollution so that many countries around the world have taken action.

Plastic is a general term for a large class of polymers, while many plastics are only used in a single plastic product. Recycling all single-type plastics is difficult because one of the biggest bottlenecks during plastic recycling is that each plastic has to be separated first before processing. If different types of plastics are treated together during the processing process, the performance of the resulting product will be affected. Therefore, it is very important to sort waste plastics effectively before recycling.

The ASTM international resin identification coding (RIC) system, namely plastic code, is a classification code developed by the American Plastics Industry Association in 1988. Before recycling and upcycling, most waste plastics are sorted according to their resin type in the co-mingled mixtures. Direct sorting, such as magnetic density separation, flotation separation, etc., and indirect sorting, including X-ray fluorescence (XRF), near-infrared spectroscopy (NIR), etc. are widely used for physical sorting multiple types of waste plastics simultaneously. However, due to a loss in material properties during the physical recycling process, mechanical recycling, the most common recycling method, is inferior to chemical recycling. Thus it is desirable to use chemical recycling to produce virgin plastics from waste plastics via their monomers.

However, the selective recycling of waste plastics containing different components was proved to be challenging in the waste plastic recycling and upcycling sectors and needs to be developed co-mingle waste plastics. Sequential polyester chemical recycling based on the energetic differences for the glycolysis of PC and PET was demonstrated in the presence of a protic ionic salt TBD:MSA catalyst. However, the current scope only for the selective deconstruction of polyester is not large enough to cover the most used plastics. According to the recycling codes, the structure difference of plastics is the polymerization bonds, namely mainly ester bonds (RIC 1, PET), amide bonds (RIC 7), and carbon-carbon bonds (RIC 2-6, HDPE, PVC, LDPE, PP, PS). Polyester mainly refers to poly (ethylene terephthalate) (PET), customarily also includes poly (butyl terephthalate) (PBT) and poly (aryl ester) and other linear thermoplastic resin. The corresponding monomers or chemical raw materials can be successfully obtained through chemical recycling, and at the same time, they can be used to produce better quality plastics or other advanced materials. Polyolefins mainly comprise polypropylene (PP), polyethylene (PE) which constitute more than 60% of the total plastic solid waste. Nylon 6 is a typical polyamide. Thus it is urgent to find an efficient route to convert the co-mingled waste plastics (polyesters, polyamides, polyolefins, etc.) to monomers and fuels in a sequential catalytic process through the selective C—O, C—N, and C—C cleavage. For the polyesters and polyamides, breaking down the plastic streams into their monomers is cost-effective while the polyolefins are suitable feedstock for the fuels since it is hard to selectively crack the polyolefins to olefins.

Besides commingled plastics, the multilayered packaging material is a type of packaging that is very hard to recycle/reuse effectively. This occurs because multilayered plastics have several thin sheets of materials (including aluminum, plastics, and paper) that are laminated together and are difficult to separate. Over 45% of plastic waste generated in 2015 was from packaging materials which consist of multilayered materials. The most common polymers utilized in the flexible packaging industry are PE, PP, polyamide (Nylon, PA), ionomers (EAA, EMAA), ethylene vinyl acetate (EVA), PET, etc. Among these layers, PE, especially LDPE, is the largest and cheapest packaging film. Most of these multilayer films are also constructed based on the ester bonds, amide bonds, and carbon-carbon bonds. A series of liquid solvents were also screened out to selectively dissolve individual plastic components off multilayer packaging materials that contained PE and PET, as well as a plastic oxygen barrier made of ethylene vinyl alcohol, or EVOH, that keeps food fresh. As discussed previously, chemical recycling/upcycling of the multilayer packaging materials has not been reported.

A tertiary amine catalyst was previously demonstrated to readily depolymerize the post-consumer PET bottles and textiles or Nylon 6 into their monomers, dimethyl terephthalate (DMT) and ethylene glycol (EG) or caprolactam, in methanol/water solvent under mild conditions. In another previous study, HDPE can be efficiently converted to jet-fuel-range and lubricant hydrocarbons in various liquid-phase solvents with the Ru/C catalyst under relatively mild conditions. The product distribution could be tuned by the H₂ partial pressure, the active metal particle size, and the solvents. According to the results from PET, Nylon 6 and HDPE deconstruction, a novel, highly efficient monomers and fuels production process was developed by sequentially cleaving the polar functional groups of the PET and Nylon 6 and the non-polar C—C bonds of the PE with different solvents and catalyst at different reaction temperatures to obtain the polyester monomers, polyamide monomers and low molecular weight hydrocarbons. The homogeneous catalyst can be recycled with the methanol or water solvent while leaving the solid residues for the next reaction step. After the exhaustion of the solid residues in the final step, the solid catalyst used in this step can be recycled. The monomers can undergo polymerization again to obtain fresh polyesters or polyamides with good material properties for everyday life. The low molecular weight hydrocarbons from polyolefins can be used as liquefied gas fuels and liquid transportation fuels. These findings can address the large waste-disposal problems presented by currently used commingled waste plastics or multilayer packaging materials through the sequential chemically catalytic process.

Materials and Methods.

Materials. The post-consumer polyethylene terephthalate (PET) was the empty Kirkland Signature Purified Drinking Water bottle (not including the cap). Nylon 6 pellets and polyethylene (PE, average Mw ˜4,000 by GPC, average Mn ˜1,700 by GPC) were purchased from Sigma-Aldrich. The multilayer packaging materials, including PET/Nylon 6/PE film for beer/milk package, PET/PE or Nylon 6/PE film for vacuum seal storage, and Nylon 6/PE film for food bag were purchased from Walmart.com, free of contamination and used in the form of cut films.

N-methylpiperidine (NMP) (99%), chloroform-d (99.8 atom % D, contains 0.03% (v/v) TMS), dimethyl terephthalate (≥99%), ethylene glycol (99.8%), Ru/C (5% Ru basis), and ε-caprolactam (99%) were provided by Sigma-Aldrich. Triethylamine (TEA, 99%), p-xylene (99%), and 1,1,1,3,3,3-Hexafluoro-2-propanol (99%) were purchased from Alfa Aesar. Nitrogen and hydrogen were obtained from A-L Compressed Gases, Inc. n-Hexane (95%) was purchased from J. T. Baker. Methanol (≥99.8%) was supplied by EMD Millipore. DI water with a specific resistance of 18.2 MΩ cm was prepared through an ultrapure water system (ELGA PURELAB FLEX) and used as the solvent. All chemicals were acquired in their pure form and utilized without any prior treatment.

Sequential process. All the reactions were carried out on a Series 5000 Multiple Reactor System with six 45 mL reactors and individual temperature control. The physical plastics mixture consisted of PET cut sheet, Nylon 6 pellets and PE powder. They were weighed respectively according to the designated amount. The multilayer packaging materials were cut into pieces before use. Typically, the physical plastics mixture or multilayer packaging films were added into the vessel with the stirring bars.

In the methanolysis step (1 st step) for PET deconstruction, 20 mL of 0.2 M NMP methanol was withdrawn into the vessels. The vessels were sealed and purged three times with 400 psi N₂ and three times with 400 psi H₂. Then all the gas in the reactors was released to keep at atmospheric pressure at room temperature. The stirring speed of the stirring bar is kept at 700 rpm. The reaction temperature was soared to the set value in 30 mins and kept for the set reaction duration.

After the methanolysis step, the solids were collected, washed with methanols and dried at 60° C. in the vessel overnight with the stirrer bar. In the hydrolysis step (2 nd step), 20 mL water and 5 mL TEA were added to the vessels. The vessels were sealed and purged three times with 400 psi N₂. Then all the gas in the reactors was released to keep at atmospheric pressure at room temperature. The stirring speed of the stirring bar is kept at 700 rpm. The reaction temperature was soared to the set value in 30 mins and kept for the set reaction duration.

After the hydrolysis step, the solids were collected, washed with water and dried at 80° C. overnight. In the hydrogenolysis step (3 nd step), the solid residue, 20 mL n-hexane and 0.05 g Ru/C were added to the vessels with the stirrer bar. The vessels were sealed and purged three times with 400 psi N₂ and three times with 400 psi H₂. Then all the reactors were pressurized with H₂ to 30 bar at room temperature. The stirring speed of the stirring bar is kept at 700 rpm. The reaction temperature was soared to the set value in 30 mins and kept for the set reaction duration.

PET/PE film for vacuum seal storage lacks Nylon 6 component so that the hydrolysis step was omitted. Nylon 6/PE film for vacuum seal storage and Nylon 6/PE film for food bag lack PET component so that the methanolysis step was omitted.

Characterizations. X-ray powder diffraction (XRD) patterns of the fresh samples and solid residues after reaction were obtained on a Rigaku SmartLab X-ray equipped with a DTex high-speed detector that allows for a higher signal-to-noise ratio at high scan rates. The measurements were conducted as follows: scanning between 10° and 90° (20) at a step of 0.01° and a scanning speed of 5° min⁻¹. The samples were loaded on glass specimen holders with a recess for powder. A scan was then collected at ambient temperature.

After the reaction, PET and Nylon 6 residues in the solids were elucidated using NMR analysis. 1 mL of 1,1,1,3,3,3-hexafluoro-2-propanol was used to dissolve the PET and Nylon 6 components in solid residues in a 2 mL glass vial. Then 1 mL of chloroform-d (99.8 atom % D, contains 0.03% (v/v) TMS) was added and mixed well with the 1,1,1,3,3,3-hexafluoro-2-propanol solution. The colorless and transparent supernatant was transferred into an NMR tube for NMR analysis. The 1H NMR spectra were obtained on a 500 MHz NMR spectrometer (Varian VNMRS Level 500 MHz Spectrometer). All NMR samples were measured at 298 K.

Analysis. Quantitative analysis of PET component and Nylon 6 component in multilayer packaging materials was performed on Varian VNMRS Level 500 MHz Spectrometer and calculated according to the external standard of ¹H-NMR spectroscopy. The preparation of samples followed the above-mentioned procedures.

After the methanolysis step, the solid residues were separated from the liquid by centrifugation in an Eppendorf 5810 R Centrifuge. The dimethyl terephthalate (D) content of the liquid phase was analyzed by a GCMS QP-2020 (Shimadzu) with an SH-Rxi-5SIL MS column. The ethylene glycol (E) content of the liquid phase was analyzed by GC-FID (GC-2010, Shimadzu) with a CP7447 column. The yields of DMT and EG were calculated by the following equations.

$$D = \frac{{n}_{1}}{{n}_{0}} \times 100 \% \qquad ( 1 )$$

$$E = \frac{{n}_{2}}{{n}_{0}} \times 100 \% \qquad ( 2 )$$

where nₒ is the moles of the repeating unit of fresh PET reactants before reaction, n, is the moles of DMT after the reaction, and n₂ is the moles of EG after the reaction.

After the hydrolysis step, the liquid phase was filtered through a 0.45-μm filter before analysis. The ε-caprolactam content of the liquid phase was analyzed by GC-FID (GC-2010, Shimadzu) with a CP7447 column. The yield of ε-caprolactam was calculated by the following equation,

$$C = \frac{{n}_{3}}{{n}_{0}} \times 100 \% \qquad ( 3 )$$

where nₒ is the moles of repeating unit of Nylon 6 before reaction, n₃ is the moles of ε-caprolactam.

After the hydrogenolysis step, the internal standard, p-xylene, was added into the vessel and mixed well with liquid phase. Then the liquid phase was filtered through a 0.45-μm filter before analysis. QP-2020 (Shimadzu) gas chromatograph-mass spectrometer equipped with a Shimadzu SH-Rxi-5SIL MS column (30 m×0.25 mm i.d., 0.25 μm film thickness), a flame ionization detector, and a high-performance ion source was used to identify and quantify the unknown products. The yield of hydrocarbons was calculated by the following equation,

$$y = \frac{{m}_{1}}{{m}_{0}} \times 100 \% \qquad ( 4 )$$

where mₒ is the weight of the PE feedstock before reaction, m₁ is the weight of the alkane hydrocarbons after the reaction.

Results and Discussion: Sequential Process for Comingled Waste Plastics.

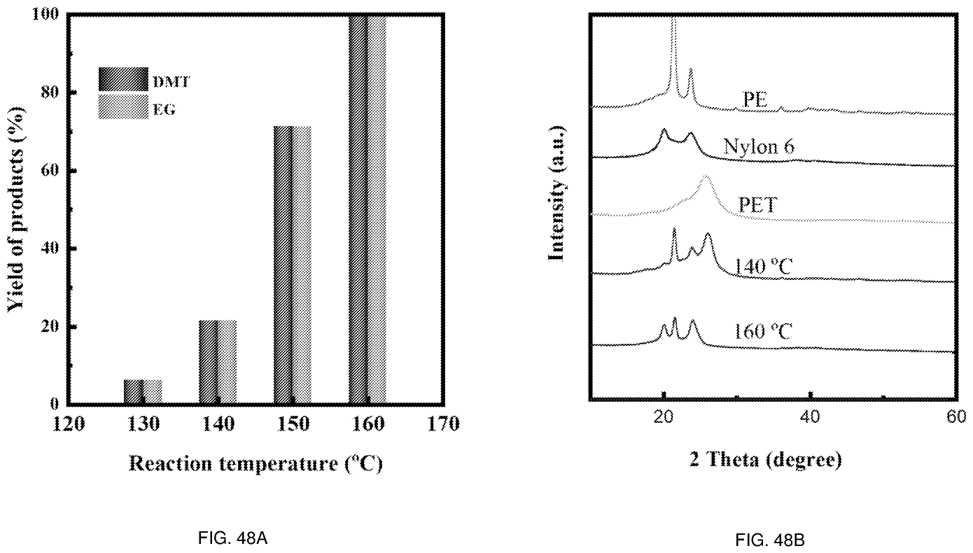

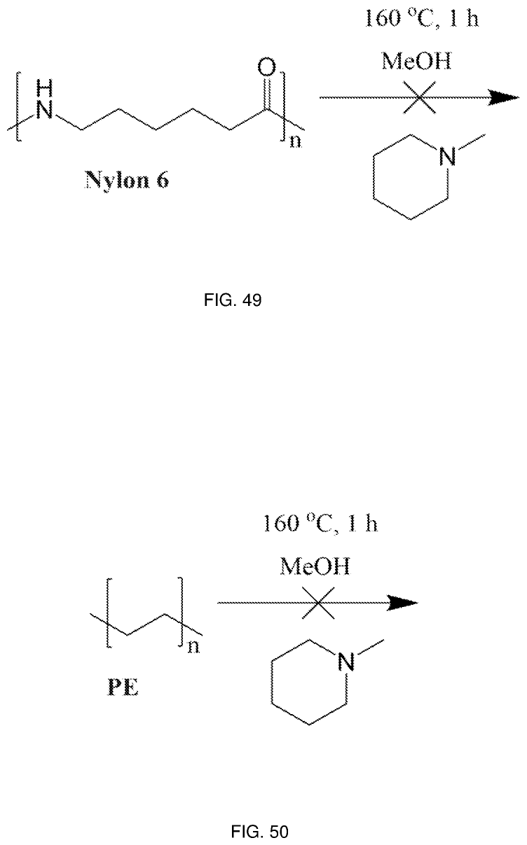

Methanolysis of PET in the first step. Previous studies have demonstrated that PET depolymerization to DME and EG can be completed in 20 mL of 0.2 M NMP methanol solution at 160° C. within 1 h. Thus the selective methanolysis of PET from PET/Nylon 6/PE mixture in the first step using N-methylpiperidine (NMP) as a catalyst was carried out under the same reaction conditions. Maximum yields of ˜100% for DMT and 100% for EG are obtained from the deconstruction of PET (FIG. 48), without any degradation products from Nylon 6 and PE (FIGS. 49 and 50). Decreasing the reaction temperature to 130° C. resulted in a sharp decline in the yields of both DMT, and the overall efficiency of the PET deconstruction declined. It can be seen in FIG. 48B that the methanolysis of PET in the PET, Nylon 6 and PE mixture can be monitored by XRD. The peak at 25.5° that is assigned to PET indicated the PET depolymerization could not complete at 140° C. By contrast, the complete methanolysis of PET at 160° C. can be verified as the PET peak disappeared, leaving the peaks assigned to Nylon 6 and PE. The complete methanolysis of PET to DME and EG and the intact state of Nylon 6 and PE suggested that the first step of the sequential chemically catalytic process was successful for the selective deconstruction of polyesters.

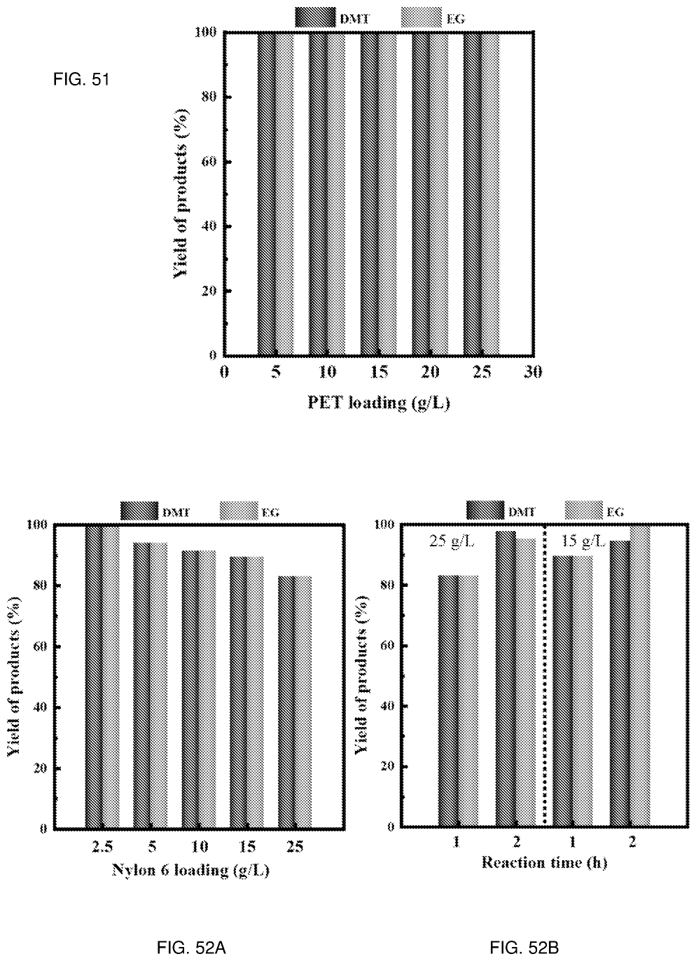

One of the main obstacles to increasing the percentage of recycled plastics is how to control the flexibility of the feedstock with a high deconstruction rate and yields of the products in each step. Thus the ratios of each individual plastic component were adjusted factitiously. It can be seen in FIG. 51 that when the PET loading was increased from 5 g/L to 25 g/L, the methanolysis of PET can still be completed at 160° C. after 1 h reaction in the study, meaning that the NMP catalyzed methanolysis of PET can be scaled up with a high PET ratio. Excess NMP and methanol can diffuse and permeate into PET fibers easily so that the methanolysis of PET fibers occurs with higher PET loading.

However, when the Nylon 6 loading was increased from 2.5 g/L to 25 g/L, only about 83% DMT and EG yields were obtained (FIG. 52A). On the one hand, the permeation damage of the Nylon 6 structure caused the swelling of it, generating a lot of powders from the crystalline Nylon 6. On the other hand, there is strong intermolecular hydrogen bonding between the amide bonds and the amines. More amide bonds can be exposed after the swelling of Nylon 6, which will attract more amine molecules in the methanol. As a result, the selective methanolysis rate of PET from PET/Nylon 6/PE mixture was diminished with higher Nylon 6 loading. It is not surprising that a longer reaction time was needed to obtain higher DMT and EG yields (FIG. 52B).

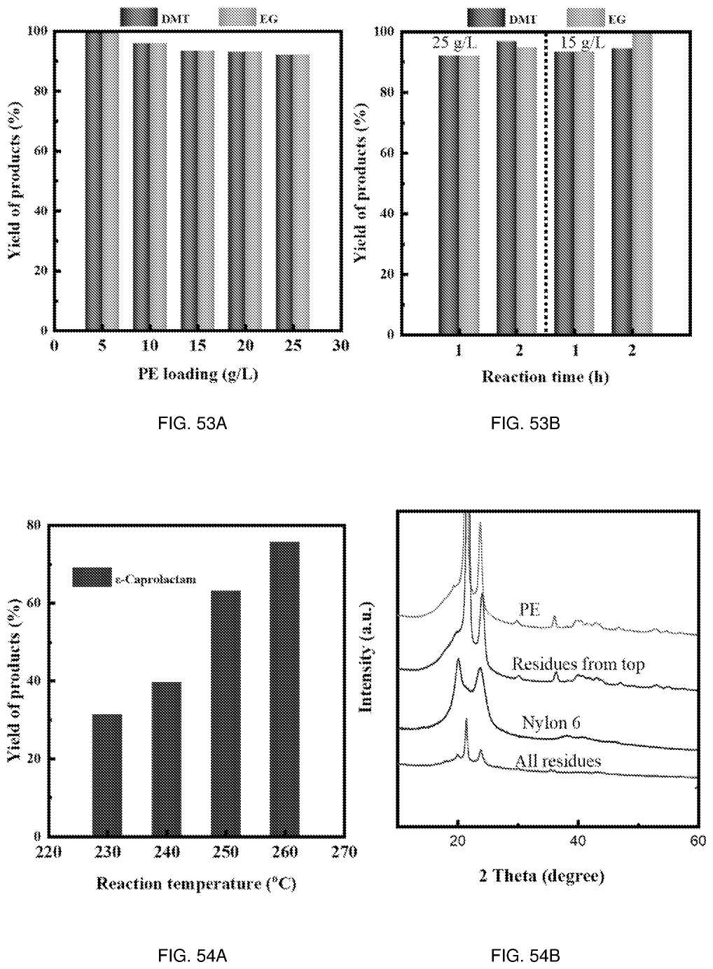

By contrast, when the PE loading was increased from 5 g/L to 25 g/L, about 92.1% DMT and EG yields were obtained, which are higher than those with 25 g/L of Nylon 6 (FIG. 53A). Nylon 6 and PET have good compatibility; thus, it affects the methanolysis of PET significantly. However, there is poor compatibilization efficiency between PE and PET without a compatibilization agent, suggesting that the presence of PE will not affect the activity of NMP in methanol. Higher PE loading resulted in the lower yields of DMT and EG due to the low boiling point of PE (92° C.). Under the methanolysis condition (160° C.), more molten PE was present in the reactor, meaning that there was resistance against pure PET mass transfer. Similarly, further prolonging the reaction time was needed to obtain higher DMT and EG yields with higher PE loadings (FIG. 53B).

Hydrolysis of Nylon 6 in the second step. The depolymerization of Nylon 6 was explored by screening the reaction media in step 2 for the hydrolysis of Nylon 6 in the solid residues from step 1, as shown in Table 8. As discussed previously, the combination of water and the optimized catalyst, triethylamine (TEA) can generate a Brønsted base, which can catalyze the hydrolysis of the amide bonds of Nylon 6. When the TEA was used as the catalyst, and the solvent or methanol was used as the solvent, the caprolactam yields were much lower than that in the presence of water at the same temperature (i.e., 230° C.), meaning that the Brønsted base has high catalytic capacity on the cleavage of amide bonds than the Lewis base. As a result, the solvent in the second step has to be changed to water even though the same solvent for different steps may simplify the process and reduce the operating cost.

TABLE 8
Reaction media selection for the deconstruction of Nylon 6.

| T/º C. | | Yield of caprolactam/% |
|---|---|---|
| Water^{a} | 230 | 31.35 |
| | 250 | 63.21 |
| TEA^{b} | 230 | 2.14 |
| | 250 | 12.22 |
| Methanol^{c} | 210 | 0.53 |
| | 230 | 5.78 |

Reaction conditions:
^{a}20 mL H₂O, 5 mL TEA,
^{b}20 mL TEA,
^{c}20 mL methanol, 5 mL TEA; 6 h, 700 rpm

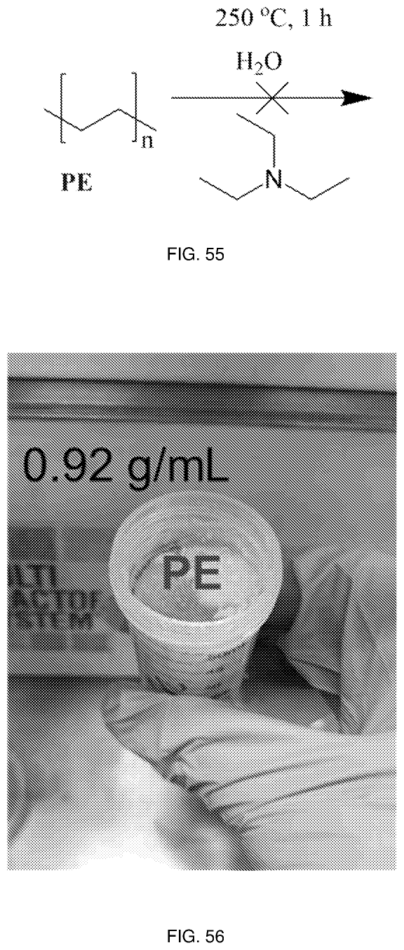

Temperature and reaction time play pivotal roles in determining the hydrolysis rate of Nylon 6. Increasing the reaction temperature for the hydrolysis of Nylon 6 in the solid residues after the methanolysis of PET in the first step resulted in a remarkable improvement in the yields of caprolactam, as shown in FIG. 54A. The hydrolysis of Nylon 6 at 260° C. within 6 h yielded about 76% caprolactam in the presence of PE, without any degradation products from PE (FIG. 55). However, the reaction temperature cannot be soared up because the critical point of TEA is 262° C. Similarly, the hydrolysis of Nylon 6 in the Nylon 6 and PE mixture can also be monitored by XRD, as shown in FIG. 54B. The characteristic peaks at 2θ=20.1° and 23.8° were assigned to α crystalline form of Nylon 6 and were indexed as (200) and (002/202) reflections of the room-temperature monoclinic structure, respectively. Even though there were some Nylon 6 solid residues after the hydrolysis reaction, pure PE can be still obtained due to the density difference of Nylon 6 and PE (Nylon 6, 1.084 g/mL at 25° C.; PE, 0.92 g/mL at 25° C.), as shown in FIG. 56. The XRD patterns of the top residues showed that only the PE characteristic peaks appeared, whereas there were Nylon 6 peaks at 26=20.1° and 23.8° if all the residues, including the Nylon 6 residue at the bottom, were collected. Therefore, under the incomplete conversion of Nylon 6, collection of the top solid residues, mainly PE can reduce the risk in the last step.

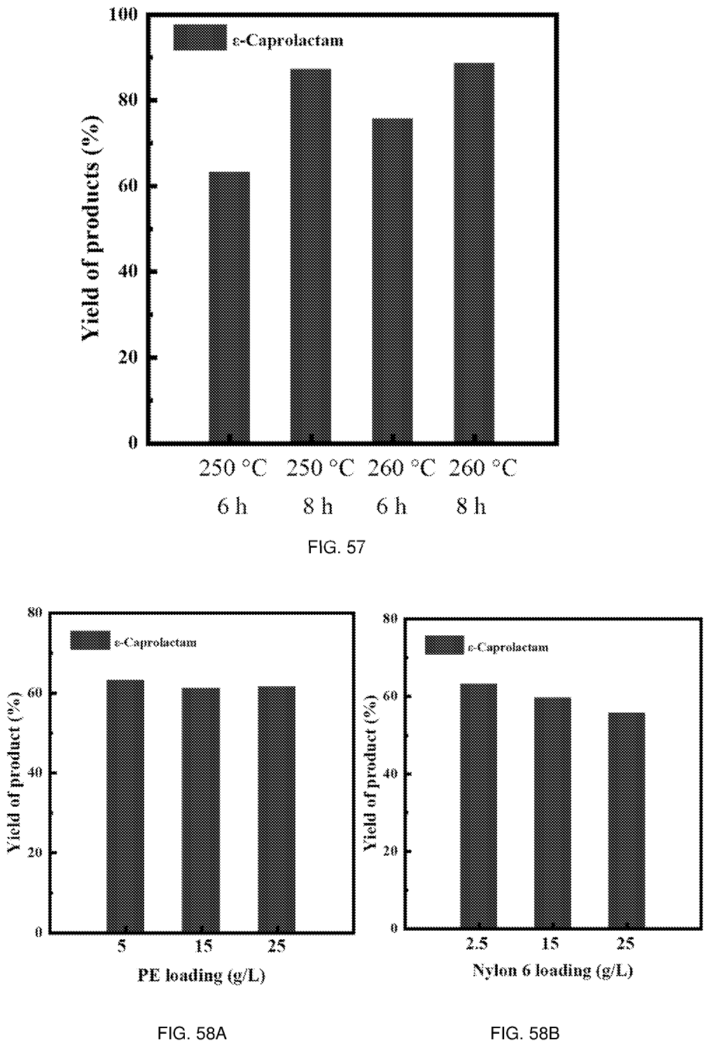

The hydrolysis of Nylon 6 can be completed at 250° C. after 6 h reaction in the previous study. However, when the reaction time was extended to 8 h, only about 87% caprolactam was obtained in the presence of PE, as shown in FIG. 57. Similarly, the hydrolysis 260° C. for 8 h only yielded 89% caprolactam. Taking the reaction temperature and reaction time into account, elevated reaction temperature and longer reaction were critical for the second step of the sequential process.

Similarly, the feedstock flexibility was also investigated in the second step. As can be seen in FIG. 58A, when the Nylon 6 loading increased from 2.5 g/L to 25 g/L, the yield of caprolactam declined from 63% to 55% due to more substrate with a limited Brønsted base. By contrast, when the PE loading increased from 5 g/L to 25 g/L, a slight decrease in the caprolactam yield was observed, meaning that the presence of PE wound not affect the mass transfer for Nylon 6 (FIG. 58B). Even though PE can be melted at 250° C., the lower-density PE can float on the water surface rather than settle to the bottom. Thus, the stirring of the hydrolysis of Nylon 6 with a higher density than water cannot be affected by PE.

Hydrocracking of PE in the third step. Ru/C induced hydrocracking has been successfully implemented to effectively convert biomass such as lysine and chitin to value-added chemicals, as well as to selectively convert HDPE to alkanes, the fuels/lubricants components. In this example, the research is extended to the hydrocracking of PE components after the first and second steps as a generic catalytic process for the production of fuels lubricants from an artificial commingled plastics waste, e.g., PET/Nylon 6/PE mixture.

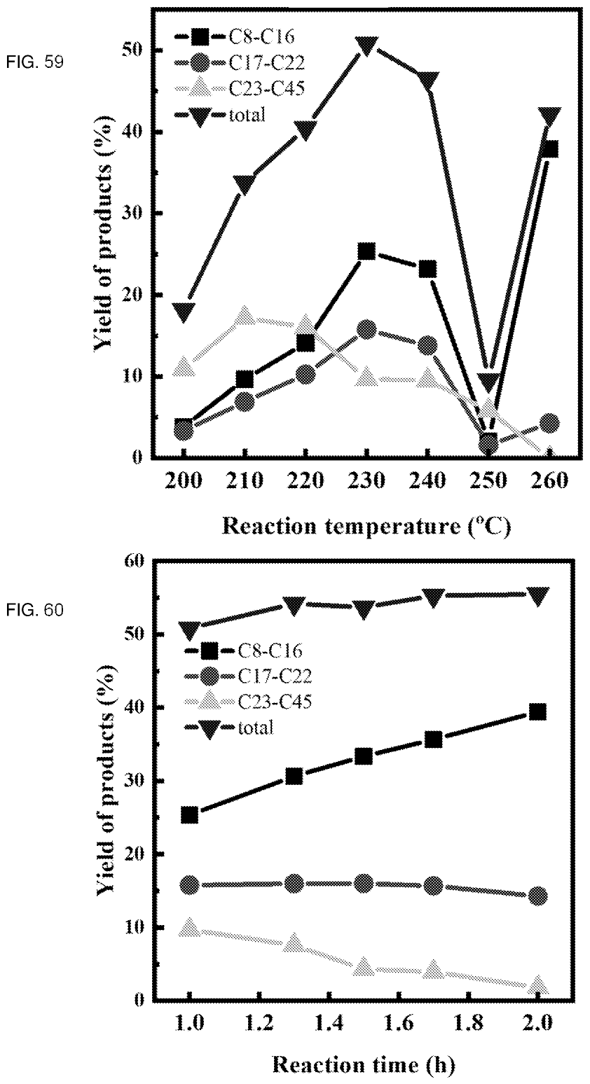

After the solvation of HDPE in n-hexane, the random scission dominated. Due to fewer HDPE molecules present in the solvent, 75% jet fuel-and diesel-ranged alkanes were obtained at 220° C. in just 1 h. It was also observed that Ru/C was also effective for hydrocracking of low-molecular-weight PE due to its high catalytic activity on breaking the carbon chain, and thus a variety of alkanes with 40% total yield were obtained, as shown in FIG. 59. Increasing temperature resulted in the remarkable improvement in the yields of jet fuel-range and diesel-range hydrocarbons. The yield of the jet-fuel-range alkanes (C8-C16) reached 25 wt %, and the yield of the diesel-range hydrocarbons (C17-C22) was ˜16 wt % at 230° C. The yield of C23-C45 products reached a maximum at 210° C. and these products underwent further hydrocracking to form jet-fuel-range and diesel-range hydrocarbons with augmenting the temperature. However, the yields of all the liquid products declined at 240˜250° C. due to the supercritical condition of n-hexane. Surprisingly, the products at 260° C. were mainly jet fuel range hydrocarbons with 38% yield and diesel fuel range hydrocarbons (carbon number ≤20) due to restoring the activity of Ru/C.

There were C23-C45 products at 230° C. so that the time course of the production distribution of the pure PE depolymerization was investigated, as shown in FIG. 60. The yields of jet-fuel range hydrocarbons increased with prolonging the reaction time to 2 h, while the C23-C45 products decreased, meaning that the hydrocracking rate of low-molecular-weight PE was much slower than that of HDPE due to more hydrocarbon molecules in the system. There was no obvious change for the yield of the diesel range hydrocarbons and the total yields, suggesting that after 1 h, the hydrocracking occurred in the C8-C45 products.

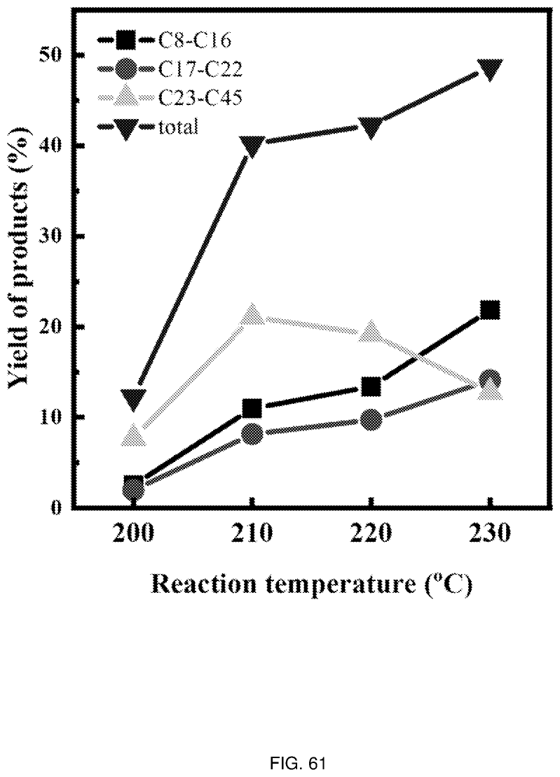

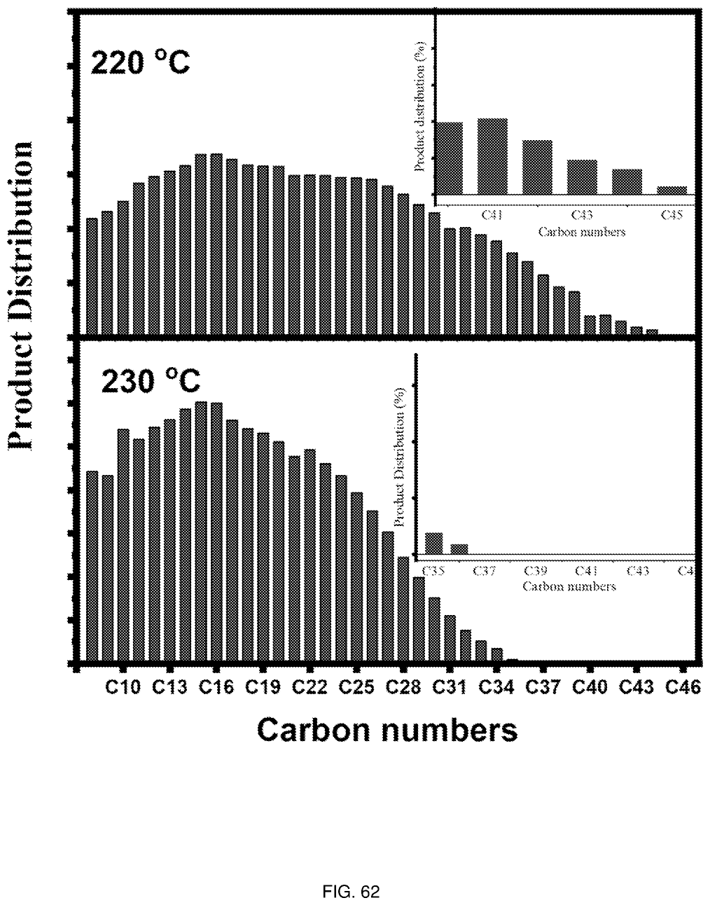

The new findings on the pure low-molecular-weight PE depolymerization can guide the processing of the PE residue from the second step. As expected in FIG. 61, reaction temperature is still a critical parameter for determining the product distribution from the PE residues degradation. Total yields of the liquid products (49%) at 230° C. with 22% jet-fuel-range alkanes (C8-C16) were similar to those (50%) from pure PE degradation with 25% jet-fuel-range alkanes (C8-C16). There were still jet-fuel-range alkanes (C8-C16), diesel-range hydrocarbons (C17-C22) and lubricant-range hydrocarbons (C24-C35) and C36-C45 products at 220° C., as shown in FIG. 62. The liquid products were narrowed down to C8-C36 hydrocarbons, with jet-fuel-range alkanes (C8-C16) and diesel-range hydrocarbons (C17-C22) being the main products.

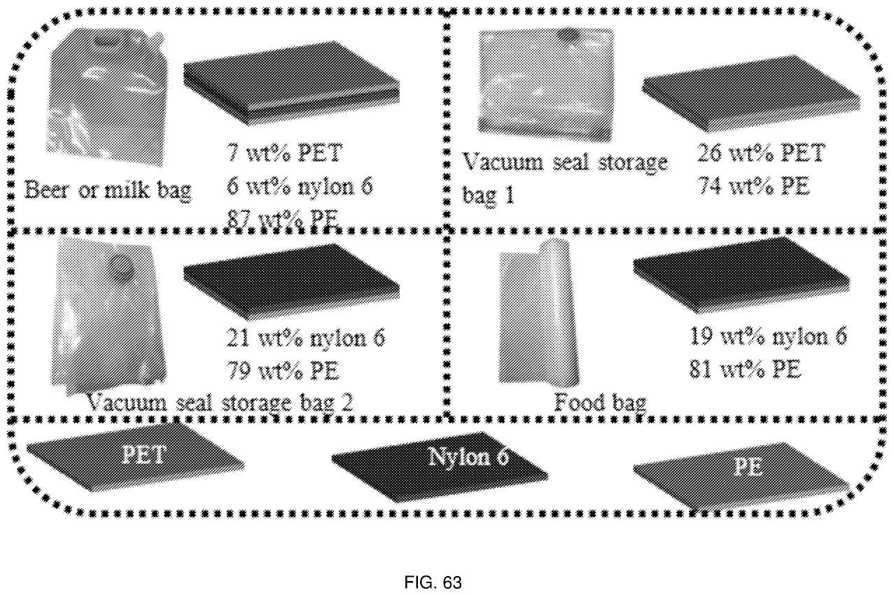

Sequential process for multilayer packaging materials. Multilayer packaging materials used in this study and the content of each based on the NMR determination were shown in FIG. 63. Two-layer plastics were used, namely vacuum seal storage bag consisting of 26 wt % PET and 74 wt % PE, and three-layer plastics, namely beer packaging bag consisting of 7 wt % PET, 6% Nylon 6, and 87 wt % PE as the real feedstock for the methanolysis of PET from multilayer packaging materials.

Other two-layer plastics, namely vacuum seal storage bag consisting of 21 wt % Nylon 6 and 79 wt % PE, and food bag consisting of 19% Nylon 6, and 81 wt % PE, together with the solid residues from the methanolysis of beer packaging bag were used as the real feedstock for the hydrolysis of Nylon 6 from multilayer packaging materials.

After the methanolysis and/or hydrolysis step, the solid residues mainly consisting of PE were used as the real feedstock for the hydrocracking to produce jet-fuel-range alkanes (C8-C16), diesel-range hydrocarbons (C17-C22) and lubricant-range hydrocarbons (C24-C35) from multilayer packaging materials.

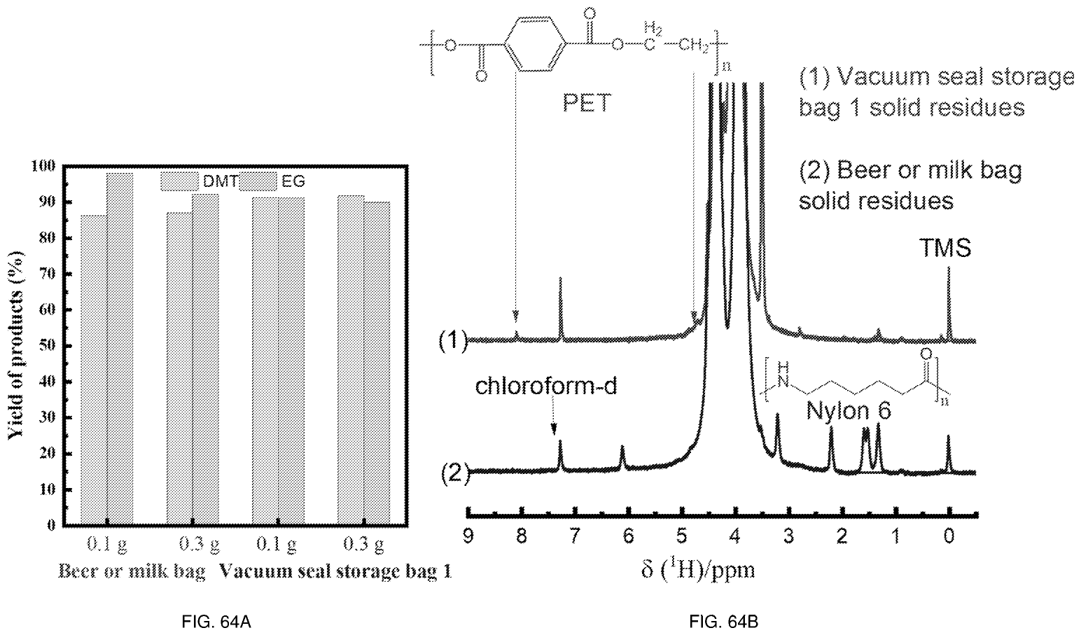

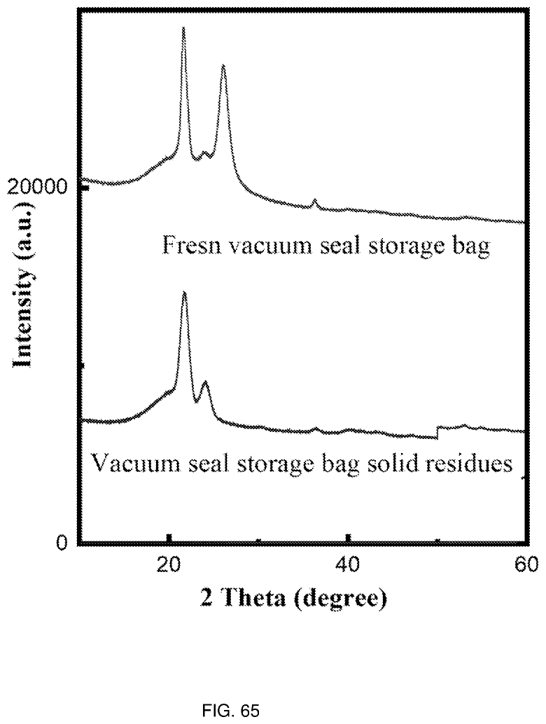

Methanolysis of PET from multilayer packaging materials. PET films are often used as gas/aroma barrier, moisture barrier, or to provide mechanical strength, and heat resistance in packaging materials. They are outside layers so that the methanolysis of PET in multilayer packaging materials can be conducted easily in the first step. When 20 mL 0.2 M N-methylpiperidine methanol solution was used to depolymerize PET in 0.1 g multilayer packaging materials at 160° C. for 1 h, 86% DMT and 98% EG were obtained from beer or milk bag (PET/Nylon 6/PE film), and 91% DMT and 91% EG were obtained from vacuum seal storage bag 1 (PET/PE film), as shown in FIG. 64A. As discussed previously, the higher PE ratio has a negative effect on the PET degradation so that the DMT and EG yields cannot reach 100%. It is worth mentioning that increasing the film loading to 0.3 g did not have a significant impact on the yields of DMT and EG. A previous paper demonstrated that XRD patterns of the solid residues could be used to monitor the structure change of the plastics. FIG. 65 shows that there is no crystalline change for the PE residues. ¹H NMR spectra of the solid residues after the methanolysis of beer or milk bag and vacuum seal storage bag demonstrated the highly efficient first step depolymerization, as a trace amount of PET retained in the vacuum seal storage bag and no detectable PET from beer or milk bag (FIG. 64B). By contrast, the Nylon 6 component will not form any impurities to contaminate the DMT and EG products because the Nylon 6 only leaves the reactor as a solid.

Hydrolysis of Nylon 6 from multilayer packaging materials. After the methanolysis of the PET layer in the beer or milk bag (PET/Nylon 6/PE film), the solid residue was subjected to hydrolysis to remove the Nylon 6 layer. Food bag or vacuum seal storage bag 2 consisting of Nylon 6/PE films were also treated in the same way.

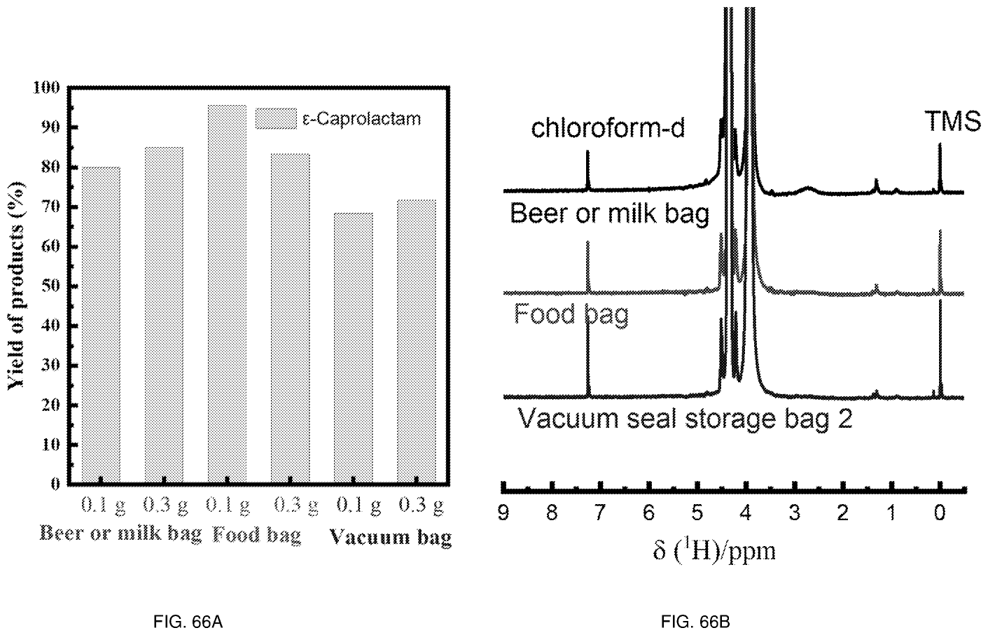

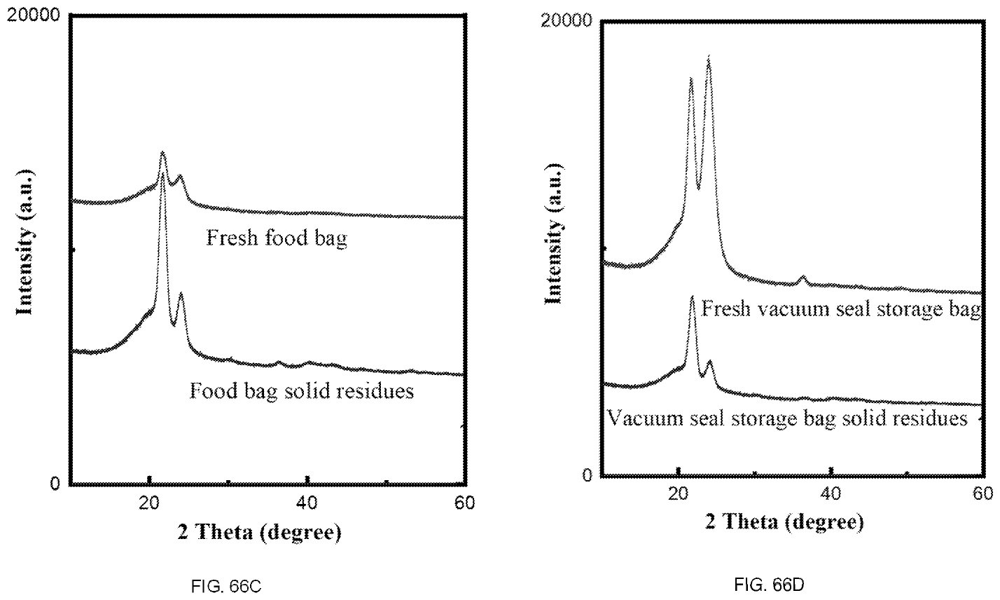

As expected, after the hydrolysis step at 250° C. for 8 h, the caprolactam yield from the food bag, the beer or milk bag, and the vacuum seal storage bag 2 was 96%, 80%, and 72%, respectively, as shown in FIG. 66A. Increasing the loading of beer or milk bag, and the vacuum seal storage led to an improvement in the caprolactam yield, whereas the yield of caprolactam declined in the case of food bag. Even though the caprolactam yield cannot reach 100%, the Nylon 6 component still cannot be detected by ¹H NMR measurement (FIG. 66B), suggesting that all the PA layers were removed in the second step of the sequential process. XRD spectra of solid residues in FIGS. 66C and 66D also verified the highly efficient second-step depolymerization with the prominent PE characteristic peaks.

Hydrocracking of PE from multilayer packaging materials. As PE film is the largest and cheapest packaging film in all the multilayer packaging materials used in this study, upgrading these layers to the jet-fuel range and lubricant-range hydrocarbons is still of interest. Thus after the methanolysis (step 1) and/or hydrolysis (8h, step 2) of 0.1 g multilayer film, the hydrocracking of the PE was conducted using Ru/C as a catalyst in n-hexane solvent.

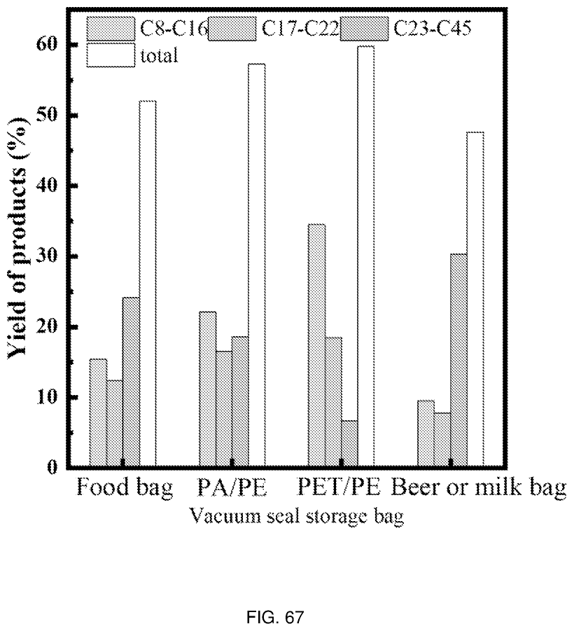

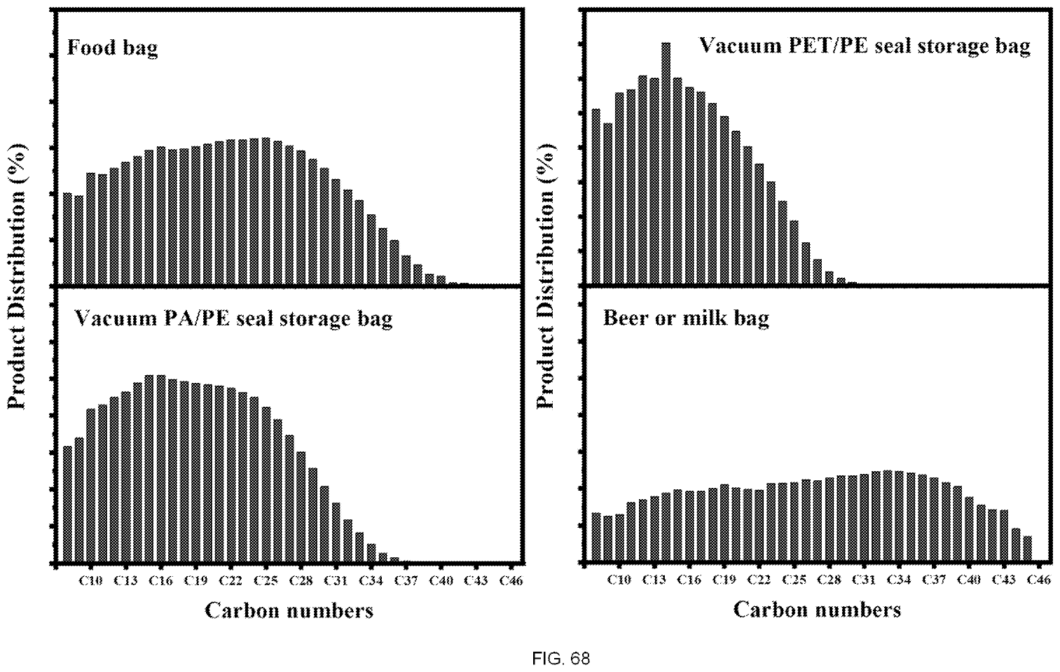

After the methanolysis (step 1) and/or hydrolysis (8h, step 2), most PET and Nylon 6 were removed, resulting in the highly hydrocracking performance. FIG. 67 displays the yields of liquid hydrocarbons after the hydrocracking of PE from the solid residues of four types of multilayer packaging materials. There were different ratios of jet-fuel-range alkanes (C8-C16), diesel-range hydrocarbons (C17-C22) and lubricant-range hydrocarbons (C23-C35) and C36-C45 products from the different feedstock. Total yields of the liquid products (52%) at 230° C. with only 15% jet-fuel-range alkanes (C8-C16) were obtained from the PE hydrocracking of the food bag. Due to the same film component and similar content with the food bag, the hydrocarbon products distribution from vacuum seal storage bag 2 degradation were similar, as shown in FIG. 68. By contrast, the highest overall yield (60%) of liquid hydrocarbons from the hydrocracking of PET/PE vacuum seal storage bag 1 solid residues were obtained, with 58% selectivity for jet-fuel-range alkanes. At the same time, the carbon numbers were narrowed to 30, with C14 being the main product. Unfortunately, the jet-fuel-range (C8-C16), diesel-range (C17-C22) hydrocarbons from the PE degradation of beer or milk bag residues were far from satisfactory because the overall yields of the liquid products were 48%, with 64% selectivity for the C23-C45 products. Based on the distribution of all the liquid products, it is concluded that it is hard to narrow the ranges due to the random scission.

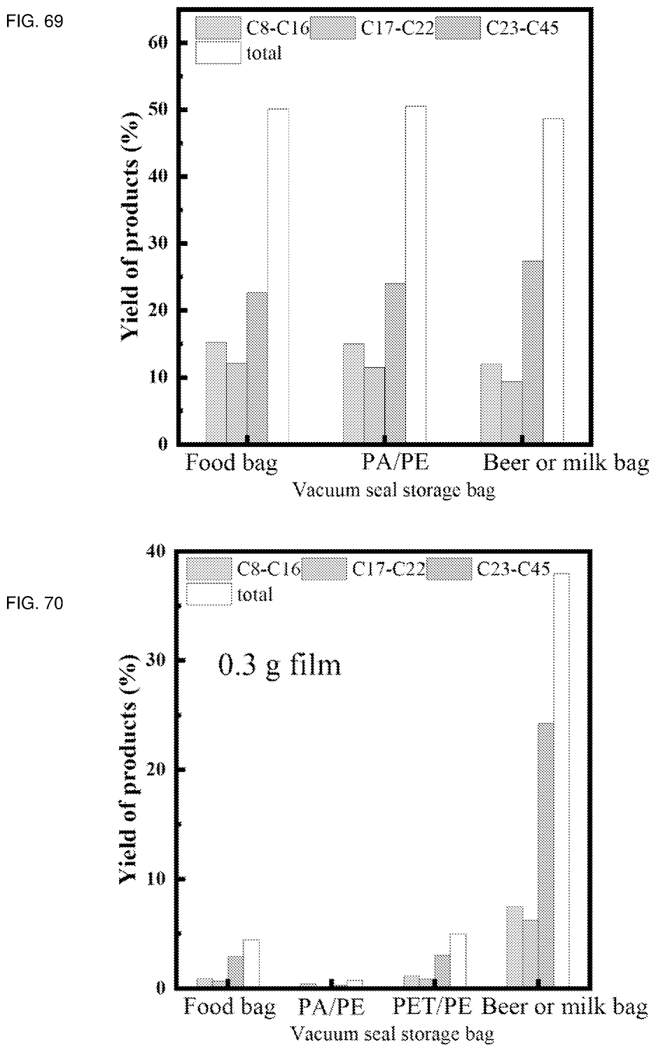

According to the previous finding, there were insoluble Nylon 6 oligomers during the hydrolysis step. Thus longer reaction time was conducted for the removal of the Nylon 6 layer. As can be seen in FIG. 69, the pretreatment time for the hydrolysis on the production distribution of the depolymerization of PE can be negligible.

The potential to promote the recycling to waste plastics is partly determined by the scale-up of the solvolysis process. However, due to the limitation of magnetic stirring, the stirring process stopped when the PE solid residues were from 0.3 g multilayer packaging films feedstock, except the beer or milk bag, as shown in FIG. 70. Even though the hydrocracking rate of the beer or milk bags (0.3 g) declined slightly, similar products distribution inspires more investigation at the industrial scale.

Techno-Economic Analysis of the Sequential Process.

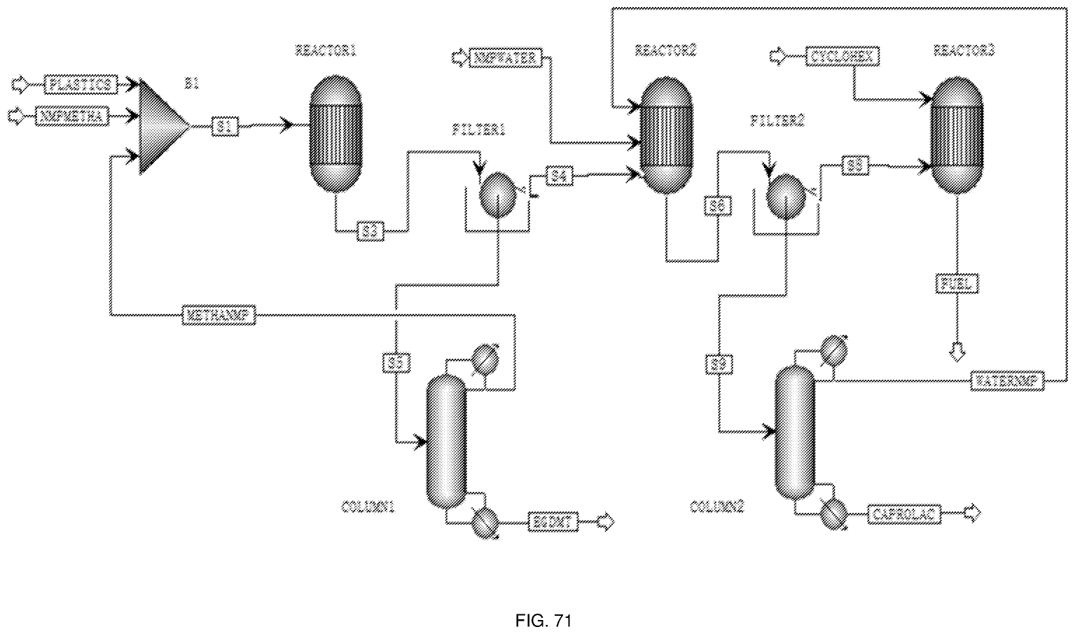

Process development. On the basis of the existing experimental data, the production of monomers and hydrocarbons with low molecular weight from co-mingled waste plastics was designed. At this time, there is no process flow diagram for the chemical degradation of co-mingled waste plastics in the sequential catalytic process; thus, the whole process for the chemical degradation of PET, Nylon 6 and PE was designed and shown in FIG. 71. It is assumed that the complete conversion of the PET, Nylon 6 or PE is achieved in the first, second, and third steps, respectively.

The degradation process of co-mingled waste plastics can be divided into 3 sections, as shown in FIG. 71: (1) complete depolymerization of PET to DMT and EG, (2) complete depolymerization of Nylon 6 to ε-caprolactam, (3) upgrading waste PE to hydrocarbons with low molecular weight. The plant, which is assumed to be located in North America, will be capable of degrading 10 tonne/h of co-mingled waste plastics (PET:Nylon 6:PE=3:2:5) a year. The process is simulated through Aspen Plus V9 using the NRTL method.

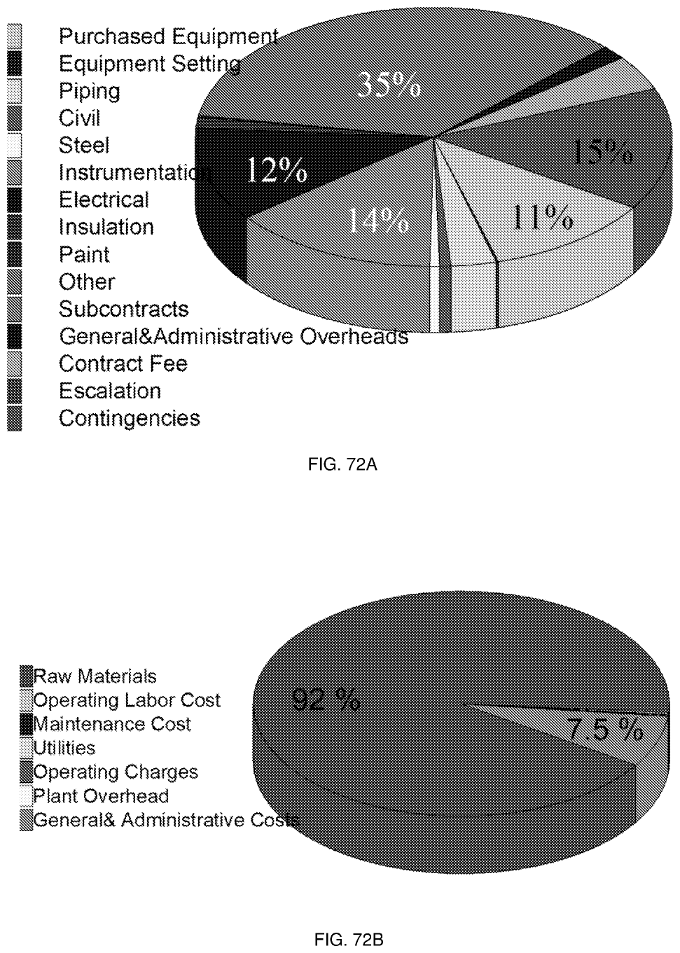

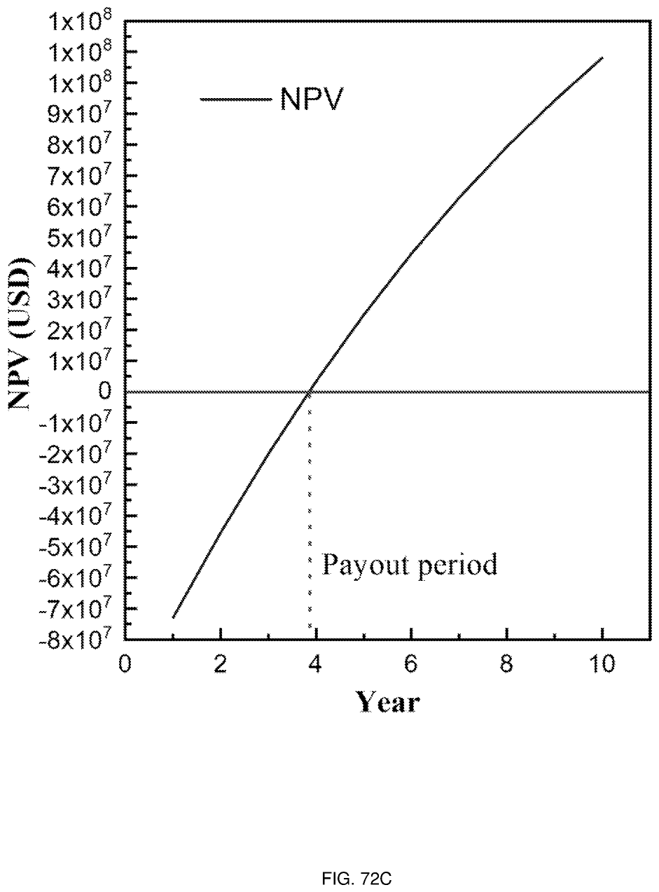

Economic evaluation. The stream prices are calculated based on the market price on the internet (amines, www.sigmaaldrich.com; Ru/C: www.spectrumchemical.com) Checkboxes for “Economics Active” and “Auto-Evaluate” were checked to evaluate process capital and operating expenses when Aspen Plus V9 was used for the simulation calculations. Table 9 shows the executive summary of the techno-economic evaluation. The total project capital cost is around 3.92+06 USD. Purchased equipment only accounted for 11%, not expensive for the whole process, as shown in 4 FIG. 72A. Raw materials accounted for most of the operation cost (FIG. 72B). The total operating cost, including raw materials, is 2.51E+08 USD/year. The total product sales are 3.04E+08 USD/year, which exceeds the sum of the total project capital cost and the total operating cost. As a result, a projected net present value (NPV) is positive, indicating that the sequential catalytic process for the co-mingled waste plastics conversion to monomers and fuels will make the plant profitable. The project's economic life is designed as 20 years but what's exciting is that the payout period (P.O. Period) is around 4 years (FIG. 72C). A projected net present value (NPV) is positive, indicating that the sequential catalytic process for the co-mingled waste plastics conversion to monomers and fuels will make the plant profitable.

TABLE 9
Executive summary of the techno-economic evaluation.

| INVESTMENT: | | |
|---|---|---|
| Total Project Capital Cost | 3.92E+06 | USD |
| Total Operating Cost | 2.51E+08 | USD/Year |
| Total Raw Materials Cost | 2.31E+08 | USD/Year |
| Total Utilities Cost | 87061.4 | USD/Year |
| Total Product Sales | 3.04E+08 | USD/Year |
| Desired Rate of Retum | 20%/year | |
| P.O. Period | 3.85 | Year |

Conclusions. In summary, a cost-effective process for the conversion of commingled waste plastics (PET, Nylon 6 and PE) and multilayer packaging materials was demonstrated, including PET/Nylon 6/PE film for beer/milk package, PET/PE or Nylon 6/PE film for vacuum seal storage, and Nylon 6/PE film for food bag, to monomers and fuels/lubricants-range hydrocarbons by the chemical recycling of the specific plastic family step by step.

Specifically, the degradation of the PET through methanolysis over a volatile homogeneous catalyst, namely NMP was achieved at low reaction temperatures, followed by the hydrolysis of Nylon 6 over the TEA at higher reaction temperatures. Last but not least, after the chemical removal of the heteroatomic polymers, the solid residues, mainly polyolefins can be cracked into fuel/lubricants-range low molecular hydrocarbons through heterogeneous catalysis over Ru-based catalysts. In the first step and second steps, the homogeneous catalyst can be recycled with the methanol or water solvent through evaporation, leaving the solid residues to be readily separated through filtration. After the exhaustion of the solid residues in the final step, the solid catalyst used in this step can be recycled. The monomers can undergo polymerization again to obtain fresh polyesters or polyamides with good material properties for everyday life. The low molecular weight hydrocarbons from polyolefins can be used as liquefied gas fuels, liquid transportation fuels or lubricants.

After the production and recovery of the products from the waste commingled plastics/multilayer packaging materials, the sequential catalytic process was integrated and simulated with the scale-up potential. The techno-economics analysis and life-cycle analysis were conducted for the whole process after the optimization of each operation unit. A projected net present value (NPV) is positive, indicating that the sequential catalytic process for the co-mingled waste plastics conversion to monomers and fuels will make the plant profitable. These findings can address the large waste-disposal problems presented by currently used commingle plastics and multilayer packaging materials through the sequential chemical catalytic process.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The subject matter described above is provided by way of illustration only and should not be construed as limiting. Various modifications and changes may be made to the subject matter described herein without following the example embodiments and applications illustrated and described, and without departing from the true spirit and scope of the present disclosure, which is set forth in the following claims.

All publications, patents and patent applications cited in this specification are incorporated herein by reference in their entireties as if each individual publication, patent or patent application were specifically and individually indicated to be incorporated by reference. While the foregoing has been described in terms of various embodiments, the skilled artisan will appreciate that various modifications, substitutions, omissions, and changes may be made without departing from the spirit thereof.

### REFERENCES

Abraham, M. J., Murtola, T., Schulz, R., Páll, S., Smith, J. C., Hess, B., and Lindah, E. (2015). Gromacs: High performance molecular simulations through multi-level parallelism from laptops to supercomputers. SoftwareX 1-2, 19-25.
Achilias, D. S., Karayannidis, G. P. (2004). The chemical recycling of PET in the framework of sustainable development, Water, Air, Soil Pollut. Focus. 4, 385-396. https://doi.org/10.1023/B:WAFO.0000044812.47185.0f.
Adams, C. J., Earle, M. J., and Seddon, K. R. (2000). Catalytic cracking reactions of polyethylene to light alkanes: In ionic liquids. Green Chem. 2, 21-23.
Aguado, J., Serrano, D. P., Vicente, G., and Sanchez, N. (2007). Enhanced production of α-olefins by thermal degradation of High-Density Polyethylene (HDPE) in decalin solvent: Effect of the reaction time and temperature. Ind. Eng. Chem. Res. 46, 3497-3504.
Akubo, K., Nahil, M. A., and Williams, P. T. (2019). Aromatic fuel oils produced from the pyrolysis-catalysis of polyethylene plastic with metal-impregnated zeolite catalysts. J. Energy Inst. 92, 195-202.
Alayoub, R. I. N. (2012). Isolation and characterization of new triethylamine and ethyl acrylate degrading bacteria.
Allen, B. (2020) IBM's VolCat Process Uses ‘Molecular Sorting’ to Turn Mixed-Waste Recyclate into Virgin-Grade PET. 1-5.
Almithn, A., and Hibbitts, D. (2019). Comparing Rate and Mechanism of Ethane Hydrogenolysis on Transition-Metal Catalysts. J. Phys. Chem. C 123, 5421-5432.
Al-Salem, S. M.; Lettieri, P.; Baeyens, J. (2009). Recycling and Recovery Routes of Plastic Solid Waste (PSW): A Review. Waste Manag. 29 (10), 2625-2643. https://doi.org/10.1016/j.wasman.2009.06.004.
Anuar Sharuddin, S. D.; Abnisa, F.; Wan Daud, W. M. A.; Aroua, M. K. (2016). A Review on Pyrolysis of Plastic Wastes. Energy Convers. Manag. 115, 308-326.
Areeprasert, C.; Asingsamanunt, J.; Srisawat, S.; Kaharn, J.; Inseemeesak, B.; Phasee, P.; Khaobang, C.; Siwakosit, W.; Chiemchaisri, C. (2017). Municipal Plastic Waste Composition Study at Transfer Station of Bangkok and Possibility of Its Energy Recovery by Pyrolysis. Energy Procedia. 107, 222-226.
Awaja, F. & Pavel, D. (2005). Recycling of PET. Eur. Polym. J. 41, 1453-1477.
Bao, Y. S., Zhaorigetu, B., Agula, B., Baiyin, M. & Jia, M. (2014). Aminolysis of aryl ester using tertiary amine as amino donor via c-o and c-n bond activations. J. Org. Chem. 79, 803-808.
Barbarias, I., Artetxe, M., Lopez, G., Arregi, A., Bilbao, J., and Olazar, M. (2018). Influence of the conditions for reforming HDPE pyrolysis volatiles on the catalyst deactivation by coke. Fuel Process. Technol. 171, 100-109.
Barrer, R. M., and Sikand, A. (1979). Sorption of hydrocarbons and water in silanated and unsilanated partial H-forms of zeolite Y. J. Chem. Soc. Faraday Trans. 1 Phys. Chem. Condens. Phases 75, 2221-2234.
BASF (2018). Chemical recycling of plastic waste. 1-2.
Becke, A. D. (1988). Density-functional exchange-energy approximation with correct asymptotic behavior. Phys. Rev. A 38, 3098-3100.
Beckner, W.; Mao, C. M.; Pfaendtner, J. (2018). Statistical Models Are Able to Predict Ionic Liquid Viscosity across a Wide Range of Chemical Functionalities and Experimental Conditions. Mol. Syst. Des. Eng. 3 (1), 253-263.
Beckner, W.; Pfaendtner, J. (2019). Fantastic Liquids and Where To Find Them: Optimizations of Discrete Chemical Space. J. Chem. Inf. Model. 59 (6), 2617-2625.
Berendsen, H. J. C., Postma, J. P. M., van Gunsteren, W. F., DiNola, A., and Haak, J. R. (1984). Molecular dynamics with coupling to an external bath. J. Chem. Phys. 81, 3684-3690.
Bhogle, C. S. & Pandit, A. B. (2019). Ultrasound assisted methanolysis of polycarbonate at room temperature. Ultrason. Sonochem. 58.
Blöchl, P. E. (1994). Projector augmented-wave method. Phys. Rev. B 50, 17953-17979.
Bockhorn, H., S. Donner, M. Gernsbeck, A. Hornung, U. Hornung, (2001). Pyrolysis of polyamide 6 under catalytic conditions and its application to reutilization of carpets, J. Anal. Appl. Pyrolysis. https://doi.org/10.1016/S0165-2370(00)00187-X.
Boisart, C. & Maille, E. (2018). Method for recycling plastic products.
Braun, M., A. B. Levy, S. (1999). Sifniades, Recycling Nylon 6 carpet to caprolactam, Polym. Plast. Technol. Eng. 38. 471-484. https://doi.org/10.1080/03602559909351594.
Briga-Sá, A. et al. (2013). Textile waste as an alternative thermal insulation building material solution. Constr. Build. Mater. 38, 155-160.
Brunner, S.; Fomin, P.; Kargel, C. (2015). Automated Sorting of Polymer Flakes: Fluorescence Labeling and Development of a Measurement System Prototype. Waste Management. https://doi.org/10.1016/j.wasman.2014.12.006.
Burney, P. R.; Nordwald, E. M.; Hickman, K.; Kaar, J. L.; Pfaendtner, J. (2015). Molecular Dynamics Investigation of the Ionic Liquid/Enzyme Interface: Application to Engineering Enzyme Surface Charge. Proteins Struct. Funct. Bioinforma. 83 (4), 670-680.
Bussi, G., Donadio, D., and Parrinello, M. (2007). Canonical sampling through velocity rescaling. J. Chem. Phys. 126, 014101.
Bütün, V., S. P. Armes, N.C. Billingham, (2001). Synthesis and aqueous solution properties of near-monodisperse tertiary amine methacrylate homopolymers and diblock copolymers, Polymer (Guildf). https://doi.org/10.1016/S0032-3861(01)00066-0.
Calvo-Correas, T.; Ugarte, L.; Trzebiatowska, P. J.; Sanzberro, R.; Datta, J.; Corcuera, M. Á; Eceiza, A. (2017). Thermoplastic Polyurethanes with Glycolysate Intermediates from Polyurethane Waste Recycling. Polym. Degrad. Stab. 144, 411-419.
Camacho, J., Diez, E., Diaz, I., and Ovejero, G. (2017). Hansen solubility parameter: from polyethylene and poly(vinyl acetate) homopolymers to ethylene-vinyl acetate copolymers. Polym. Int. 66, 1013-1020.
Cantero, D. A., M. D. Bermejo, M. J. Cocero. (2015). Governing Chemistry of Cellulose Hydrolysis in Supercritical Water, ChemSusChem. https://doi.org/10.1002/cssc.201403385.
Cardenal, A. D., Jeong Park, H., Chalker, C. J., Ortiz, K. G., and Powers, D. C. (2017). Cis-Decalin oxidation as a stereochemical probe of in-MOF versus on-MOF catalysis. Chem.
Commun. 53, 7377-7380.
Carné Sánchez, A.; Collinson, S. R. (2011). The Selective Recycling of Mixed Plastic Waste of Polylactic Acid and Polyethylene Terephthalate by Control of Process Conditions. Eur. Polym. J., 47 (10), 1970-1976.
Castaño, P., Elordi, G., Olazar, M., Aguayo, A. T., Pawelec, B., and Bilbao, J. (2011). Insights into the coke deposited on HZSM-5, Hβ and HY zeolites during the cracking of polyethylene. Appl. Catal. B Environ. 104, 91-100.
Celik, G.; Kennedy, R. M.; Hackler, R. A.; Ferrandon, M.; Tennakoon, A.; Patnaik, S.; Lapointe, A. M.; Ammal, S. C.; Heyden, A.; Perras, F. A.; et al. (2019). Upcycling Single-Use Polyethylene into High-Quality Liquid Products. ACS Cent. Sci. 5 (11), 1795-1803.
Ceruti, M. G., S. H. Rubin, (2005). Infodynamics III: Information integration and tractability, in: Proc. 2005 IEEE Int. Conf. Inf. Reuse Integr. IRI—2005, https://doi.org/10.1109/IRI-05.2005.1506444.
Češarek, U., D. Pahovnik, E. Zagar, (2020). Chemical recycling of aliphatic polyamides by microwave-assisted hydrolysis for efficient monomer recovery, ACS Sustain. Chem. Eng. 8 16274-16282. https://doi.org/10.1021/acssuschemeng.0c05706.
Chang, H. C., J. C. Jiang, W. C. Tsai, G. C. Chen, C. Y. Chang, S. H. Lin, (2006). The effect of pressure on charge-enhanced C—H - - - O interactions in aqueous triethylamine hydrochloride probed by high pressure Raman spectroscopy, Chem. Phys. Lett. https://doi.org/10.1016/j.cplett.2006.10.042.
Chang, H. Z., Li, J. Q., Du, S., Shen, K. Y., Yang, Q., Yi, H., and Zhang, J. W. (2019). Transformation Characteristics of Hydrogen-Donor Solvent Tetralin in the Process of Direct Coal Liquefaction. Front. Chem. 7.
Chavarria, F., D. R. Paul, (2004). Comparison of nanocomposites based on Nylon 6 and Nylon 66, Polymer (Guildf). https://doi.org/10.1016/j.polymer.2004.09.074.
Chemistry can help make plastics sustainable—but it isn't the whole solution. (2021). Nature 590, 363-364.
Chen, J., G. Liu, L. Jin, P. Ni, Z. Li, H. He, Y. Xu, J. Zhang, J. Dong. (2010). Catalytic hydrolysis of waste Nylon 6 to produce ε-caprolactam in sub-critical water, J. Anal. Appl. Pyrolysis. https://doi.org/10.1016/j.jaap.2009.10.004.
Chen, J., Z. Li, L. Jin, P. Ni, G. Liu, H. He, J. Zhang, J. Dong, R. Ruan. (2010). Catalytic hydrothermal depolymerization of Nylon 6, J. Mater. Cycles Waste Manag. 12 321-325. https://doi.org/10.1007/s10163-010-0304-y.
Chen, Z.; Zhang, X.; Che, L.; Peng, H.; Zhu, S.; Yang, F.; Zhang, X. (2020). Effect of Volatile Reactions on Oil Production and Composition in Thermal and Catalytic Pyrolysis of Polyethylene. Fuel, 271.
Chevron Phillips Chemical successfully completes first U.S. commercial scale production of circular polyethylene from recycled mixed-waste plastics (2020).
Chiu, S. J., Tsai, C. T. & Chang, Y. K. (2008). Monomer recovery from polycarbonate by methanolysis. E-Polymers. doi:10.1515/epoly.2008.8.1.1516
Cho, H. H.; Choi, S. C. (1984). Study on the Amine Degradation of Poly(Ethylene Terephthalate) Fibre. II. Changes of Physical Properties of PET Filaments by Amine Degradation.
Clark, M. (2011). Handbook of Textile and Industrial Dyeing. Handbook of Textile and Industrial Dyeing 2,
Coates, G. W. & Getzler, Y. D. Y. L. (2020). Chemical recycling to monomer for an ideal, circular polymer economy. Nature Reviews Materials 5, 501-516.
Coates, G. W.; Getzler, Y. D. Y. L. (2020). Chemical Recycling to Monomer for an Ideal, Circular Polymer Economy. Nature Reviews Materials. pp 501-516. https://doi.org/10.1038/s41578-020-0190-4.
Conesa, J. A., R. Font, A. Martilla, A. N. Garcia. (1994). Pyrolysis of Polyethylene in a Fluidized Bed Reactor, Energy and Fuels. https://doi.org/10.1021/ef00048a012.
Coq, B., Dutartre, R., Figueras, F., and Tazi, T. (1990). Particle size, precursor, and support effects in the hydrogenolysis of alkanes over supported rhodium catalysts. J. Catal. 122, 438-447.
Crespy, D., K. Landfester. (2007). Preparation of Nylon 6 nanoparticles and nanocapsules by two novel miniemulsion/solvent displacement hybrid techniques, Macromol. Chem. Phys. 208, 457-466. https://doi.org/10.1002/macp.200600487.
Cullen, J. M. & Allwood, J. M. (2010). Theoretical efficiency limits for energy conversion devices. Energy 35, 2059-2069.
Czernik, S., C. C. Elam, R. J. Evans, R. R. Meglen, L. Moens, K. Tatsumoto. (1998). Catalytic pyrolysis of Nylon-6 to recover caprolactam, J. Anal. Appl. Pyrolysis. https://doi.org/10.1016/S0165-2370(98)00068-0.
d'Ambrières, W. (2019). Plastics Recycling Worldwide: Current Overview and Desirable Changes. F. Actions Sci. Reports. J. F. actions
Darden, T., York, D., and Pedersen, L. (1993). Particle mesh Ewald: An N −log(N) method for Ewald sums in large systems. J. Chem. Phys. 98, 10089-10092.
Das, J., Halgeri, A. B., Sahu, V. & Parikh, P. A. (2007). Alkaline hydrolysis of poly(ethylene terephthalate) in presence of a phase transfer catalyst. Indian J. Chem. Technol. 14, 173-177.
Das, P., and Tiwari, P. (2018). Valorization of packaging plastic waste by slow pyrolysis. Resour. Conserv. Recycl. 128, 69-77.
Datta, J., K. Bfazek, M. Wfoch, R. Bukowski. (2018). A New Approach to Chemical Recycling of Polyamide 6.6 and Synthesis of Polyurethanes with Recovered Intermediates, J. Polym. Environ. 26 4415-4429. https://doi.org/10.1007/s10924-018-1314-4.
David G. Hangauer, J. (1943). Aqueous colloidal dispersions of tertiary amine salts of urea-urethane polymers and method for manufacture. 12, 2-4.
De Stefanis, A.; Cafarelli, P.; Gallese, F.; Borsella, E.; Nana, A.; Perez, G. (2013). Catalytic Pyrolysis of Polyethylene: A Comparison between Pillared and Restructured Clays. J. Anal. Appl. Pyrolysis, 104, 479-484.
Deighan, M.; Pfaendtner, J. (2013). Exhaustively Sampling Peptide Adsorption with Metadynamics. Langmuir. 29 (25), 7999-8009.
Deshmukh, S. D.; Undre, P. B.; Pattebahadur, K. L.; Mohod, A. G.; Patil, S. S.; Khirade, P. W. 2017. Investigation of Intermolecular Interactions between Amide-Amine Binary Mixtures through Dielectric Relaxation Study. Ferroelectrics. https://doi.org/10.1080/00150193.2017.1362280.
Deshpande, N., E. H. Cho, A. P. Spanos, L. C. Lin, N. A. Brunelli. (2019). Tuning molecular structure of tertiary amine catalysts for glucose isomerization, J. Catal. https://doi.org/10.1016/j.jcat.2019.02.025.
DeSimone, J. M. (2002). Practical approaches to green solvents. Science 297, 799-803
Dick Vethaak, A.; Legler, J. (2021). Microplastics and Human Health: Knowledge Gaps Should Be Addressed to Ascertain the Health Risks of Microplastics. Science (80-.). 371 (6530), 672-674. https://doi.org/10.1126/science.abe5041.
Dimitrov, N., Kratofil Krehula, L., Ptiček Siročić, A. & Hrnjak-Murgić, Z. (2013). Analysis of recycled PET bottles products by pyrolysis-gas chromatography. Polym. Degrad. Stab. 98, 972-979.
Ding, G.; Su, J.; Zhang, C.; Tang, K.; Yang, L.; Lin, H. (2018). Coupling Glucose Dehydrogenation with CO 2 Hydrogenation by Hydrogen Transfer in Aqueous Media at Room Temperature. ChemSusChem. 11 (13), 2029-2034.
Ding, W. B., Tuntawiroon, W., Liang, J., and Anderson, L. L. (1996). Depolymerization of waste plastics with coal over metal-loaded silica—Alumina catalysts. Fuel Process. Technol. 49, 49-63.
Drozdowski, H., and Nowakowski, K. (2008). X-ray diffraction studies of liquid methylcyclohexane C6Hn-CH3 structure at 293 K. Acta Phys. Pol. A 114, 383-389.
Duan, Q.; Li, J. (2021). Classification of Common Household Plastic Wastes Combining Multiple Methods Based on Near-Infrared Spectroscopy. ACS ES&T Eng. https://doi.org/10.1021/acsestengg.0c00183.
Dufaud, V., and Basset, J. M. (1998). Catalytic hydrogenolysis at low temperature and pressure of polyethylene and polypropylene to diesels or lower alkanes by a zirconium hydride supported on silica-alumina: A step toward polyolefin degradation by the microscopic reverse of Ziegler-Natta pol. Angew. Chemie—Int. Ed. 37, 806-810.
Edward, J., F. Moran, (1992). Nylon component reclamation, U.S. Pat. No. 5,266,694A,
Elordi, G.; Olazar, M.; Lopez, G.; Castaño, P.; Bilbao, J. (2011). Role of Pore Structure in the Deactivation of Zeolites (HZSM-5, Hβ and HY) by Coke in the Pyrolysis of Polyethylene in a Conical Spouted Bed Reactor. Appl. Catal. B Environ. 102 (1-2), 224-231.
Erikson, J. P. (2017). Partially miscible water-triethylamine solutions and their temperature dependence, J. Chem. Educ. 94, 75-78. https://doi.org/10.1021/acs.jchemed.6b00489.
Eriksson, O. & Finnveden, G. (2009). Plastic waste as a fuel—CO2-neutral or not? Energy Environ. Sci. 2, 907-914.
Essaddam, H. (2016). Polyethylene terephthalate depolymerization.
Eyal, A. M., R. Canari. (1995). pH Dependence of Carboxylic and Mineral Acid Extraction by Amine-Based Extractants: Effects of pKa, Amine Basicity, and Diluent Properties, Ind. Eng. Chem. Res. https://doi.org/10.1021/ie00044a030.
Ferrero, F. & Periolatto, M. (2012). Glycerol in comparison with ethanol in alcohol-assisted dyeing. J. Clean. Prod. 33, 127-131.
Fischer, M. (2004). Polyamide (PA), Kunststoffe Plast Eur. https://doi.org/10.1007/978-3-642-40872-4_1725-1.
Flaherty, D. W., and Iglesia, E. (2013). Transition-state enthalpy and entropy effects on reactivity and selectivity in hydrogenolysis of n-alkanes. J. Am. Chem. Soc. 135, 18586-18599.
Flaherty, D. W., Hibbitts, D. D., and Iglesia, E. (2014). Metal-catalyzed C—C bond cleavage in alkanes: Effects of methyl substitution on transition-state structures and stability. J. Am. Chem. Soc. 136, 9664-9676.
Flaherty, D. W., Hibbitts, D. D., Gürbüz, E. l., and Iglesia, E. (2014). Theoretical and kinetic assessment of the mechanism of ethane hydrogenolysis on metal surfaces saturated with chemisorbed hydrogen. J. Catal. 311, 350-356.
Fleming, K. L.; Tiwary, P.; Pfaendtner, J. (2016). New Approach for Investigating Reaction Dynamics and Rates with Ab Initio Calculations. J. Phys. Chem. A 120 (2), 299-305.
Franco, M. A. (2017). Circular economy at the micro level: A dynamic view of incumbents' struggles and challenges in the textile industry. J. Clean. Prod. 168, 833-845.
Froidevaux, V., C. Negrell, S. Caillol, J. P. Pascault, B. Boutevin. (2016). Biobased Amines: From Synthesis to Polymers; Present and Future, Chem. Rev. 116, 14181-14224. https://doi.org/10.1021/acs.chemrev.6b00486.
Fu, C. D.; He, Y.; Pfaendtner, J. (2019). Diagnosing the Impact of External Electric Fields Chemical Kinetics: Application to Toluene Oxidation and Pyrolysis. J. Phys. Chem. A, 123 (14), 3080-3089.
Fu, C. D.; L. Oliveira, L. F.; Pfaendtner, J. (2017). Determining Energy Barriers and Selectivities of a Multi-Pathway System with Infrequent Metadynamics. J. Chem. Phys. 146 (1), 014108.
Fu, C. D.; Pfaendtner, J. (2018). Lifting the Curse of Dimensionality on Enhanced Sampling of Reaction Networks with Parallel Bias Metadynamics. J. Chem. Theory Comput. 14 (5), 2516-2525.
Fuchs, H., G. Neubauer, J. Ritz, C. U. Priester. (1994). Recovery of caprolactam from polycaprolactam, U.S. Pat. No. 5,359,062A.
Fujimoto, K., Ohno, A., and Kunugi, T. (1983). Liquid phase hydrogenolysis of thiophene by decaline as hydrogen donor with metal supported active carbon catalysts. Stud. Surf. Sci. Catal. 17, 241-249.
Fukushima, K. et al. (2011). Organocatalytic depolymerization of poly(ethylene terephthalate). J. Polym. Sci. Part A Polym. Chem. 49, 1273-1281.
Garcia, J. M.; Robertson, M. L. (2017). The Future of Plastics Recycling. Science. 358 (6365), 870-872.
Gcse, E., F. (2014). Technology, N,N-Dimethylaniline_C8H11N—PubChem, 1-3.
Genta, M., Goto, M. & Sasaki, M. (2010). Heterogeneous continuous kinetics modeling of PET depolymerization in supercritical methanol. J. Supercrit. Fluids 52, 266-275
Genta, M., Iwaya, T., Sasaki, M. & Goto, M. (2007). Supercritical methanol for polyethylene terephthalate depolymerization: Observation using simulator. Waste Manag. 27, 1167-1177.
Geyer, R., Jambeck, J. R., and Law, K. L. (2017). Production, use, and fate of all plastics ever made. Sci. Adv. 3.
Geyer, R.; Jambeck, J. R.; Law, K. L. (2017). Production, Use, and Fate of All Plastics Ever Made. Sci. Adv. 3 (7). https://doi.org/10.1126/sciadv.1700782.
Ghosh, S. K.; P, A. (2019). Plastics in Municipal Solid Waste: What, Where, How and When?Waste Manag. Res. 37 (11), 1061-1062.
Góral, M., D. G. Shaw, A. Maczyński, B. Wiśniewska-Gocfowska, P. Oracz. (2012). IUPAC-NIST Solubility Data Series. 96. Amines with Water Part 1. C4-C6 Aliphatic Amines, J. Phys. Chem. Ref Data. 41. https://doi.org/10.1063/1.4755288.
Goto, M. (2009). Chemical Recycling of Plastics Using Sub- and Supercritical Fluids. J. Supercrit. Fluids. 47 (3), 500-507. https://doi.org/10.1016/j.supflu.2008.10.011.
Goto, M. et al. (2002). Degradation kinetics of polyethylene terephthalate in supercritical methanol. AlChE J. 48, 136-144.
Goto, M., M. Sasaki, T. Hirose. (2006). Reactions of polymers in supercritical fluids for chemical recycling of waste plastics, J. Mater. Sci. 41, 1509-1515. https://doi.org/10.1007/s10853-006-4615-2.
Goto, M., M. Umeda, A. Kodama, T. Hirose, S. Nagaoka. (2001). Monomerization of Nylon 6 in sub-and supercritical water, Kobunshi Ronbunshu. https://doi.org/10.1295/koron.58.548.
Grasso, M. M. (1995). Recycled textile fibers: the challenge for the twenty-first century. Text. Chem. Color. 27.
Grasso, M. M. (1996). Recycling fabric waste—the challenge industry. J. Text. Inst. 87, 21-30
Grimme, S., Antony, J., Ehrlich, S. & Krieg, H. (2010). A consistent and accurate ab initio parametrization of density functional dispersion correction (DFT-D) for the 94 elements H—Pu. J. Chem. Phys. 132.
Güçlü, G., Yalginyuva, T., Özgümüş, S. & Orbay, M. (2003). Simultaneous glycolysis and hydrolysis of polyethylene terephthalate and characterization of products by differential scanning calorimetry. Polymer (Guildf). 44, 7609-7616.
Gupta, P.; Bhandari, S. (2018). Chemical Depolymerization of PET Bottles via Ammonolysis and Aminolysis. In Recycling of Polyethylene Terephthalate Bottles. pp 109-134.
Haider, T. P., Volker, C., Kramm, J., Landfester, K. & Wurm, F. R. (2019). Plastics of the Future? The Impact of Biodegradable Polymers on the Environment and on Society. Angewandte Chemie—International Edition 58, 50-62.
Hansen Solubility Parameters https://www.hansen-solubility.com/.
Hansen, C. M. (2007). Hansen solubility parameters: A user's handbook: Second edition (CRC Press).
Hatakeyama, K., Kojima, T. & Funazukuri, T. (2014). Chemical recycling of polycarbonate in dilute aqueous ammonia solution under hydrothermal conditions. J. Mater. Cycles Waste Manag. 16, 124-130.
He, Y., Pan, J., Wu, L., Ge, L. & Xu, T. (2015). Facile preparation of 1,8-Diazabicyclo[5.4.0]undec-7-ene based high performance anion exchange membranes for diffusion dialysis applications. J. Memb. Sci. 491, 45-52.
Heterogeneous Catalysis in Organic Chemistry, (1999). https://doi.org/10.1016/b978-O-12-651645-6.x5000-8.
Hibbitts, D. D., Flaherty, D. W., and Iglesia, E. (2016). Effects of Chain Length on the Mechanism and Rates of Metal-Catalyzed Hydrogenolysis of n-Alkanes. J. Phys. Chem. C 120, 8125-8138.
Hicks, C. & Dietmar, R. (2007). Improving cleaner production through the application of environmental management tools in China. J. Clean. Prod. 15, 395-408.
Hongfei Lin; Shaoqu Xie. (2019). Conversion of Co-Mingled Waste Plastics to Monomers and Fuels in Sequential Catalytic Process. U.S. Patent Application No. 62/902,712.
Hoover, W. G. (1985). Canonical dynamics: Equilibrium phase-space distributions. Phys. Rev. A 31, 1695-1697.
Hopewell, J.; Dvorak, R.; Kosior, E. (2009). Plastics Recycling: Challenges and Opportunities. Philosophical Transactions of the Royal Society B: Biological Sciences. 364(1526): 2115-2126. https://doi.org/10.1098/rstb.2008.0311.
Hough, B. R.; Beck, D. A. C.; Schwartz, D. T.; Pfaendtner, J. (2017). Application of Machine Learning to Pyrolysis Reaction Networks: Reducing Model Solution Time to Enable Process Optimization. Comput. Chem. Eng. 104, 56-63.
Hu, L. C., Oku, A. & Yamada, E. (1998). Alkali-catalyzed methanolysis of polycarbonate. A study on recycling of bisphenol A and dimethyl carbonate. Polymer (Guildf). 39, 3841-3845
Huczkowski, P., J. Kapko. (1980). Degradation of Nylon-6 in ethylene glycol: 2. Mathematical illustration of degradation, Polymer (Guildf). https://doi.org/10.1016/0032-3861(80)90172-X.
Iannone, F. et al. (2017). Ionic liquids/ZnO nanoparticles as recyclable catalyst for polycarbonate depolymerization. J. Mol. Catal. A Chem. 426, 107-116.
Ibáñez, M., Artetxe, M., Lopez, G., Elordi, G., Bilbao, J., Olazar, M., and Castano, P. (2014).
Identification of the coke deposited on an HZSM-5 zeolite catalyst during the sequenced pyrolysis-cracking of HDPE. Appl. Catal. B Environ. 148-149, 436-445.
Identification, M., (2020). Showing metabocard for Tripropylamine (HMDB0032545), 1-8.
Identifiers, C., (2019). CAMEO Chemicals_Tripropylamine, 1-4.
Identifiers, C., (2019). EPA_Chemistry Dashboard_N-methylpiperidine, 1-4.
Iribarren, D.; Dufour, J.; Serrano, D. P. (2012). Preliminary Assessment of Plastic Waste Valorization via Sequential Pyrolysis and Catalytic Reforming. J. Mater. Cycles Waste Manag. 14 (4), 301-307.
Itävaara, M., Karjomaa, S. & Selin, J. F. (2002). Biodegradation of polylactide in aerobic and anaerobic thermophilic conditions. Chemosphere 46, 879-885.
Iwaya, T., M. Sasaki, M. Goto. (2006). Kinetic analysis for hydrothermal depolymerization of Nylon 6, Polym. Degrad. Stab. https://doi.org/10.1016/j.polymdegradstab.2006.02.009.
Jacob Sun, C. K.; Chen, S. H. Tracer Diffusion of Aromatic Hydrocarbons in N-Hexane up to the Supercritical Region. Chem. Eng. Sci. (1985). https://doi.org/10.1016/0009-2509(85)85123-X.
Jaeger, V. W.; Pfaendtner, J. (2016). Destabilization of Human Serum Albumin by Ionic Liquids Studied Using Enhanced Molecular Dynamics Simulations. J. Phys. Chem. B, 120 (47), 12079-12087.
Jaeger, V. W.; Pfaendtner, J. (2013). Structure, Dynamics, and Activity of Xylanase Solvated in Binary Mixtures of Ionic Liquid and Water. ACS Chem. Biol. 8 (6), 1179-1186.
Jaeger, V.; Burney, P.; Pfaendtner, J. (2015). Comparison of Three Ionic Liquid-Tolerant Cellulases by Molecular Dynamics. Biophys. J. 108 (4), 880-892.
Jaegers, N. R., Hu, W., Wang, Y. & Hu, J. Z. (2020). High-temperature and high-pressure in situ magic angle spinning nuclear magnetic resonance spectroscopy. J. Vis. Exp. 2020, 1-16
Jaegers, N. R., Mueller, K. T., Wang, Y. & Hu, J. Z. (2020). Variable Temperature and Pressure Operando MAS NMR for Catalysis Science and Related Materials. Acc. Chem. Res. 53, 611-619.
Jaegers, N. R., Wang, Y. & Hu, J. Z. (2020). Thermal perturbation of NMR properties in small polar and non-polar molecules. Sci. Rep. 10.
Jambeck, J. R., Geyer, R., Wilcox, C., Siegler, T. R., Perryman, M., Andrady, A., Narayan, R., and Law, K. L. (2015). Plastic waste inputs from land into the ocean. Science (80-.). 347, 768-771.
Jarin, Z.; Pfaendtner, J. (2014). Ionic Liquids Can Selectively Change the Conformational Free-Energy Landscape of Sugar Rings. J. Chem. Theory Comput. 10 (2), 507-510.
Jehanno, C. et al. (2018). Organocatalysed depolymerisation of PET in a fully sustainable cycle using thermally stable protic ionic salt. Green Chem. 20, 1205-1212.
Jehanno, C.; Demarteau, J.; Mantione, D.; Arno, M. C.; Ruiperez, F.; Hedrick, J. L.; Dove, A. P.; Sardon, H. (2021). Selective Chemical Upcycling of Mixed Plastics Guided by a Thermally Stable Organocatalyst. Angew. Chemie—Int. Ed. 60 (12), 6710-6717. https://doi.org/10.1002/anie.202014860.
Jenke, D., M. Poss, S. Sadain, J. Story, W. Smith, D. Reiber. (2005). Identification of caprolactam oligomers and related compounds in aqueous extracts of Nylon-6, J. Appl. Polym. Sci. 95, 1262-1274. https://doi.org/10.1002/app.21341.
Jia, C.; Xie, S.; Zhang, W.; Intan, N. N.; Sampath, J.; Pfaendtner, J.; Lin, H. (2021). Deconstruction of High-Density Polyethylene into Liquid Hydrocarbon Fuels and Lubricants by Hydrogenolysis over Ru Catalyst. Chem Catal. https://doi.org/10.1016/j.checat.2021.04.002.
Jia, X.; Qin, C.; Friedberger, T.; Guan, Z.; Huang, Z. (2016). Efficient and Selective Degradation of Polyethylenes into Liquid Fuels and Waxes under Mild Conditions. Sci. Adv. 2 (6).e1501591. https://doi.org/10.1126/sciadv.1501591.
Kaimal, V. K.; Vijayabalan, P. (2016). A Study on Synthesis of Energy Fuel from Waste Plastic and Assessment of Its Potential as an Alternative Fuel for Diesel Engines. Waste Manag. 51, 91-96.
Kaimal, V. K., and Vijayabalan, P. (2016). A study on synthesis of energy fuel from waste plastic and assessment of its potential as an alternative fuel for diesel engines. Waste Manag. 51, 91-96.
Kaiser, K.; Schmid, M.; Schlummer, M. (2018). Recycling of Polymer-Based Multilayer Packaging: A Review. Recycling. https://doi.org/10.3390/recycling3010001.
Kale, G., Auras, R. & Singh, S. P. (2007). Comparison of the degradability of poly(lactide) packages in composting and ambient exposure conditions. Packag. Technol. Sci. 20, 49-70.
Kalfas, G. A., (1998). Mathematical modeling of the depolymerization of polyamide mixtures—Part I: Kinetic mechanism and parametric studies in batch reactors, Polym. React. Eng. 6(1):41-67. https://doi.org/10.1080/10543414.1998.10744482.
Kamimura, A., S. Yamamoto. (2007). An efficient method to depolymerize polyamide plastics: A new use of ionic liquids, Org. Lett. 9, 2532-2535. https://doi.org/10.1021/o1070886c.
Kamimura, A., Y. Shiramatsu, T. Kawamoto. (2019). Depolymerization of polyamide 6 in hydrophilic ionic liquids, Green Energy Environ. https://doi.org/10.1016/j.gee.2019.01.002.
Kaminsky, W., and Zorriqueta, I. J. N. (2007). Catalytical and thermal pyrolysis of polyolefins. J. Anal. Appl. Pyrolysis 79, 368-374.
Kao, C. Y., Cheng, W. H. & Wan, B. Z. (1998). Investigation of alkaline hydrolysis of polyethylene terephthalate by differential scanning calorimetry and thermogravimetric analysis.
J. Appl. Polym. Sci. 70, 1939-1945.
Karayannidis, G. P., Chatziavgoustis, A. P. & Achilias, D. S. (2002). Poly(ethylene terephthalate) recycling and recovery of pure terephthalic acid by alkaline hydrolysis. Adv. Polym. Technol. 21, 250-259.
Karst, D. & Yang, Y. (2005). Using the solubility parameter to explain disperse dye sorption on polylactide. J. Appl. Polym. Sci. 96, 416-422
Kawecki, D., Scheeder, P. R. W. & Nowack, B. (2018). Probabilistic Material Flow Analysis of Seven Commodity Plastics in Europe. Environ. Sci. Technol. 52, 9874-9888
Khalid, H. U.; Ismail, M. C.; Nosbi, N. 2020. Permeation Damage of Polymer Liner in Oil and Gas Pipelines: A Review. Polymers. https://doi.org/10.3390/polym12102307.
Kim, D. H. et al. (2021). One-Pot Chemo-bioprocess of PET Depolymerization and Recycling Enabled by a Biocompatible Catalyst, Betaine. ACS Catal. 11, 3996-4008.
Kim, K. J., D. M. Dhevi, J. S. Lee, Y. D. Cho, E. K. Choe. (2006). Mechanism of glycolysis of Nylon 6,6 and its model compound by ethylene glycol, Polym. Degrad. Stab. 91(7):1545-1555. https://doi.org/10.1016/j.polymdegradstab.2005.09.019.
Klun, U., A. Kržan. (2000). Rapid microwave induced depolymerization of polyamide-6, Polymer (Guildf). https://doi.org/10.1016/S0032-3861(99)00658-8.
Kresse, G. & Furthmüller, J. (1996). Efficiency of ab-initio total energy calculations for metals and semiconductors using a plane-wave basis set. Comput. Mater. Sci. 6, 15-50.
Kresse, G. & Furthmüller, J. (1996). Efficient iterative schemes for ab initio total-energy calculations using a plane-wave basis set. Phys. Rev. B—Condens. Matter Mater. Phys. 54, 11169-11186.
Kunwar, B.; Moser, B. R.; Chandrasekaran, S. R.; Rajagopalan, N.; Sharma, B. K. (2016). Catalytic and Thermal Depolymerization of Low Value Post-Consumer High Density Polyethylene Plastic. Energy. 111, 884-892.
Kuram, E., E. Tasci, A. I. Altan, M. M. Medar, F. Yilmaz, B. Ozcelik. (2013). Investigating the effects of recycling number and injection parameters on the mechanical properties of glass-fibre reinforced Nylon 6 using Taguchi method, Mater. Des. https://doi.org/10.1016/j.matdes.2013.02.027.
Kurokawa, H., Ohshima, M. A., Sugiyama, K. & Miura, H. (2003). Methanolysis of polyethylene terephthalate (PET) in the presence of aluminium tiisopropoxide catalyst to form dimethyl terephthalate and ethylene glycol. Polym. Degrad. Stab. 79, 529-533.
Law, K. L., Starr, N., Siegler, T. R., Jambeck, J. R., Mallos, N.J., and Leonard, G. H. (2020). The United States' contribution of plastic waste to land and ocean. Sci. Adv. 6.
Lee, C., Yang, W. & Parr, R. G. (1988). Development of the Colle-Salvetti correlation-energy formula into a functional of the electron density. Phys. Rev. B 37, 785-789.
Lemordant, D., Letellier, P., Rumeau, M. & Soma, C. (1988). Colour removal from textile effluents. Indian J. Fibre Text. Res. 29, 239-259.
Leng, Z., Padhan, R. K. & Sreeram, A. (2018). Production of a sustainable paving material through chemical recycling of waste PET into crumb rubber modified asphalt. J. Clean. Prod. 180, 682-688.
Li, H., Niu, S., Lu, C., Liu, M. & Huo, M. (2014). Transesterification catalyzed by industrial waste—Lime mud doped with potassium fluoride and the kinetic calculation. Energy Convers. Manag. 86, 1110-1117.
Li, T.; Lin, H.; Ouyang, X.; Qiu, X.; Wan, Z. (2019). In Situ Preparation of Ru@N-Doped Carbon Catalyst for the Hydrogenolysis of Lignin To Produce Aromatic Monomers. ACS Catal. 9 (7), 5828-5836.
Li, T.; Ong, S. S. G.; Zhang, J.; Jia, C.; Sun, J.; Wang, Y.; Lin, H. (2018). One-Pot Conversion of Carbohydrates into Furan Derivatives in Biphasic Tandem Catalytic Process. Catal. Today DOI: 10.1016/J. CATTOD.2018.11.052.
Li, Y., Ma, L., Liu, H., and He, D. (2014). Influence of HZSM5 on the activity of Ru catalysts and product selectivity during the hydrogenolysis of glycerol. Appl. Catal. A Gen. 469, 45-51.
Liebmann, B., Köppel, S., Philipp, K., Theresa, B., Thomas, R., and Philipp, S. (2018). Assessment of microplastic concentrations in human stool final results of a prospective study. Conf. Nano microplastics Tech. Freshw. Syst. Microplastics, 28-31.
Lin, C. H., Lin, H. Y., Liao, W. Z. & Dai, S. A. (2007). Novel chemical recycling of polycarbonate (PC) waste into bis-hydroxyalkyl ethers of bisphenol A for use as PU raw materials. Green Chem. 9, 38-43.
Lin, H.; Yang, L. (2019). U.S. Pat. No. 10,252,251 B2, Production of Organic Materials Using Solid Catalysts. U.S. Pat. No. 10,252,251 B2.
Lin, Y. H., and Yang, M. H. (2005). Catalytic reactions of post-consumer polymer waste over fluidised cracking catalysts for producing hydrocarbons. J. Mol. Catal. A Chem. 231, 113-122.
Liu, F. S. et al. (2009). Methanolysis and hydrolysis of polycarbonate under moderate conditions. J. Polym. Environ. 17, 208-211.
Liu, F., Li, L., Yu, S., Lv, Z. & Ge, X. (2011). Methanolysis of polycarbonate catalysed by ionic liquid [Bmim][Ac]. J. Hazard. Mater. 189, 249-254.
Liu, F., Li, Z., Yu, S., Cui, X. & Ge, X. (2010). Environmentally benign methanolysis of polycarbonate to recover bisphenol A and dimethyl carbonate in ionic liquids. J. Hazard. Mater. 174, 872-875.
Liu, H. et al. (2017). Lewis Acidic Ionic Liquid [Bmim] FeC14 as a High Efficient Catalyst for Methanolysis of Poly (lactic acid). Catal. Letters 147, 2298-2305.
Liu, H., Song, X., Liu, F., Liu, S. & Yu, S. (2015). Ferric chloride as an efficient and reusable catalyst for methanolysis of poly(lactic acid) waste. J. Polym. Res. 22, 135.
Lönnstedt, O. M.; Eklöv, P. (2016). Environmentally Relevant Concentrations of Microplastic Particles Influence Larval Fish Ecology. Science (80-.). 352 (6290), 1213-1216. https://doi.org/10.1126/science.aad8828.
López, A.; de Marco, I.; Caballero, B. M.; Laresgoiti, M. F.; Adrados, A. (2011). Dechlorination of Fuels in Pyrolysis of PVC Containing Plastic Wastes. Fuel Process. Technol. 92 (2), 253-260.
Lopez, G.; Artetxe, M.; Amutio, M.; Bilbao, J.; Olazar, M. (2017). Thermochemical Routes for the Valorization of Waste Polyolefinic Plastics to Produce Fuels and Chemicals. A Review. Renew. Sustain. Energy Rev. 73, 346-368.
Lopez-Urionabarrenechea, A.; de Marco, I.; Caballero, B. M.; Laresgoiti, M. F.; Adrados, A. (2012). Catalytic Stepwise Pyrolysis of Packaging Plastic Waste. J. Anal. Appl. Pyrolysis. 96, 54-62.
Lorenzetti, C., Manaresi, P., Berti, C. & Barbiroli, G. (2006). Chemical recovery of useful chemicals from polyester (PET) waste for resource conservation: A survey of state of the art. J. Polym. Environ. 14, 89-101.
Lozano-González, M. J., M. T. Rodriguez-Hernandez, E. A. Gonzalez-De Los Santos, J. Villalpando-Olmos. (2000). Physical-mechanical properties and morphological study on Nylon-6 recycling by injection molding, J. Appl. Polym. Sci. 76, 851-858. https://doi.org/10.1002/(SICI)1097-4628(20000509)76:6<851::AID-APP11>3.0. CO; 2-D.
Lu, L. et al. (2020). A new strategy for CO2 utilization with waste plastics: Conversion of hydrogen carbonate into formate using polyvinyl chloride in water. Green Chem. 22, 352-358
Lu, M.; Zhang, J.; Yao, Y.; Sun, J.; Wang, Y.; Lin, H. (2018). Renewable Energy Storage via Efficient Reversible Hydrogenation of Piperidine Captured CO 2. Green Chem. 20 (18), 4292-4298.
Lunt, J. (1998). Large-scale production, properties and commercial applications of poly lactic acid polymers. Polym. Degrad. Stab. 59, 145-152.
Makki, B. S.; Moradi, M.; Moafi, A.; Mohajerzadeh, S.; Hekmatshoar, B.; Shahrjerdi, D. (2004). Fabrication of Poly-Ge-Based Thermopiles on Plastic. IEEE Sens. J. https://doi.org/10.1109/JSEN.2004.836862.
Malde, A. K., Zuo, L., Breeze, M., Stroet, M., Poger, D., Nair, P. C., Oostenbrink, C., and Mark, A. E. (2011). An Automated force field Topology Builder (ATB) and repository: Version 1.0. J. Chem. Theory Comput. 7, 4026-4037.
Marcilla, A., Beltrán, M. I., and Navarro, R. (2009). Thermal and catalytic pyrolysis of polyethylene over HZSM5 and HUSY zeolites in a batch reactor under dynamic conditions. Appl. Catal. B Environ. 86, 78-86.
Marcilla, A., Gómez-Siurana, A., and Valdés, F. J. (2008). Influence of the temperature on the composition of the coke obtained in the catalytic cracking of low density polyethylene in the presence of USY and HZSM-5 zeolites. Microporous Mesoporous Mater. 109, 420-428.
Marczak, W. et al. (2013). Water-induced aggregation and hydrophobic hydration in aqueous solutions of N-methylpiperidine. RSC Adv. 3, 22053-22064.
Marczak, W., Czech, B., Almásy, L. & Lairez, D. (2011). Molecular clusters in aqueous solutions of pyridine and its methyl derivatives. Phys. Chem. Chem. Phys. 13, 6260-6269
Marczak, W., Kiefek, K., Czech, B., Flakus, H. & Rogalski, M. (2009). Complexes of 2,6-dimethylpyridine with water in condensed phases and the dynamical co-operative interactions involving hydrogen bonds. Phys. Chem. Chem. Phys. 11, 2668-2678.
Marczak, W., M. Lȩzniak, M. Zorȩbski, P. Lodowski, A. Przybyta, D. Truszkowska, L. Almásy. (2013). Water-induced aggregation and hydrophobic hydration in aqueous solutions of N-methylpiperidine, RSC Adv. 3, 22053-22064. https://doi.org/10.1039/c3ra43168a.
McKinney, R. J. (1994). Ammonolysis of Nylon. U.S. Pat. No. 5,302,756A.
Meyer, A., N. Jones, Y. Lin, D. Kranbuehl. (2002). Characterizing and modeling the hydrolysis of polyamide-11 in a pH 7 water environment, Macromolecules. 35(7):2784-2798. https://doi.org/10.1021/maOl05410.
Mieth, A.; Hoekstra, E.; Simoneau, C. (2016). Guidance for the Identification of Polymers in Multilayer Films Used in Food Contact Materials: User Guide of Selected Practices to Determine the Nature of Layers.
Mihut, C., D. K. Captain, F. Gadala-Maria, M. D. Amiridis. (2001). Review: Recycling of Nylon from carpet waste, Polym. Eng. Sci. https://doi.org/10.1002/pen.10845.
Mishra, S. & Goje, A. S. (2003). Kinetic and thermodynamic study of methanolysis of poly(ethylene terephthalate) waste powder. Polym. Int. 52, 337-342.
Miskolczi, N.; Bartha, L.; Angyal, A. (2009). Pyrolysis of Polyvinyl Chloride (PVC)-Containing Mixed Plastic Wastes for Recovery of Hydrocarbons. Energy & Fuels. 23 (5), 2743-2749.
Mittal, A., Soni, R. K., Dutt, K. & Singh, S. (2010). Scanning electron microscopic study of hazardous waste flakes of polyethylene terephthalate (PET) by aminolysis and ammonolysis. J. Hazard. Mater. 178, 390-396.
Mondragon, G., G. Kortaberria, E. Mendiburu, N. González, A. Arbelaiz, C. Peña-Rodriguez, (2020). Thermomechanical recycling of polyamide 6 from fishing nets waste, J. Appl. Polym. Sci. https://doi.org/10.1002/app.48442.
Moriya, T., and Enomoto, H. (1999). Characteristics of polyethylene cracking in supercritical water compared to thermal cracking. Polym. Degrad. Stab. 65, 373-386.
Müller, R. J., I. Kleeberg, W. D. Deckwer. (2001). Biodegradation of polyesters containing aromatic constituents, J. Biotechnol. https://doi.org/10.1016/S0168-1656(00)00407-7.
Mumladze, T.; Yousef, S.; Tatariants, M.; Kriukiene, R.; Makarevicius, V.; Lukošiute, S. I.; Bendikiene, R.; Denafas, G. (2018). Sustainable Approach to Recycling of Multilayer Flexible Packaging Using Switchable Hydrophilicity Solvents. Green Chem. https://doi.org/10.1039/c8gc01062e.
Murthy, N. S., (2006). Hydrogen bonding, mobility, and structural transitions in aliphatic polyamides, J. Polym. Sci. Part B Polym. Phys. https://doi.org/10.1002/polb.20833.
Nakagawa, Y., Oya, S., Kanno, D., Nakaji, Y., Tamura, M., and Tomishige, K. (2017). Regioselectivity and Reaction Mechanism of Ru-Catalyzed Hydrogenolysis of Squalane and Model Alkanes. ChemSusChem 10, 189-198.
Nakaji, Y.; Tamura, M.; Miyaoka, S.; Kumagai, S.; Tanji, M.; Nakagawa, Y.; Yoshioka, T.; Tomishige, K. (2021). Low-Temperature Catalytic Upgrading of Waste Polyolefinic Plastics into Liquid Fuels and Waxes. Appl. Catal. B Environ. https://doi.org/10.1016/j.apcatb.2020.119805.
Nemade, A. M., S. Mishra, V. S. Zope. (2011). Chemical Recycling of Polyamide Waste at Various Temperatures and Pressures Using High Pressure Autoclave Technique, J. Polym. Environ. 19(1):110-114. https://doi.org/10.1007/s10924-010-0249-1.
Nikles, D. E.; Farahat, M. S. (2005). New Motivation for the Depolymerization Products Derived from Poly(Ethylene Terephthalate) (PET) Waste: A Review. Macromol. Mater. Eng. 290 (1), 13-30.
Nosé, S. (1984). A molecular dynamics method for simulations in the canonical ensemble. Mol. Phys. 52, 255-268.
Nunes, C. S. et al. (2014). PET depolymerisation in supercritical ethanol catalysed by [Bmim][BF 4]. RSC Adv. 4, 20308-20316.
Oh, S. C., Shin, H. Y. & Bae, S. Y. (2009). Degradation kinetics of polycarbonate in supercritical methanol. J. Chem. Eng. Japan 42, 700-704.
Okada, Y., Sasaki, E., Watanabe, E., Hyodo, S., and Nishijima, H. (2006). Development of dehydrogenation catalyst for hydrogen generation in organic chemical hydride method. Int. J. Hydrogen Energy 31, 1348-1356.
Okan, M., H. M. Aydin, M. Barsbay. (2019). Current approaches to waste polymer utilization and minimization: a review, J. Chem. Technol. Biotechnol. 94, 8-21. https://doi.org/10.1002/jctb.5778.
Oliveira, L. F. L.; Fu, C. D.; Pfaendtner, J. (2018). Density Functional Tight-Binding and Infrequent Metadynamics Can Capture Entropic Effects in Intramolecular Hydrogen Transfer Reactions. J. Chem. Phys. 148 (15), 154101.
Onwudili, J. A.; Muhammad, C.; Williams, P. T. (2019). Influence of Catalyst Bed Temperature and Properties of Zeolite Catalysts on Pyrolysis-Catalysis of a Simulated Mixed Plastics Sample for the Production of Upgraded Fuels and Chemicals. J. Energy Inst. 92 (5), 1337-1347.
Ostle, C., Thompson, R. C., Broughton, D., Gregory, L., Wootton, M., and Johns, D. G. (2019). The rise in ocean plastics evidenced from a 60-year time series. Nat. Commun. 10.
Oya, S. I., Kanno, D., Watanabe, H., Tamura, M., Nakagawa, Y., and Tomishige, K. (2015). Catalytic Production of Branched Small Alkanes from Biohydrocarbons. ChemSusChem 8, 2472-2475.
Palme, A., Peterson, A., de la Motte, H., Theliander, H. & Brelid, H. (2017). Development of an efficient route for combined recycling of PET and cotton from mixed fabrics. Text. Cloth. Sustain. 3.
Papadopoulos, A. I., F. Tzirakis, I. Tsivintzelis, P. Seferlis. (2019). Phase-Change Solvents and Processes for Postcombustion CO2 Capture: A Detailed Review, Ind. Eng. Chem. Res. 58, 5088-5111. https://doi.org/10.1021/acs.iecr.8b06279.
Park, G. S., and Saleem, M. (1984). Diffusion of additives and plasticizers in poly(vinyl chloride) —v. diffusion of n-hexadecane and ddt in various poly(vinyl chloride)/dialkylphthalate compositions. J. Memb. Sci. 18, 177-185.
Park, J. W., Kim, J. H., and Seo, G. (2002). The effect of pore shape on the catalytic performance of zeolites in the liquid-phase degradation of HDPE. Polym. Degrad. Stab. 76, 495-501.
Park, K. B., Jeong, Y. S., Guzelciftci, B., and Kim, J. S. (2019). Characteristics of a new type continuous two-stage pyrolysis of waste polyethylene. Energy 166, 343-351.
Park, K. H., M. Y. Kim, I. H. Um. (2016). Kinetic study on nucleophilic displacement reactions of phenyl Y-substituted phenyl carbonates with 1,8-diazabicyclo[5.4.0]undec-7-ene: Effects of amine nature on reaction mechanism, Bull. Korean Chem. Soc. 37, 77-81. https://doi.org/10.1002/bkcs.10627.
Park, S. H. & Kim, S. H. (2014). Poly (ethylene terephthalate) recycling for high value added textiles. Fashion and Textiles 1.
Paszun, D. & Spychaj, T. (1997). Chemical Recycling of Poly(ethylene terephthalate). Ind. Eng. Chem. Res. 36, 1373-1383.
Patil, D. B., S. V. Madhamshettiwar. (2014) Kinetics and Thermodynamic Studies of Depolymerization of Nylon Waste by Hydrolysis Reaction, J. Appl. Chem. 2014, 1-8. https://doi.org/10.1155/2014/286709.
Peez, N.; Becker, J.; Ehlers, S. M.; Fritz, M.; Fischer, C. B.; Koop, J. H. E.; Winkelmann, C.; Imhof, W. (2019). Quantitative Analysis of PET Microplastics in Environmental Model Samples Using Quantitative 1H-NMR Spectroscopy: Validation of an Optimized and Consistent Sample Clean-up Method. Anal. Bioanal. Chem. 411 (28), 7409-7418. https://doi.org/10.1007/s00216-019-02089-2.
Perdew, J. P., Burke, K. & Ernzerhof, M. (1996). Generalized gradient approximation made simple. Phys. Rev. Lett. 77, 3865-3868.
Perera, L., and Berkowitz, M. L. (1991). Many-body effects in molecular dynamics simulations of Na+(H2O)n and Cl—(H2O) n clusters. J. Chem. Phys. 95, 1954-1963.
Pfaendtner, J.; Bonomi, M. (2015). Efficient Sampling of High-Dimensional Free-Energy Landscapes with Parallel Bias Metadynamics. J. Chem. Theory Comput. 11 (11), 5062-5067.
Piñero, R., Garcia, J. & Cocero, M. J. (2005). Chemical recycling of polycarbonate in a semi-continuous lab-plant. A green route with methanol and methanol-water mixtures. in Green Chemistry 7, 380-387.
Piñero-Hernanz, R., Garcia-Serna, J. & Cocero, M. J. (2006). Nonstationary model of the semicontinuous depolymerization of polycarbonate. AIChE J. 52, 4186-4199.
Piringer, O. G.; Baner, A. L. (2008). Plastic Packaging: Interactions with Food and Pharmaceuticals, Second Edition. https://doi.org/10.1002/9783527621422.
Plastic Pollution. (2020). pp 115-147. https://doi.org/10.1142/9781786347435_0005.
Plastic upcycling. (2019). Nature Catalysis 2, 945-946 Properties, P. et al. Technical Bulletin Physical Properties & Resin Suitability.
Quartinello, F. et al. (2017). Synergistic chemo-enzymatic hydrolysis of poly(ethylene terephthalate) from textile waste. Microb. Biotechnol. 10, 1376-1383.
Ragaert, K., L. Delva, K. Van Geem. (2017). Mechanical and chemical recycling of solid plastic waste, Waste Manag. 69, 24-58. https://doi.org/10.1016/j.wasman.2017.07.044.
Rahimi, A. R.; Garciá, J. M. (2017). Chemical Recycling of Waste Plastics for New Materials Production. Nat. Rev. Chem. 1, 1-11.
Ramesh, C.; Bhoje Gowd, E. (2001). High-Temperature X-Ray Diffraction Studies on the Crystalline Transitions in the α- and γ-Forms of Nylon-6. Macromolecules. https://doi.org/10.1021/ma0006979.
Ramesh, V., Biswal, M., Mohanty, S. & Nayak, S. K. (2014). Recycling of engineering plastics from waste electrical and electronic equipments: Influence of virgin polycarbonate and impact modifier on the final performance of blends. Waste Manag. Res. 32, 379-388.
Renzini, M. S., Lerici, L. C., Sedran, U., and Pierella, L. B. (2011). Stability of ZSM-11 and BETA zeolites during the catalytic cracking of low-density polyethylene. J. Anal. Appl. Pyrolysis 92, 450-455.
Requests, S. D. S. (2015). Dyes & Pigments for Plastics. Orco 1-19
Roos, S., Posner, S., Jonsson, C. & Peters, G. M. (2015). Is Unbleached Cotton Better Than Bleached? Exploring the Limits of Life-Cycle Assessment in the Textile Sector. Cloth. Text.
Res. J. 33, 231-247.
Rorrer, J. E., Beckham, G. T., and Roman-Leshkov, Y. (2021). Conversion of Polyolefin Waste to Liquid Alkanes with Ru-Based Catalysts under Mild Conditions. JACS Au 1, 8-12.
Rorrer, N. A.; Nicholson, S.; Carpenter, A.; Biddy, M. J.; Grundl, N. J.; Beckham, G. T. (2019). Combining Reclaimed PET with Bio-Based Monomers Enables Plastics Upcycling. Joule. 3 (4), 1006-1027. https://doi.org/10.1016/j.joule.2019.01.018.
Rosevelt, C., Los Huertos, M., Garza, C., and Nevins, H. M. (2013). Marine debris in central California: Quantifying type and abundance of beach litter in Monterey Bay, CA. Mar. Pollut. Bull. 71, 299-306.
Rozenstein, O.; Puckrin, E.; Adamowski, J. (2017). Development of a New Approach Based on Midwave Infrared Spectroscopy for Post-Consumer Black Plastic Waste Sorting in the Recycling Industry. Waste Manag. 68, 38-44. https://doi.org/10.1016/j.wasman.2017.07.023.
Sa, U. (2020). ChemBook_1, 8-Diazabicyclo[5.4.0]undec-7-ene_6674-22-2, 1-5.
Sabic outlines intentions for Trucircle™ to close loop on plastic recycling (2020).
Saito, K. et al. (2020). From plastic waste to polymer electrolytes for batteries through chemical upcycling of polycarbonate. J. Mater. Chem. A 8, 13921-13926.
Saleem, M., Asfour, A. A., De Kee, D., and Harrison, B. (1989). Diffusion of organic penetrants through low density polyethylene (LDPE) films: Effect of size and shape of the penetrant molecules. J. Appl. Polym. Sci. 37, 617-625.
Sato, S., Murakata, T., Baba, S., Saito, Y., and Watanabe, S. (1990). Solvent effect on thermal degradation of polystyrene. J. Appl. Polym. Sci. 40, 2065-2071.
Scheirs, J. (1998). Polymer Recycling: Science, Technology and Applications.
Schullery, S. E. & Scott, R. M. (1994). Amine and phenol solvation by Lewis bases: calculated binding constants and stoichiometries presented as evidence of bifurcated and trifurcated hydrogen bonds. J. Mol. Struct. 322, 287-296.
SCM Software for Chemistry & Materials. Available at: http://www.scm.com.
Serhatkulu, T.; Erman, B.; Bahar, I.; Fakirov, S.; Evstatiev, M.; Sapundjieva, D. (1995). Dynamic Mechanical Study of Amorphous Phases in Poly(Ethylene Terephthalate)/Nylon-6 Blends. Polymer (Guildf). https://doi.org/10.1016/0032-3861(95)97335-D.
Serrano, D. P., Aguado, J., Vicente, G., and Sanchez, N. (2007). Effects of hydrogen-donating solvents on the thermal degradation of HDPE. J. Anal. Appl. Pyrolysis 78, 194-199.
Serranti, S.; Luciani, V.; Bonifazi, G.; Hu, B.; Rem, P. C. (2015). An Innovative Recycling Process to Obtain Pure Polyethylene and Polypropylene from Household Waste. Waste Manag. https://doi.org/10.1016/j.wasman.2014.10.017.
Shibata, M.; Masuda, T.; Yosomiya, R.; Ling-Hui, M. (2000). Depolymerization of Poly(Butylene Terephthalate) Using High-Temperature and High-Pressure Methanol. J. Appl. Polym. Sci. 77 (14), 3228-3233.
Shuai, L., and Luterbacher, J. (2016). Organic Solvent Effects in Biomass Conversion Reactions. ChemSusChem 9, 133-155.
Shukla, S. R. & Mathur, M. R. (2000). Action of alkali on polybutylene terephthalate and polyethylene terephthalate polyesters. J. Appl. Polym. Sci. 75, 1097-1102.
Shukla, S. R., Harad, A. M. & Jawale, L. S. (2008). Recycling of waste PET into useful textile auxiliaries. Waste Manag. 28, 51-56.
Shukla, S. R., A. M. Harad, D. Mahato. (2006). Depolymerization of Nylon 6 waste fibers, J. Appl. Polym. Sci. https://doi.org/10.1002/app.22775.
Sinfelt, J. H. (1973). Specificity in Catalytic Hydrogenolysis by Metals. Adv. Catal. 23, 91-119.
Sinha, V., Patel, M. R. & Patel, J. V. (2010). Pet waste management by chemical recycling: A review. J. Polym. Environ. 18, 8-25.
Smigiel-Kaminska, D. et al. (2019). The identification of polyester fibers dyed with disperse dyes for forensic purposes. Molecules 24.
Sofer, G., (2000). Process Validation in Manufacturing of Biopharmaceuticals, https://doi.org/10.1201/b13997.
Song, X. et al. (2019). Zn-Acetate-Containing ionic liquid as highly active catalyst for fast and mild methanolysis of Poly(lactic acid). Polym. Degrad. Stab. 168, 108937.
Song, X., H. Wang, X. Zheng, F. Liu, S. Yu. (2014). Methanolysis of poly(lactic acid) using acidic functionalized ionic liquids as catalysts, J. Appl. Polym. Sci. 131, 1-6. https://doi.org/10.1002/app.40817.
Sprenger, K. G.; Choudhury, A.; Kaar, J. L.; Pfaendtner, J. (2016). Lytic Polysaccharide Monooxygenases Sc LPMO10B and Sc LPMO10C Are Stable in Ionic Liquids As Determined by Molecular Simulations. J. Phys. Chem. B 120 (16), 3863-3872.
Sprenger, K. G.; Jaeger, V. W.; Pfaendtner, J. (2015). The General AMBER Force Field (GAFF) Can Accurately Predict Thermodynamic and Transport Properties of Many Ionic Liquids. J. Phys. Chem. B 119 (18), 5882-5895.
Sprenger, K. G.; Pfaendtner, J. (2016). Using Molecular Simulation to Study Biocatalysis in Ionic Liquids. In Methods in Enzymology. pp 419-441.
Sprenger, K. G.; Plaks, J. G.; Kaar, J. L.; Pfaendtner, J. (2017). Elucidating Sequence and Solvent Specific Design Targets to Protect and Stabilize Enzymes for Biocatalysis in Ionic Liquids. Phys. Chem. Chem. Phys. 19 (26), 17426-17433.
Stempfle, F., Ortmann, P. & Mecking, S. (2016). Long-Chain Aliphatic Polymers to Bridge the Gap between Semicrystalline Polyolefins and Traditional Polycondensates. Chemical Reviews 116, 4597-4641.
Su, X., Zhao, Y., Zhang, R., and Bi, J. (2004). Investigation on degradation of polyethylene to oils in supercritical water. Fuel Process. Technol. 85, 1249-1258.
Substances, H., HSDB_PubChem_Triethylamine, (2020). 1-36.
Summary, C., HSDB_PubChem_Tripropylamine, (2020). 1-47.
Summary, C., N,N-Diethylaniline, (2020).
Tan, X., Y. Li, Y. Li, J. Liu. (2013). Catalytic hydrolysis of Nylon 6 to recover caprolactam over solid superacid, Chem. Eng. 27, 17-18.
Tang, H., Radosz, M. & Shen, Y. (2006). CuBr2/N,N,N′,N′-tetra[(2-pyridal)methyl]ethylenediamine/tertiary amine as a highly active and versatile catalyst for atom-transfer radical polymerization via activator generated by electron transfer. Macromol. Rapid Commun. 27, 1127-1131.
Tang, K.; Xie, S.; Cofield, G. R.; Yang, X.; Tian, E.; Lin, H. (2018). Catalytic Transfer Hydrogenation of Furfural for the Production of Ethyl Levulinate: Interplay of Lewis and Brønsted Acidities. Energy Technol. 6 (9), 1826-1831.
Tang, W.; Liu, Y.; Peng, C.; Hu, M. Y.; Deng, X.; Lin, M.; Hu, J. Z.; Loh, K. P. (2015). Probing Lithium Germanide Phase Evolution and Structural Change in a Germanium-in-Carbon Nanotube Energy Storage System. J Am Chem Soc. 137 (7), 2600-2607.
Tang, Z., Wang, L. & Yang, J. (2008). Transesterification of rapeseed oil catalyzed by liquid organic amine in supercritical methanol in a continuous tubular-flow reactor. Eur. J. Lipid Sci. Technol. 110, 747-753.
Tansel, B. (2017). From electronic consumer products to e-wastes: Global outlook, waste quantities, recycling challenges. Environ. Int. 98, 35-45.
Taylor, J. D., J. I. Steinfeld, J. W. (2001). Tester, Experimental measurement of the rate of methyl tert-butyl ether hydrolysis in sub- and supercritical water, Ind. Eng. Chem. Res. https://doi.org/10.1021/ie0006357.
Tellý, A., Özdýl, N. & Babaarslan, O. (2012). Pet {thorn}ý{thorn}e atiklarinin tekstýl endustrüstrýsýnde de{eth}erlendýrýlmesý ve sürdürülebýlýrlý{eth}e katkisi. Tekst. ve Muhendis 19, 49-55
Temming, M. (2021). Chemists Are Reimagining Recycling to Keep Plastics out of Landfills.
Tennakoon, A., Wu, X., Paterson, A. L., Patnaik, S., Pei, Y., LaPointe, A. M., Ammal, S. C., Hackler, R. A., Heyden, A., Slowing, 1.1., et al. (2020). Catalytic upcycling of high-density polyethylene via a processive mechanism. Nat. Catal. 3, 893-901.
Tiseo, I. (2021). Global Plastic Production 1950-2019.
Tokiwa, Y., B. P. Calabia. (2006). Biodegradability and biodegradation of poly(lactide), Appl.
Microbiol. Biotechnol. 72, 244-251. https://doi.org/10.1007/s00253-006-0488-1.
Tsintzou, G. P. & Achilias, D. S. (2013). Chemical recycling of polycarbonate based wastes using alkaline hydrolysis under microwave irradiation. Waste and Biomass Valorization. 4, 3-7
Tung, H.-J.; Pfaendtner, J. (2016). Kinetics and Mechanism of Ionic-Liquid Induced Protein Unfolding: Application to the Model Protein HP35. Mol. Syst. Des. Eng. 1 (4), 382-390.
Ügdüler, S. et al. (2020). Towards closed-loop recycling of multilayer and coloured PET plastic waste by alkaline hydrolysis. Green Chem. 22, 5376-5394.
US Department of Energy. (2020). Plastics Innovation Challenge.
US EPA, O. (2020). Plastics: Material-Specific Data.
Van Lenthe, E. & Baerends, E. J. (2003). Optimized Slater-type basis sets for the elements 1-118. J. Comput. Chem. 24, 1142-1156.
Van Maris, R., Y. Tamano, H. Yoshimura, K. M. Gay. (2005). Polyurethane catalysis by tertiary amines, J. Cell. Plast. 41, 305-322. https://doi.org/10.1177/0021955X05055113.
Vedage, G. A., Herman, R. G. & Klier, K. (1985). Chemical trapping of surface intermediates in methanol synthesis by amines. J. Catal. 95, 423-434
Vezzini, A. (2014). Manufacturers, Materials and Recycling Technologies. In Lithium-Ion Batteries: Advances and Applications. pp 529-551.
Vicente, G., Aguado, J., Serrano, D. P., and Sanchez, N. (2009). HDPE chemical recycling promoted by phenol solvent. J. Anal. Appl. Pyrolysis 85, 366-371.
Vollmer, I. et al. (2020). Beyond Mechanical Recycling: Giving New Life to Plastic Waste. Angewandte Chemie—International Edition 59, 15402-15423.
Vora, N. et al. (2021). Leveling the cost and carbon footprint of circular polymers that are chemically recycled to monomer. Sci. Adv. 7, eabf0187.
Walker, T. W.; Frelka, N.; Shen, Z.; Chew, A. K.; Banick, J.; Grey, S.; Kim, M. S.; Dumesic, J. A.; Van Lehn, R. C.; Huber, G. W. (2020). Recycling of Multilayer Plastic Packaging Materials by Solvent-Targeted Recovery and Precipitation. Sci. Adv. 6 (47). https://doi.org/i0.1126/sciadv.aba7599.
Wang, J., Cheng, W., Gao, Y., Zhu, L. & Pei, L. (2019). Mechanism of accelerant on disperse dyeing for PET fiber in the silicone solvent dyeing system. Polymers (Basel). 11.
Wang, J.; Wang, H.; Yue, D. (2019). Optimization of Surface Treatment Using Sodium Hypochlorite Facilitates Coseparation of ABS and PC from WEEE Plastics by Flotation. Environ. Sci. Technol. https://doi.org/10.1021/acs.est.8b06432.
Wang, K. et al. (2020). Flotation separation of polyethylene terephthalate from waste packaging plastics through ethylene glycol pretreatment assisted by sonication. Waste Manag. 105, 309-316
Wang, L., Nelson, G. A., Toland, J. & Holbrey, J. D. (2020). Glycolysis of PET Using 1,3-Dimethylimidazolium-2-Carboxylate as an Organocatalyst. ACS Sustain. Chem. Eng. 8, 13362-13368.
Wang, W., L. Meng, J. Yu, F. Xie, Y. Huang. (2017). Enhanced hydrothermal conversion of caprolactam from waste monomer casting polyamide over H-Beta zeolite and its mechanism, J. Anal. Appl. Pyrolysis. https://doi.org/10.1016/j.jaap.2017.03.020.
Wang, W., L. Meng, K. Leng, Y. Huang. (2017). Hydrolysis of waste monomer casting Nylon catalyzed by solid acids, Polym. Degrad. Stab. https://doi.org/10.1016/j.polymdegradstab.2016.12.017.
Wang, W.; Meng, L.; Huang, Y. (2014). Hydrolytic Degradation of Monomer Casting Nylon in Subcritical Water. Polym. Degrad. Stab. 110, 312-317. https://doi.org/10.1016/j.polymdegradstab.2014.09.014.
Wang, Y. (2010). Fiber and textile waste Utilization, Waste and Biomass Valorization. https://doi.org/10.1007/s12649-009-9005-y.
Watanabe, M. et al. (2009). Chemical recycling of polycarbonate in high pressure high temperature steam at 573 K. Polym. Degrad. Stab. 94, 2157-2162.
Xiao, J.; Hu, J. Z.; Chen, H.; Vijayakumar, M.; Zheng, J.; Pan, H.; Walter, E. D.; Hu, M.; Deng, X.; Feng, J.; et al. (2015). Following the Transient Reactions in Lithium-Sulfur Batteries Using an in Situ Nuclear Magnetic Resonance Technique. Nano Lett 15 (5), 3309-3316.
Xie, S.; Jia, C.; Go Ong, S. S.; Wang, Z.; Zhu, M. jun; Wang, Q.; Yang, Y.; Lin, H. (2020). A Shortcut Route to Close Nitrogen Cycle: Bio-Based Amines Production via Selective Deoxygenation of Chitin Monomers over Ru/C in Acidic Solutions. iScience. 23 (5), 101096. https://doi.org/10.1016/j.isci.2020.101096.
Xie, S.; Jia, C.; Prakash, A.; Palafox, M. I.; Pfaendtner, J.; Lin, H. (2019). Generic Biphasic Catalytic Approach for Producing Renewable Diesel from Fatty Acids and Vegetable Oils. ACS Catal. 9 (4), 3753-3763. https://doi.org/10.1021/acscatal.9b00215.
Xie, S.; Jia, C.; Wang, Z.; Ong, S. S. G.; Zhu, M.; Lin, H. (2020). Mechanistic Insight into Selective Deoxygenation of I-Lysine to Produce Biobased Amines. ACS Sustain. Chem. Eng. 8 (31), 11805-11817. https://doi.org/10.1021/acssuschemeng.0c04052.
Xie, S.; Zhang, W.; Jia, C.; Ong, S. S. G.; Zhang, C.; Zhang, S.; Lin, H. (2020). Eliminating Carbon Dioxide Emissions at the Source by the Integration of Carbon Dioxide Capture and Utilization over Noble Metals in the Liquid Phase. J. Catal. 389, 247-258.
Xu, S.; Ye, L. (2015). Monomer Casting Nylon-6-b-Polyether Amine Copolymers: Synthesis and Properties. Compos. Part B Eng. https://doi.org/10.1016/j.compositesb.2015.04.040.
Yan, C., J. Fraga-Dubreuil, E. Garcia-Verdugo, P. A. Hamley, M. Poliakoff, I. Pearson, A. S. Coote. (2008). The continuous synthesis of ε-caprolactam from 6-aminocapronitrile in high-temperature water, Green Chem. https://doi.org/10.1039/b710041 h.
Yang, L.; Yang, X.; Tian, E.; Lin, H. (2016). Direct Conversion of Cellulose into Ethyl Lactate in Supercritical Ethanol-Water Solutions. ChemSusChem. 9 (1), 36-41.
Yang, L.; Yang, X.; Tian, E.; Vattipalli, V.; Fan, W.; Lin, H. (2016). Mechanistic Insights into the Production of Methyl Lactate by Catalytic Conversion of Carbohydrates on Mesoporous Zr-SBA-15. J. Catal. 333, 207-216.
Yoshioka, T., Okayama, N. & Okuwaki, A. (1998). Kinetics of Hydrolysis of PET Powder in Nitric Acid by a Modified Shrinking-Core Model. Ind. Eng. Chem. Res. 37, 336-340.
Yousfi, M.; Soulestin, J.; Vergnes, B.; Lacrampe, M. F.; Krawczak, P. (2013). Morphology and Mechanical Properties of PET/PE Blends Compatibilized by Nanoclays: Effect of Thermal Stability of Nanofiller Organic Modifier. J. Appl. Polym. Sci. https://doi.org/10.1002/app.38450.
Yuan, X. X., Q. Zhou, X. Y. Li, P. Yang, K. K. Yang, Y. Z. Wang. (2014). Degradation of Nylon 6 to produce a “pseudo” amino acid ionic liquid, Polym. Degrad. Stab. https://doi.org/10.1016/j.polymdegradstab.2014.07.016.
Zagar, E., U. Cesarek, A. Drincid, S. Sitar, I. M. Shlyapnikov, D. Pahovnik. (2020). Quantitative Determination of PA6 and/or PA66 Content in Polyamide-Containing Wastes, ACS Sustain. Chem. Eng. 8, 11818-11826. https://doi.org/10.1021/acssuschemeng.0c04190.
Zhang, C.; Jia, C.; Cao, Y.; Yao, Y.; Xie, S.; Zhang, S.; Lin, H. (2019). Water-Assisted Selective Hydrodeoxygenation of Phenol to Benzene over the Ru Composite Catalyst in the Biphasic Process. Green Chem. 21 (7), 1668-1679.
Zhang, F., Zeng, M., Yappert, R. D., Sun, J., Lee, Y. H., LaPointe, A. M., Peters, B., Abu-Omar, M. M., and Scott, S. L. (2020). Polyethylene upcycling to long-chain alkylaromatics by tandem hydrogenolysis/aromatization. Science 370, 437-441.
Zhang, H., Li, W., Jin, Y., Sheng, W., Hu, M., Wang, X., and Zhang, J. (2016). Ru—Co(III)—Cu(II)/SAC catalyst for acetylene hydrochlorination. Appl. Catal. B Environ. 189, 56-64.
Zhang, J., Huo, X., Li, Y., and Strathmann, T. J. (2019). Catalytic Hydrothermal Decarboxylation and Cracking of Fatty Acids and Lipids over Ru/C. ACS Sustain. Chem. Eng. 7, 14400-14410.
Zhang, L., Y. Li, H. Zhou, M. Chen. (2017). Performance of 1,8-Diazabicyclo[5.4.0]undec-7-ene-Modified SBA-15 for Selective Adsorption of CO2, Energy and Fuels. 31, 3062-3068. https://doi.org/10.1021/acs.energyfuels.6b03301.
Zhang, Y., Duan, D., Lei, H., Villota, E., and Ruan, R. (2019). Jet fuel production from waste plastics via catalytic pyrolysis with activated carbons. Appl. Energy 251.
Zhao, S. H. & Chen, Z. Bin. (2005). N-methylpiperidine—A useful base catalyst in the Morita-Baylis-Hillman reaction. Synth. Commun. 35, 3045-3053.
Zhao, Y., Rodrigo, J., Hoveyda, A. H. & Snapper, M. L. (2006). Enantioselective silyl protection of alcohols catalysed by an amino-acid-based small molecule. Nature 443, 67-70.
Zhou, Y. et al. (2019). Alkyl coupling in tertiary amines as analog of Guerbet condensation reaction. RSC Adv. 9, 9845-9849.

1. A method of recycling co-mingled plastic containing one or more polyesters, one or more polyamides, and one or more polyolefins, wherein the method comprises
(a) deconstructing one or more polyesters in the co-mingled plastic by solvolysis with one or more tertiary amine catalysts dissolved in an organic solvent, and obtaining polyester monomers and derivatives thereof, and unconverted plastic containing one or more polyamides and one or more polyolefins;
(b) deconstructing the one or more polyamides in the unconverted plastic by solvolysis with one or more tertiary amine catalysts dissolved in a solvent, and obtaining polyamide monomers and unconverted plastic containing one or more polyolefins; and
(c) deconstructing the one or more polyolefins in the unconverted plastic by hydrogenolysis with one or more supported metal catalysts and an organic solvent, and obtaining low molecular weight hydrocarbons (LMWH).

2. The method of claim 1, wherein the method is a continuous sequential catalytic solvolysis process.

3. The method of claim 1, wherein the method does not require presorting of the co-mingled plastic.

4. The method of claim 1, wherein the one or more polyesters comprise polyethylene terephthalate (PET), polylactic acid (PLA), polycarbonate (PC), polybutylene terephthalate (PBT), polyurethane (PU), polycaprolactone (PCL), polyhydroxybutyrate (PHB), polyglycolic acid (PGA), polyethylene adipate (PEA), polyethylene terephthalate (PET), polybutylene terephthalate (PBT), polyethylene naphthalate (PEN), polytrimethylene terephthalate (PTT), polyester of 4-hydroxybenzoic acid and 6-hydroxynaphthalene-2-carboxylic acid (LCP), and polyester of bisphenol A and phthalic acid (PAR).

5. The method of claim 1, wherein the one or more polyamides comprise Nylons, optionally the Nylons comprise poly(hexamethylene adipamide) (Nylon 6,6), polycaprolactam (Nylon 6), poly(hexamethylene dodecanediamide) (Nylon 6,12), poly(hexamethylene succinamide) (Nylon 4,6), poly(hexamethylene sebacamide) (Nylon 6,10), and poly(ω-undecanamide) (Nylon 11), semi-aromatic polyamides such as polyphthalamides (PPA), poly(hexamethylene teraphthalamide) (PA 6T), and poly(hexamethylene isophthalamide) (PA 6I).

6. The method of claim 1, wherein the one or more polyolefins include low density high density polyethylene (HDPE), low density polyethylene (LDPE), linear LDPE (LLDPE), polypropylene (PP), poly(butylene), poly(butyl ethylene), poly(cyclohexylethylene), poly(ethylene), poly(isobutene), poly(isobutylethylene), poly(propylene), poly(propylethylene), and poly(tert-butylethylene).

7. The method of claim 1, wherein the organic solvent for deconstructing the one or more polyesters comprises methanol, ethanol, propanol, butanol, or polyols, optionally polyethylene glycol.

8. The method of claim 1, wherein deconstructing the one or more polyester by solvolysis comprises methanolysis with one or more tertiary amine catalysts dissolved in methanol.

9. The method of claim 1, wherein the solvent for deconstructing the one or more polyamides comprises water, phenol, cresol, or DMF.

10. The method of claim 1, wherein deconstructing the one or more polyamides by solvolysis comprises hydrolysis with one or more tertiary amine catalysts dissolved in water.

11. The method of claim 1, wherein the organic solvent for deconstructing the one or more olefins comprises pentane, methylcyclohexane, hexane, heptane, octane, nonane, decane, undecane, dodecane, tridecane, tetradecane, pentadecane, or hexadecane.

12. The method of claim 1, wherein the one or more tertiary amine catalysts comprise linear amines, aromatic amines, cyclic amines, and diamines.

13. The method of claim 1, wherein the one or more tertiary amines catalysts comprise tripropylamine (TPA), triethylamine (TEA), N,N-dimethylaniline (DMA), 4,N,N-trimethylaniline (TMA), N-methylpiperidine (NMP), 1,8-Diazabicyclo[5.4.0]undec-7-ene (DBU), N,N,N′,N′-Tetramethylethylenediamine (TMEDA), N,N,N′,N′-Tetramethyl-1,3-propanediamine (TMPDA), and N,N,N′,N′-Tetraethylethylenediamine (TEEDA).

14. The method of claim 1, wherein the one or more tertiary amine catalysts for deconstructing polyamides by solvolysis, optionally methanolysis, comprise NMP, TEA, and TEEDA, optionally wherein the tertiary amine catalyst for methanolysis comprises NMP.

15. The method of claim 1, wherein the one or more tertiary amine catalysts for solvolysis, optionally hydrolysis, comprise TEA, TPA, NMP, and TEEDA, optionally wherein the tertiary amine catalyst for hydrolysis comprises TEA.

16. The method of claim 1, wherein the supported metal catalyst comprises supported ruthenium (Ru/C) catalyst, supported platinum catalyst, supported rhodium catalyst, and supported nickel catalyst, and optionally wherein the supported metal catalyst comprises supported Ru/C catalyst.

17. The method of claim 1, wherein the method further comprises separating the one or more catalysts and/or solvent from the polyester monomers and derivatives thereof, and/or from the polyamide monomers, and optionally, wherein separating comprises, distillation, flash distillation, and/or membrane pervaporation, and/or
wherein the method further comprises separating the one or more supported metal catalysts from the LMWH, and optionally, wherein separating comprises filtration or distillation.

18. The method of claim 1, wherein the method further comprises recycling the catalysts and solvents.

19. The method of claim 1, wherein the polyester monomers comprise dimethyl terephthalate (DMT) and ethylene glycol (EG), wherein the monomers of the polyamides comprise ε-caprolactam, and/or wherein the deconstructed products of the polyolefins comprise alkanes, optionally C₇ to C₃₈ alkanes.

20. The method of claim 1, wherein the method further comprises mixing the co-mingled plastic with the tertiary amine catalyst dissolved in the organic solvent, optionally methanol, in a vessel and heating the mixture to a set temperature of less than 200° C., and optionally wherein the method comprises heating the mixture from 80° C. to 180° C., 100° C. to 160° C., or 120° C. to 160° C., or heated to 100° C., 120° C., or 160° C.

21. The method of claim 1, wherein the method further comprises mixing the unconverted plastic containing one or more polyamides and one or more polyolefins with a tertiary amine catalyst dissolved in the solvent, optionally an aqueous solvent, and heating the mixture to a set temperature of less than 300° C., and optionally wherein the temperature for hydrolysis of the unconverted plastic comprises 200° C. to 270° C., 200° C. to 250° C., 220° C. to 250° C., 230° C. to 250° C., 240° C. to 250° C., or 250° C.

22. The method of claim 1, wherein the method further comprises mixing the unconverted plastic containing one or more polyolefins with a supported metal catalyst and an organic solvent, optionally hexane, and heating the mixture to a set temperature of less than 260° C., and optionally wherein the temperature for hydrogenolysis of the unconverted plastic comprises 200° C. to 260° C., 200° C. to 240° C., 200° C. to 230° C., 200° C. to 220° C., 210° C. to 230° C., or 220° C.

23. The method of claim 1, wherein the method further comprises treating the co-mingled plastic with one or more organic solvents prior to deconstruction, and optionally wherein the one or more organic solvents comprise methanol, acetone, or a mixture thereof.

24. A system for recycling co-mingled plastic containing one or more polyesters, one or more polyamides, and one or more polyolefins, wherein the system comprises
(a) a reactor tank for deconstructing the one or more polyesters in the co-mingled plastic by solvolysis, optionally methanolysis, with one or more tertiary amine catalysts dissolved in an organic solvent, optionally methanol, to obtain polyester monomers and derivatives thereof, and unconverted plastic containing one or more polyamides and one or more polyolefins;
(b) a reactor tank for deconstructing the one or more polyamides in the unconverted plastic by solvolysis, optionally hydrolysis, with one or more tertiary amine catalysts dissolved in a solvent, optionally water, to obtain polyamide monomers and unconverted plastic containing one or more polyolefins; and
(c) a reactor tank for deconstructing one or more polyolefins in the unconverted plastic hydrogenolysis with one or more supported metal catalysts, optionally a Ru/C catalyst, and an organic solvent, optionally hexane, to obtain low molecular weight hydrocarbons (LMWH).

25. The system of claim 24, wherein the reactor tank for deconstructing polyester by solvolysis, optionally methanolysis, is connected to the reactor tank for deconstructing polyamides by solvolysis, optionally hydrolysis, through a line for moving unconverted plastic containing one or more polyamides and one or more polyolefins to the reactor tank for deconstructing polyamides by solvolysis, optionally hydrolysis, wherein the reactor tank for deconstructing polyamides by solvolysis, optionally hydrolysis, is connected to the reactor tank for deconstructing polyolefins by hydrogenolysis through a line for moving unconverted plastic containing one or more polylefins to the reactor tank for hydrogenolysis, and the reactor tank for hydrogenolysis is connected to a vessel for collecting or recovering residual plastics through a line for moving the residual plastics to the vessel.

26. The system of claim 24, wherein each of the reactor tanks is connected to an individual separation apparatus for separating the catalyst and solvent from the polyester monomers and derivatives thereof, for separating the catalyst and solvent from the polyamide monomers, or for separating the supported metal catalyst and solvent from the LMWH.

27. The system of embodiment 26, wherein each of the separation apparatus is connected to its respective reactor tanks for recycling the separated catalyst and solvent.

28. The system of embodiment 27, wherein each the separation apparatus is further connected to an individual vessel for collecting the polyester monomers and derivatives thereof, for collecting polyamide monomers, or for collecting LMWH.
